(19) United States
(12) Patent Application Publication
(10) Pub. No.: US 2025/0024294 A1
(43) Pub. Date: Jan. 16, 2025

(54) UE-INITIATED BEAM MANAGEMENT

(71) Applicant: Samsung Electronics Co., Ltd., Suwon-si (KR)

(72) Inventors: Dalin Zhu, Allen, TX (US); Emad Nader Farag, Flanders, NJ (US); Eko Onggosanusi, Coppell, TX (US)

(21) Appl. No.: 18/759,579

(22) Filed: Jun. 28, 2024

Related U.S. Application Data
(60) Provisional application No. 63/526,613, filed on Jul. 13, 2023.
(60) Provisional application No. 63/527,992, filed on Jul. 20, 2023.

(51) Int. Cl. H04W 24/10; H04B 7/06; H04B 7/08

(52) U.S. Cl. CPC H04W 24/10; H04B 7/0626; H04B 7/088

(57) ABSTRACT

Methods and apparatuses for user equipment (UE)-initiated beam management. A method performed by a UE includes receiving first information to enable UE-initiated beam operation, receiving second information related to a measurement reference signal (RS) for the UE-initiated beam operation, and measuring the measurement RS. The method further includes determining, based on the measurement, a report, transmitting a first uplink (UL) channel notifying transmission of the report, and transmitting a second UL channel including the report.

### CROSS-REFERENCE TO RELATED AND CLAIM OF PRIORITY

The present application claims priority under 35 U.S.C. § 119 (e) to U.S. Provisional Patent Application No. 63/526,613 filed on Jul. 13, 2023, and U.S. Provisional Patent Application No. 63/527,992 filed on Jul. 20, 2023, which are hereby incorporated by reference in their entirety.

### TECHNICAL FIELD

The present disclosure relates generally to wireless communication systems and, more specifically, the present disclosure relates to methods and apparatuses for user equipment (UE)-initiated beam management.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to user equipment (UE)-initiated beam management.

Other technical features may be readily apparent to one skilled in the art from the following figures, descriptions, and claims.

In one embodiment, a UE is provided. The UE includes a transceiver configured to receive first information to enable UE-initiated beam operation and receive second information related to a measurement reference signal (RS) for the UE-initiated beam operation. The UE further includes a processor operably coupled with the transceiver. The processor is configured to measure the measurement RS and determine a report based on the measurement. The transceiver is further configured to transmit a first uplink (UL) channel notifying transmission of the report and transmit a second UL channel including the report.

In another embodiment, a method performed by a UE is provided. The method includes receiving first information to enable UE-initiated beam operation, receiving second information related to a measurement RS for the UE-initiated beam operation, and measuring the measurement RS. The method further includes determining, based on the measurement, a report, transmitting a first UL channel notifying transmission of the report, and transmitting a second UL channel including the report.

In yet another embodiment, a base station (BS) is provided. The BS includes a processor and a transceiver operably coupled with the processor. The transceiver is configured to transmit first information to enable a UE-initiated beam operation; transmit second information related to a measurement RS for the UE-initiated beam operation; transmit the measurement RS; receive a first UL channel notifying reception of a report associated with the measurement RS; and receive a second UL channel including the report.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit.” “receive.” and “communicate.” as well as derivatives thereof, encompass both direct and indirect communication. The terms “include” and “comprise.” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of.” when used with a list of items, means that different combinations of one or more of the listed items may be used, and only one item in the list may be needed. For example. “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure:

FIG. 3 illustrates an example user equipment (UE) according to embodiments of the present disclosure:

FIGS. 4A and 4B illustrate examples of wireless transmit and receive paths according to embodiments of the present disclosure:

FIG. 5A illustrates an example of a wireless system according to embodiments of the present disclosure:

FIG. 5B illustrates an example of a multi-beam operation according to embodiments of the present disclosure:

FIG. 6 illustrates an example of a transmitter structure for beamforming according to embodiments of the present disclosure:

FIG. 7 illustrates an example procedure for applying transmission configuration indication (TCI) states for first/second downlink and uplink channels/signals according to embodiments of the present disclosure:

FIG. 8 illustrates an example procedure for applying TCI states for first/second downlink and uplink channels/signals according to embodiments of the present disclosure:

FIG. 9 illustrates an example procedure for applying TCI states for first/second downlink and uplink channels/signals according to embodiments of the present disclosure:

FIG. 10 illustrates an example procedure for applying TCI states for first/second downlink and uplink channels/signals according to embodiments of the present disclosure:

FIG. 11 illustrates a flow diagram for UE-initiated beam switching according to embodiments of the present disclosure:

FIG. 12 illustrates a table of example mapping between indicator/trigger identifications (IDs) and channel state information (CSI) report settings for beam reporting according to embodiments of the present disclosure:

FIG. 13 illustrates a table of example mapping between indicator/trigger IDs and CSI resource settings for beam reporting according to embodiments of the present disclosure:

FIG. 14 illustrates a table of example mapping between indicator/trigger IDs and CSI resource sets for beam reporting according to embodiments of the present disclosure:

FIG. 15 illustrates a table of example mapping between TCI state IDs and CSI report settings for beam reporting according to embodiments of the present disclosure:

FIG. 16 illustrates a table of example mapping between TCI state IDs and CSI resource settings for beam reporting according to embodiments of the present disclosure;

FIG. 17 illustrates a table of example mapping between TCI state IDs and CSI resource sets for beam reporting according to embodiments of the present disclosure;

FIG. 18 illustrates a flow diagram for an example beam operation according to embodiments of the present disclosure;

FIG. 19 illustrates a flow diagram for UE-initiated beam switching according to embodiments of the present disclosure;

FIG. 20 illustrates a flow diagram for UE-initiated beam switching according to embodiments of the present disclosure;

FIG. 21 illustrates a flow diagram for UE-initiated beam switching according to embodiments of the present disclosure;

FIG. 22 illustrates an example UE-initiated TCI state(s) switching activation/deactivation medium access control (MAC) control element (CE) command according to embodiments of the present disclosure; and

FIG. 23 illustrates an example method performed by a UE in a wireless communication system according to embodiments of the present disclosure.

### DETAILED DESCRIPTION

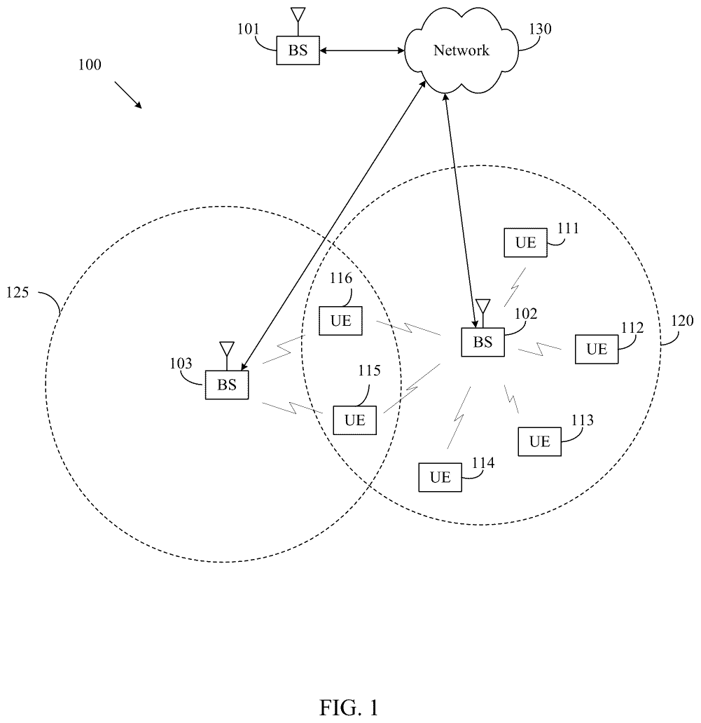

FIGS. 1-23, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [1] 3GPP TS 38.211 v16.1.0. “NR; Physical channels and modulation;” [2] 3GPP TS 38.212 v16.1.0. “NR; Multiplexing and Channel coding;” [3] 3GPP TS 38.213 v16.1.0. “NR; Physical Layer Procedures for Control;” [4] 3GPP TS 38.214 v16.1.0. “NR; Physical Layer Procedures for Data;” [5] 3GPP TS 38.321 v16.1.0. “NR; Medium Access Control (MAC) protocol specification;” and [6] 3GPP TS 38.331 v16.1.0. “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station. B), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A). WiMAX. WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE). LTE advanced (LTE-A), high speed packet access (HSPA). Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station.” “subscriber station.” “remote terminal.” “wireless terminal.” “receive point.” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for performing UE-initiated beam management. In certain embodiments, one or more of the BSs 101-103 include circuitry, programing, or a combination thereof to support UE-initiated beam management.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

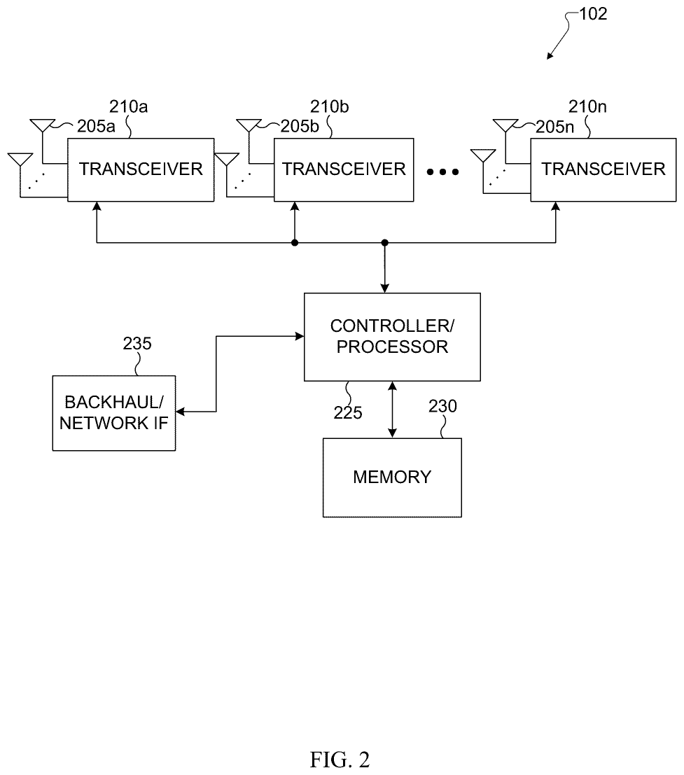

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as supporting UE-initiated beam management. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR. LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

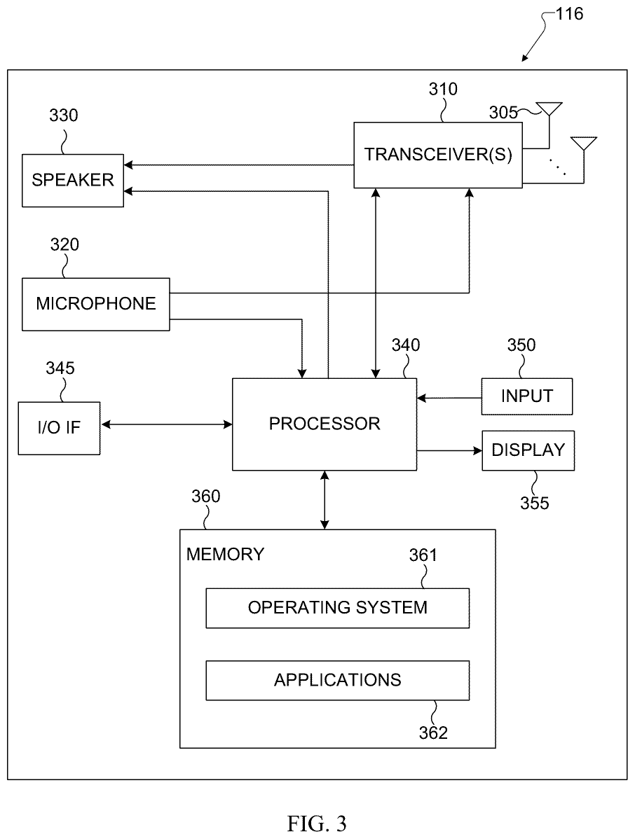

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However. UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes to perform UE-initiated beam management as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone. UEs could be configured to operate as other types of mobile or stationary devices.

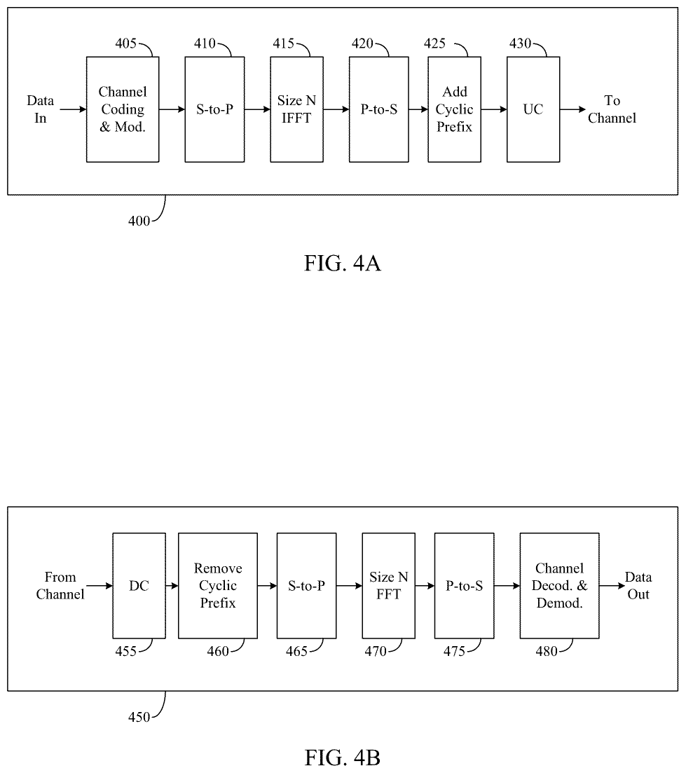

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or receive path 450 is configured to support UE-initiated beam management as described in embodiments of the present disclosure.

As illustrated in FIG. 4A, the transmit path 400 includes a channel coding and modulation block 205, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 250 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

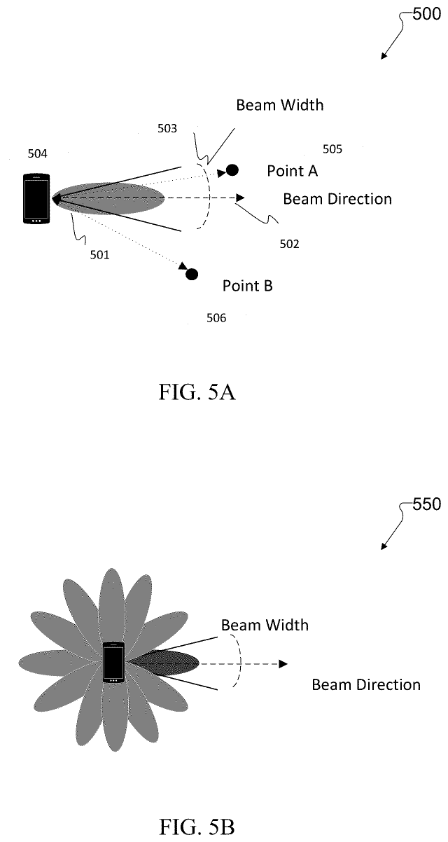

As illustrated in FIG. 5A, in a wireless system 500, a beam 501 for a device 504 can be characterized by a beam direction 502 and a beam width 503. For example, the device 504 (or UE 116) transmits RF energy in a beam direction and within a beam width. The device 504 receives RF energy in a beam direction and within a beam width. As illustrated in FIG. 5A, a device at point A 505 can receive from and transmit to device 504 as Point A is within a beam width and direction of a beam from device 504. As illustrated in FIG. 5A, a device at point B 506 cannot receive from and transmit to device 504 as Point B 506 is outside a beam width and direction of a beam from device 504. While FIG. 5A, for illustrative purposes, shows a beam in 2-dimensions (2D), it should be apparent to those skilled in the art, that a beam can be in 3-dimensions (3D), where the beam direction and beam width are defined in space.

FIG. 5B illustrates an example of a multi-beam operation 550 according to embodiments of the present disclosure. For example, the multi-beam operation 550 can be utilized by UE 116 of FIG. 3. This example is for illustration only and other embodiments can be used without departing from the scope of the present disclosure.

In a wireless system, a device can transmit and/or receive on multiple beams. This is known as “multi-beam operation”. While FIG. 5B, for illustrative purposes, a beam is in 2D, it should be apparent to those skilled in the art, that a beam can be 3D, where a beam can be transmitted to or received from any direction in space.

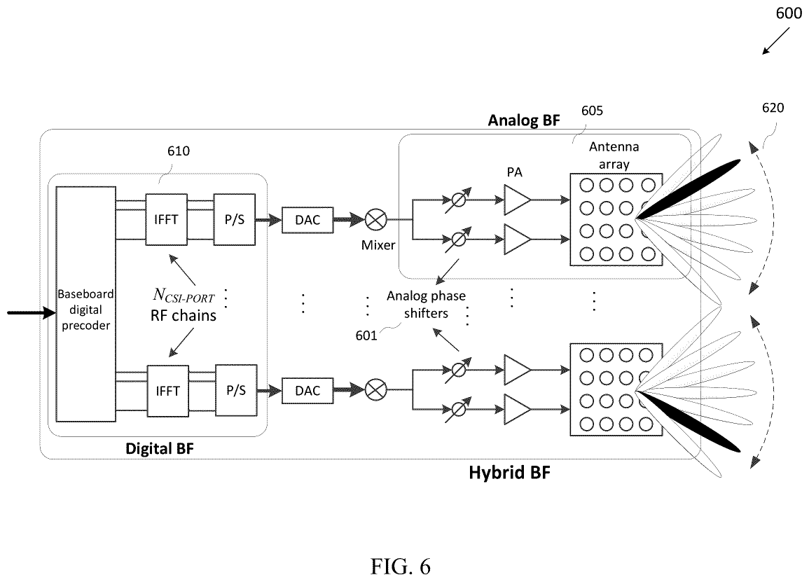

FIG. 6 illustrates an example of a transmitter structure 600 for beamforming according to embodiments of the present disclosure. In certain embodiments, one or more of gNB 102 or UE 116 includes the transmitter structure 600. For example, one or more of antenna 205 and its associated systems or antenna 305 and its associated systems can be included in transmitter structure 600. This example is for illustration only and other embodiments can be used without departing from the scope of the present disclosure.

Accordingly, embodiments of the present disclosure recognize that Rel-14 LTE and Rel-15 NR support up to 32 channel state information reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 6. Then, one CSI-RS port can be mapped onto a large number of antenna elements that can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or slots/subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 600 of FIG. 6 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 6 is also applicable to higher frequency bands such as >52.6 GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are needed to compensate for the additional path loss.

The text and figures are provided solely as examples to aid the reader in understanding the present disclosure. They are not intended and are not to be construed as limiting the scope of the present disclosure in any manner. Although certain embodiments and examples have been provided, it will be apparent to those skilled in the art based on the disclosures herein that changes in the embodiments and examples shown may be made without departing from the scope of the present disclosure. The transmitter structure 600 for beamforming is for illustration only and other embodiments can be used without departing from the scope of the present disclosure.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Any of the above variation embodiments can be utilized independently or in combination with at least one other variation embodiment.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of subject matter is defined by the claims.

In this disclosure, a beam is determined by either of:
A TCI state, that establishes a quasi-colocation (QCL) relationship between a source reference signal (e.g., SSB and/or CSI-RS) and a target reference signal; or
A spatial relation information that establishes an association to a source reference signal, such as SSB or CSI-RS or sounding reference signal (SRS).

In either case, the ID of the source reference signal identifies the beam.

The TCI state and/or the spatial relation reference RS can determine a spatial Rx filter for reception of downlink channels at the UE (e.g., the UE 116), or a spatial TX filter for transmission of uplink channels from the UE.

In (up to Rel. 17) NR specification, the most resource-efficient reporting mechanism for a content (e.g., beam. CSI etc., or in general different report quantities) is aperiodic (in conjunction with aperiodic CSI-RS). On the other hand, with a well-chosen periodicity, periodic reporting (followed by semi-persistent) results in the lowest latency at the expense of resources. Although aperiodic reporting seems preferred from the overall operational perspective, in a few relevant scenarios the NW/gNB lacks knowledge on the DL channel condition—or, in other words, the UE knows the DL channel condition better. In this case, it is clearly beneficial if the UE can initiate its own aperiodic reporting for a content (e.g., beam. CSI etc.) or trigger a beam switching for a condition or event. For instance, when the UE is configured only with aperiodic beam reporting and the channel condition is worsened to the point of beam failure, the loss of link due to beam failure can be avoided if the UE can transmit an aperiodic beam report without having to wait for a beam report request/trigger from the NW/gNB or trigger a new beam update without having to wait for a beam change or update indication from the NW/gNB. Likewise, when the UE is configured only with aperiodic CSI reporting and the channel condition is worsened due to UE speed/movement, the performance degradation due to faster link quality degradation can be avoided if the UE can transmit an aperiodic CSI report without having to wait for a CSI request/trigger from the NW/gNB or trigger a new beam update without having to wait for a beam change or update indication from the NW/gNB. Such UE-initiated reporting and/or beam switching for a content can be enabled for other types of report quantities (different from common beam or CSI reports) and application scenarios.

Although UE-initiated reporting and/or beam switching can be beneficial, efficient designs are needed to ensure that the latency is reduced and, at the same time, error events can be minimized. Therefore, embodiments of the present disclosure recognize that there is a need for efficient designs for UE-initiated reporting and/or beam switching for a content that can offer good trade-off between latency and reliability. In particular, when the UE-initiated beam management framework can include multiple report types (or report quantities) or/and multiple event types when a report types can be associated with an event (e.g., for beam report, the event can be beam failure, and for CSI, the event can be user throughput degradation or increasing retransmission rate). This disclosure provides example embodiments on the mentioned UE-initiated beam management herein including reporting and beam switching.

The present disclosure provides various novel and detailed design examples on the UE-initiated beam management including UE-initiated/triggered reporting and/or UE-initiated/triggered beam switching.

In the present disclosure, a UE detects (or determines) a need for transmitting a UE-initiated/UE-triggered report (or initiation/triggering) of a (report-)type (A), (B), or (C), where:
(A) includes an initiator/trigger/pre-notification message.
(B) includes a report/content (comprising one or multiple report quantities).
(C) includes both a trigger/pre-notification message and a (corresponding) report/content.

The report is to facilitate/enable efficient/timely/fast/reliable communication over the link/channel between a target entity (e.g., NW/gNB or another device) and the UE, and the content (if reported) can include a quantity or quantities. At least one of the following examples can be used/configured for the content:
In one example, the content includes beam-related quantity/quantities. For example, up to N≥1 indicators {Iᵢ} or pairs of {(Iᵢ,Jᵢ)}, where Iᵢ is a beam (source RS) indicator (e.g., channel quality indicator report interval (CRI), synchronization signal block resource indicator (SSBRI)) and Jᵢ is a beam metric (e.g., L1-RSRP. L1-SINR).
In one example, the content includes CSI-related quantity/quantities. For example, at least one of ((rank indicator (RI), precoding matrix indicator (PMI), channel quality indicator (CQI), CQI report interval (CRI), layer index (LI))).
In one example, the content includes TDCP-related quantity/quantities. For example, an indicator about the Doppler profile (e.g., Doppler spread or Doppler shift, relative Doppler spreads, or relative Doppler shifts), or an indicator about the auto-correlation profiles (e.g. (auto-) correlation values corresponding to a few dominant lags/delays).
In one example, the content includes other (e.g., non-beam, non-CSI, non-TDCP) quantity/quantities.
   In one example, quantity/quantities comprises a selector/indicator indicating selection of one (or >1) of either:
      beam (TCI state) TCI states (e.g., DL TCI state, UL TCI state, or unified (joint) DL/UL TCI state), or
      panel(s) (e.g., UE panels for DL reception or/and UL transmission), or
      antenna(e) (e.g., UE antennae for DL reception or/and UL transmission), or
      antenna port(s) (e.g., UE antenna ports for DL reception or/and UL transmission).
   In one example, quantity/quantities comprises an indicator indicating switching from one beam to another beam, or from one panel to another, or from one antenna port group to another antenna port group, or from N₁ SRS ports to N₂ SRS ports, where N₁≠N₂ (e.g., this switching is for DL reception or/and UL transmission).
In one example, the content includes beam-related quantity/quantities (one or more examples described herein) and at least one other quantity/quantities (one or more examples described herein).
In one example, the content includes CSI-related quantity/quantities (one or more examples described herein) and at least one other quantity/quantities (one or more examples described herein).
In one example, the content includes TDCP-related quantity/quantities (one or more examples described herein) and at least one other quantity/quantities (one or more examples described herein).
In one example, the content includes beam-related quantity/quantities (one or more examples described herein) and CSI-related quantity/quantities (one or more examples described herein).
In one example, the content includes beam-related quantity/quantities (one or more examples described herein) and TDCP-related quantity/quantities (one or more examples described herein).
In one example, the content includes TDCP-related quantity/quantities (one or more examples described herein) and CSI-related quantity/quantities (one or more examples described herein).

In one example, the report is targeting a physical layer (L1) communication (e.g., L1 DL/UL, or L1 sidelink (SL)). i.e., such reporting is to enable fast/reliable DL/UL or SL transmission/reception.

In one example, the link/channel between the target entity and the UE is a Uu interface (i.e., DL, UL).

In one example, the link/channel between the target entity and the UE is a sidelink (SL), or a device-to-device (D2D) or PC5 interface.

In one example, such reporting can be non-event-based or autonomous, the UE can initiate/trigger the report autonomously (i.e., without being associated with any event) or unconditionally/freely. For example, the UE can be configured with a triggering time window (or multiple UL slots), and the UE can trigger the report during this window.

In one example, such reporting can be event-based. i.e., the UE can initiate/trigger the report only when it detects an event associated with the report, where the event can be of a (event-)type: type 0, type 1, and so on. In one example, type 0 corresponds to a beam-related event, type 1 corresponds to a CSI-related event, type 2 corresponds to a time-domain channel property (TDCP)-related event, and type 3 can be a non-CSI-related event (examples provided later). In one example, if a metric (depending on the event-type) is less than or equal to a threshold (or greater than or equal to a threshold), the event is detected or declared positive. The threshold is chosen such that a failure (e.g., beam/link failure) can be detected before it actually happens, and the UE-initiated report can avoid the failure.

In one example, such reporting can be non-event-based or event-based, based on report-type.

In one example, such reporting can be non-event-based or event-based, based on a configuration.

A few examples of the event-types and the report-types are provided in Table 1 (for joint) and Table 2/Table 3 (for separate). In these examples, the event-types and the report-types are separate (explicit). However, they can also be joint, as shown in Table 4. A few examples of the autonomous UE-initiated report are shown in Table 5.

TABLE 1
event-based UE-initiated report

| | Report | | |
|---|---|---|---|
| Event type | Type | Trigger/pre-notification message | Content |
| 0: beam | (A) | Yes (e.g., beam-related event) | No |
| | (B) | No | Yes |
| | (C) | Yes (e.g., beam-related event) | Yes |
| 1: CSI | (A) | Yes (e.g., CSI-related event) | No |
| | (B) | No | Yes |
| | (C) | Yes (e.g., CSI-related event) | Yes |
| 2: TDCP | (A) | Yes (e.g., TDCP-related event) | No |
| | (B) | No | Yes |
| | (C) | Yes (e.g., TDCP-related event) | Yes |
| 3: non-CSI/ | (A) | Yes (e.g., non-CSI-related event) | No |
| beam/TDCP | (B) | No | Yes |
| | (C) | Yes (e.g., non-CSI-related event) | Yes |
| 4. other (content- | (A) | Yes (no need for content) | No |
| free/less events) | | | |

TABLE 2
event-based UE-initiated report

| Event-type | Event |
|---|---|
| 0 | Beam-related |
| 1 | CSI-related |
| 2 | TDCP-related |
| 3 | Non-beam/CSI/TDCP |
| 4 | Other |

TABLE 3
event-based UE-initiated report

| Report-type | Trigger/pre-notification message | Content |
|---|---|---|
| (A) | Yes | No |
| (B) | No | Yes |
| (C) | Yes | Yes |

TABLE 4
event-based UE-initiated report
Report

| Type | Trigger/pre-notification message | Content |
|---|---|---|
| 0 | Yes (e.g., beam-related event), | No |
| | content-specific or event-specific | |
| 1 | No | Beam |
| 2 | Yes (e.g., beam-related event) | Beam |
| 3 | Yes (e.g., CSI-related event) | No |
| 4 | No | CSI |
| 5 | Yes (e.g., CSI-related event) | CSI |
| 6 | Yes (e.g., TDCP-related event) | No |
| 7 | No | TDCP |
| 8 | Yes (e.g., TDCP-related event) | TDCP |
| 9 | Yes (e.g., non-CSI-related event) | No |
| 10 | No | Non-CSI |
| 11 | Yes (e.g., non-CSI-related event) | Non-CSI |

TABLE 5
non-event-based or autonomous UE-initiated report
Report

| Type | Trigger/pre-notification message | Content |
|---|---|---|
| 0 | Yes (content-agnostic/transparent) | No |
| 1 | No | Beam |
| 2 | Yes | Beam |
| 3 | No | CSI |
| 4 | Yes | CSI |
| 5 | No | TDCP |
| 6 | Yes | TDCP |
| 7 | No | Non-CSI |
| 8 | Yes | Non-CSI |

In one embodiment, a UE could send to the network (e.g., the network 130) one or more indicators to indicate, initiate or trigger update(s)/change(s) of one or more beams and/or transmission configuration indication (TCI) states (and therefore, quasi-co-location (QCL) settings including QCL source RS(s) and the corresponding QCL type(s) provided/configured therein) and/or spatial relation settings for receiving/transmitting one or more DL/UL channels and/or signals. Throughout this disclosure, a TCI state can also be referred to as a beam or a spatial relation setting; i.e., they can be used/applied interchangeably to various design examples throughout the present disclosure; for instance, a spatial relation or spatial relation setting for determining an UL Tx spatial filter can be with a reference to an RS in the indicated TCI state. Furthermore, throughout the present disclosure. “trigger” can also be referred to as “initiate” or “indicate”; i.e., they can be used/applied interchangeably to various design examples throughout the present disclosure. For instance, the UE could send to the network an indicator to trigger a TCI state change/update/switch for one or more channels or signals. The indicator could comprise/include/contain or correspond to one or more of:
An identity (ID) of the TCI state.
An index/ID of a higher layer RRC configured list/set/pool of TCI states that comprises/indicates/provides the TCI state.
An index of the TCI state in a list/set/pool of TCI states higher layer RRC configured to the UE.
An index of the TCI state in a set of TCI states activated by a (unified) TCI state(s) activation/deactivation MAC CE.
An index/ID of a set of TCI states—e.g., among sets of TCI states activated/provided by a (unified) TCI state(s) activation/deactivation MAC CE—that comprises/indicates/provides the TCI state.
A TCI codepoint activated/provided by a (unified) TCI state(s) activation/deactivation MAC CE that comprises/indicates/provides the TCI state.
An index/ID of a TCI codepoint—e.g., among TCI codepoints activated/provided by a (unified) TCI state(s) activation/deactivation MAC CE—that comprises/indicates/provides the TCI state.
An index/ID of or information related to a (unified) TCI state(s) activation/deactivation MAC CE that activates the TCI state or a TCI codepoint that comprises/indicates/provides the TCI state; the information could include/comprise/contain/indicate when (e.g., reception time in form of slot/slot index/etc.) the (unified) TCI state(s) activation/deactivation MAC CE was received.
An index/ID of or information related to a beam indication downlink control information (DCI) that provides/indicates the TCI state or a TCI codepoint that comprises/indicates/provides the TCI state; the information could include/comprise/contain/indicate when (e.g., reception time in form of slot/slot index/etc.) the beam indication DCI was received.
An index/ID of a CORESET or a coresetPoolIndex/coresetGroupIndex associated to a CORESET, in which a beam indication DCI that provides/indicates the TCI state or a TCI codepoint that comprises/indicates/provides the TCI state was received, and/or
RS index(es)/ID(s) such as SSB index(es)/ID(s) and/or CSI-RS resource index(es)/ID(s) provided/indicated in the TCI state along with the corresponding QCL-type(s).

Furthermore, as described herein in the present disclosure, the indicator could be for one or more DL/UL channels and/or signals. Specifically, for transmitting/receiving DL/UL channel(s):
In one example, the indicator could trigger a TCI state change/update/switch for applicable DL and UL channels including, e.g., UE-dedicated physical downlink shared channel (PDSCH)/physical downlink control channel (PDCCH) and dynamic-grant/configured-grant based physical uplink shared channel (PUSCH) and dedicated physical uplink control channel (PUCCH) resources.
In another example, the indicator could trigger a TCI state change/update/switch for one or more of applicable DL and/or UL channels including, e.g., UE-dedicated PDSCH and/or UE-dedicated PDCCH and/or dynamic-grant/configured-grant based PUSCH and/or dedicated PUCCH resources.
In yet another example, the indicator could trigger a TCI state change/update/switch only for applicable DL channel(s) including, e.g., UE-dedicated PDSCH and/or PDCCH.
   For example, the indicator could trigger a TCI state change/update/switch only for PDCCH and PDSCH receptions including, e.g., UE-dedicated reception(s) of PDSCH(s) and PDCCH(s).
   For another example, the indicator could trigger a TCI state change/update/switch only for PDSCH(s) reception including, e.g., UE-dedicated reception(s) of PDSCH(s).
   Yet for another example, the indicator could trigger a TCI state change/update/switch only for PDCCH(s) reception including, e.g., UE-dedicated reception(s) of PDCCH(s).
In yet another example, the indicator could trigger a TCI state change/update/switch only for applicable UL channel(s) including, e.g., dynamic-grant/configured-grant based PUSCH and/or dedicated PUCCH resources.
   For example, the indicator could trigger a TCI state change/update/switch only for PUSCH and PUCCH transmissions including, e.g., dynamic-grant/configured-grant based PUSCH and dedicated PUCCH resources.
   For another example, the indicator could trigger a TCI state change/update/switch only for PUSCH(s) transmission, including, e.g., dynamic-grant/configured-grant based PUSCH.
   Yet for another example, the indicator could trigger a TCI state change/update/switch only for PUCCH(s) transmission, including, e.g., dedicated PUCCH resources.
In yet another example, the indicator could trigger a TCI state change/update/switch only for applicable DL/UL control channel(s) including, e.g., UE-dedicated PDCCH and/or dedicated PUCCH resources.
   For example, the indicator could trigger a TCI state change/update/switch only for DL and UL control channels including, e.g., UE-dedicated PDCCH and dedicated PUCCH resources.
   For another example, the indicator could trigger a TCI state change/update/switch only for DL control channel(s) reception including, e.g., UE-dedicated reception(s) of PDCCH(s).
   Yet for another example, the indicator could trigger a TCI state change/update/switch only for UL control channel(s) transmission including, e.g., of dedicated PUCCH resources.
In yet another example, the indicator could trigger a TCI state change/update/switch only for applicable DL/UL shared data channel(s) including, e.g., UE-dedicated PDSCH and/or dynamic-grant/configured-grant based PUSCH.
   For example, the indicator could trigger a TCI state change/update/switch only for DL and UL shared data channels including, e.g., UE-dedicated PDSCH and dynamic-grant/configured-grant based PUSCH.
   For another example, the indicator could trigger at TCI state change/update/switch only for DL shared data channel(s) reception including, e.g., UE-dedicated reception(s) of PDSCH(s).
   Yet for another example, the indicator could trigger a TCI state change/update/switch only for UL shared data channel(s) transmission including, e.g., dynamic-grant/configured-grant based PUSCH.

Furthermore, for transmitting/receiving DL/UL signal(s):
In one example, the indicator could trigger a TCI state change/update/switch for applicable DL and UL signals including, e.g., (aperiodic) CSI-RS resources and (aperiodic) SRS resources.
In another example, the indicator could trigger a TCI state change/update/switch for one or more of applicable DL and/or UL signals including, e.g., (aperiodic) CSI-RS resources and/or (aperiodic) SRS resources.
In yet another example, the indicator could trigger a TCI state change/update/switch only for DL signal(s) reception including, e.g., (aperiodic) CSI-RS resources.
In yet another example, the indicator could trigger a TCI state change/update/switch only for UL signal(s) transmission including, e.g., (aperiodic) SRS resources.

In the present disclosure, a UE could send to the network, e.g., in part of CSI/beam report and/or the indicator(s) as described herein in the present disclosure, one or more channel/signal indicators to indicate which one or more of the DL and UL channels and signals the TCI state(s) change/update/switch triggered/indicated/initiated by the indicator(s) as described herein in the present disclosure is applied to, according to one or more of the design examples (e.g., one or more examples described herein) specified herein in the present disclosure.
In one example, the channel/signal indicator(s) could be a one-bit indicator. For instance, the one-bit channel/signal indicator could be applied to one or more examples described herein; for this case, when/if the one-bit channel/signal indicator is set to ‘0’ (or ‘1’), the one-bit channel/signal indicator could indicate that the indicator(s) as specified herein in the present disclosure could trigger a TCI state change/update/switch only for applicable DL channel(s) including, e.g., UE-dedicated PDSCH and/or PDCCH (i.e., according to one or more example described herein); when/if the one-bit channel/signal indicator is set to ‘1’ (or ‘0’), the one-bit channel/signal indicator could indicate that the indicator(s) as specified herein in the present disclosure could trigger a TCI state change/update/switch only for applicable UL channel(s) including, e.g., dynamic-grant/configured-grant based PUSCH and/or dedicated PUCCH resources; optionally, when/if the one-bit channel/signal indicator is not present/reported, the indicator(s) as specified herein in the present disclosure could trigger a TCI state change/update/switch for applicable DL and UL channels including, e.g., UE-dedicated PDSCH/PDCCH and dynamic-grant/configured-grant based PUSCH and dedicated PUCCH resources. The one-bit channel/signal indicator as described herein in the present disclosure could be applied to other design examples specified herein in the present disclosure.
In another example, the channel/signal indicator(s) could be a bitmap with each entry/bit position of the bitmap corresponding to a DL or UL channel or signal. For this case, when/if an entry/bit position of the bitmap is set to ‘1’ (or ‘0’), the TCI state change/update/switch triggered by the indicator(s) as specified herein in the present disclosure could apply to the DL or UL channel or signal corresponding to the entry/bit position of the bitmap.
In yet another example, the channel/signal indicator(s) could be a bitmap with each entry/bit position of the bitmap corresponding to one or more DL and/or UL channels and/or signals. For this case, when/if an entry/bit position of the bitmap is set to ‘1’ (or ‘0’), the TCI state change/update/switch triggered by the indicator(s) as specified herein in the present disclosure could apply to the one or more DL and/or UL channels and/or signals corresponding to the entry/bit position of the bitmap according to one or more of the design examples specified herein in the present disclosure.

The indicator(s) described herein in the present disclosure could correspond to the trigger/pre-notification message in a (report-)type (A) based report or a (report-)type (C) based report, or part of the (corresponding) content in a (report-)type (B) based report or a (report-)type (C) based report. Furthermore, the signaling medium/container for reporting the indicator(s) as specified herein in the present disclosure (or equivalently, the trigger/pre-notification message in a (report-)type (A) based report or a (report-)type (C) based report, or part of the (corresponding) content in a (report-)type (B) based report or a (report-)type (C) based report) could be PUCCH. PUSCH, physical random access channel (PRACH), MAC CE, uplink control information (UCI), etc. The UE (e.g., the UE 116) may expect to receive from the network an acknowledgement (ACK) (or negative ACK (NACK)) for the indicator(s) specified herein in the present disclosure within a first time window/offset (e.g., in terms of the number of slots/symbols/etc.) starting from the transmission of the indicator(s) (e.g., starting from the corresponding slot/symbol/etc.). The value of the first time window/offset could be: (i) fixed in the system specification(s), (ii) configured/provided/indicated by the network, e.g., via higher layer RRC signaling/parameter and/or MAC CE command and/or dynamic DCI based L1 signaling, or (iii) autonomously determined by the UE and sent to the network via uplink channels such as PUCCH/PUSCH.
When/if the UE does not receive from the network an ACK for the indicator(s) within the first time window/offset starting from the transmission of the indicator(s) or receives a NACK for the indicator(s) within the first time window/offset starting from the transmission of the indicator(s), the UE could (re-)send the indicator(s).
When/if the UE receives from the network an ACK for the indicator(s) within the first time window/offset starting from the transmission of the indicator(s), the UE may perform the behaviors/operations and/or expect the corresponding network's operations according to the indicator(s) X duration/offset/time (e.g., X symbols/slots/etc.) starting from the reception of the ACK message for the indicator(s). The value of X could be: (i) fixed in the system specification(s), (ii) configured/provided/indicated by the network, e.g., via higher layer RRC signaling/parameter and/or MAC CE command and/or dynamic DCI based L1 signaling, or (iii) autonomously determined by the UE and sent to the network via uplink channels such as PUCCH/PUSCH.

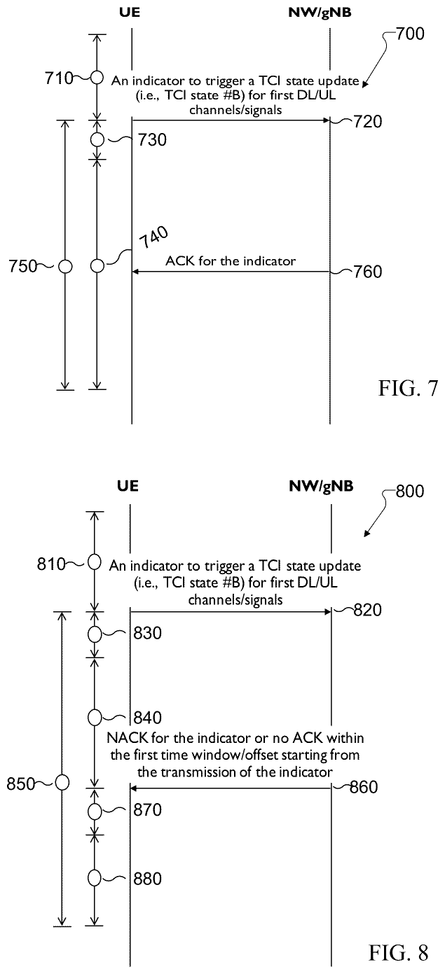

FIG. 7 illustrates an example procedure 700 for applying TCI states for first/second downlink and uplink channels/signals according to embodiments of the present disclosure. For example, procedure 700 for applying TCI states for first/second downlink and uplink channels/signals may be performed by the UE 116 and the gNB 102 and/or network 130 in the wireless network 100 of FIG. 1. This example is for illustration only and other embodiments can be used without departing from the scope of the present disclosure.

The procedure begins in 710, a UE applies TCI state #A for first/second DL channels/signals and first/second UL channels/signals. In 720, the UE sends to the NW/gNB an indicator to trigger a TCI state update (i.e., TCI state #B) for first DL/UL channels/signals. In 730, a n1 duration/offset/time (e.g., symbols/slots) applies TCI state #A for first DL and UL channels/signals. In 740, the UE applies TCI state #B for first DL and UL channels/signals. In 740, the UE applies TCI state #A for second DL and UL channels/signals. In 750, the NW/gNB sends to the UE an ACK for the indicator.

FIG. 8 illustrates an example procedure 800 for applying TCI states for first/second downlink and uplink channels/signals according to embodiments of the present disclosure. For example, procedure 800 for applying TCI states for first/second downlink and uplink channels/signals may be performed by the UE 111 and the gNB 102 and/or network 130 in the wireless network 100 of FIG. 1. This example is for illustration only and other embodiments can be used without departing from the scope of the present disclosure.

The procedure begins in 810, a UE applies TCI state #A for first/second DL channels/signals and first/second UL channels/signals. In 820, the UE sends to the NW/gNB an indicator to trigger a TCI state update (i.e., TCI state #B) for first DL/UL channels/signals. In 830, a n1 duration/offset/time applies TCI state #A for first DL and UL channels/signals. In 840, the UE applies TCI state #B for first Dl and UL channels/signals. In 850, the UE applies TCI state #A for second DL and UL channels/signals. In 860, the NW/gNB sends to the UE a NACK for the indicator or no ACK within the first time window/offset starting from the transmission of the indicator. In 870, a n2 duration/offset/time (e.g., symbols/slots) applies TCI state #B for first DL and UL channels/signals. In 880, the UE applies TCI state #A for first DL and UL channels/signals.

In one embodiment, after a UE has sent to the network the one or more indicators as specified herein in the present disclosure and before the UE receives from the network an ACK/NACK for the indicator(s) as specified herein in the present disclosure, when/if the indicator(s) triggers a TCI state change/update/switch. e.g., from a previously/currently applied TCI state #A to a new TCI state #B, only for one or more first DL channel(s)/signal(s) and first UL channel(s)/signal(s) according to those specified herein in the present disclosure:
For the first DL channel(s)/signal(s), n1 duration/offset/time (e.g., n1 symbols/slots/etc.) starting from or after the last symbol/slot of the transmission of the indicator(s), the UE could set their (spatial domain) receive filter(s) according to the QCL source RS(s) and QCL type(s) provided/indicated/configured in the new TCI state #B to receive the first DL channel(s)/signal(s). The value of n1 could be: (i) fixed in the system specification(s), (ii) configured/provided/indicated by the network, e.g., via higher layer RRC signaling/parameter and/or MAC CE command and/or dynamic DCI based L1 signaling, and/or (iii) autonomously determined by the UE and sent to the network via uplink channels such as PUCCH/PUSCH. Before setting their (spatial domain) receive filter(s) according to the QCL source RS(s) and QCL type(s) provided/indicated/configured in the new TCI state #B to receive the first DL channel(s)/signal(s), the UE could keep setting their (spatial domain) receive filter(s) according to the QCL source RS(s) and QCL type(s) provided/indicated/configured in the previously/currently applied TCI state #A to receive the first DL channel(s)/signal(s).
For the first UL channel(s)/signal(s), n1 duration/offset/time (e.g., n1 symbols/slots/etc.) starting from or after the last symbol/slot of the transmission of the indicator(s), the UE could set their (spatial domain) transmit filter(s) according to the QCL source RS(s) and QCL type(s) provided/indicated/configured in the new TCI state #B to transmit the first UL channel(s)/signal(s). The value of n1: (i) fixed in the system specification(s), (ii) configured/provided/indicated by the network, e.g., via higher layer RRC signaling/parameter and/or MAC CE command and/or dynamic DCI based L1 signaling, and/or (iii) autonomously determined by the UE and sent to the network via uplink channels such as PUCCH/PUSCH. Before setting their (spatial domain) receive filter(s) according to the QCL source RS(s) and QCL type(s) provided/indicated/configured in the new TCI state #B to receive the second DL channel(s)/signal(s), the UE could keep setting their (spatial domain) receive filter(s) according to the QCL source RS(s) and QCL type(s) provided/indicated/configured in the previously/currently applied TCI state #A to receive the second DL channel(s)/signal(s).
For one or more second DL channels/signals (which the TCI state change/update/switch triggered by the indicator(s) does not apply to), the UE could set their (spatial domain) receive filter(s) according to the QCL source RS(s) and QCL type(s) provided/indicated/configured in the previously/currently applied TCI state #A to receive the second DL channel(s)/signal(s).
For one or more second UL channels/signals (which the TCI state change/update/switch triggered by the indicator(s) does not apply to), the UE could set their (spatial domain) transmit filter(s) according to the QCL source RS(s) and QCL type(s) provided/indicated/configured in the previously/currently applied TCI state #A to transmit the second UL channel(s)/signal(s).

Furthermore, when/if the UE receives an ACK for the indicator(s) as described herein in the present disclosure:
For the first DL channel(s)/signal(s), upon/after reception of the ACK, the UE could keep setting their (spatial domain) receive filter(s) according to the QCL source RS(s) and QCL type(s) provided/indicated/configured in the new TCI state #B to receive the first DL channel(s)/signal(s).
For the first UL channel(s)/signal(s), upon/after reception of the ACK, the UE could keep setting their (spatial domain) transmit filter(s) according to the QCL source RS(s) and QCL type(s) provided/indicated/configured in the new TCI state #B to transmit the first UL channel(s)/signal(s).
For the second DL channels/signals (which the TCI state change/update/switch triggered by the indicator(s) does not apply to), upon/after reception of the ACK, the UE could keep setting their (spatial domain) receive filter(s) according to the QCL source RS(s) and QCL type(s) provided/indicated/configured in the previously/currently applied TCI state #A to receive the second DL channel(s)/signal(s).
For the second UL channels/signals (which the TCI state change/update/switch triggered by the indicator(s) does not apply to), upon/after reception of the ACK, the UE could keep setting their (spatial domain) transmit filter(s) according to the QCL source RS(s) and QCL type(s) provided/indicated/configured in the previously/currently applied TCI state #A to transmit the second UL channel(s)/signal(s).

When/if the UE receives a NACK for the indicator(s) as described herein in the present disclosure, or the UE does not receive an ACK for the indicator(s) within the first time window/offset starting from the transmission of the indicator(s) as specified herein in the present disclosure:
For the first DL channel(s)/signal(s), n2 duration/offset/time (e.g., n2 symbols/slots/etc.) starting from or after reception (e.g., the last symbol/slot) of the NACK for the indicator(s) or n2 duration/offset/time (e.g., n2 symbols/slots/etc.) starting from or after not receiving (e.g., the last symbol/slot) an ACK for the indicator(s) within the first time window/offset starting from the transmission of the indicator(s), the UE could set their (spatial domain) receive filter(s) according to the QCL source RS(s) and QCL type(s) provided/indicated/configured in the previously/currently applied TCI state #A to receive the first DL channel(s)/signal(s). The value of n2 could be: (i) fixed in the system specification(s), (ii) configured/provided/indicated by the network, e.g., via higher layer RRC signaling/parameter and/or MAC CE command and/or dynamic DCI based L1 signaling, and/or (iii) autonomously determined by the UE and sent to the network via uplink channels such as PUCCH/PUSCH. Before setting their (spatial domain) receive filter(s) according to the QCL source RS(s) and QCL type(s) provided/indicated/configured in the previously/currently applied TCI state #A to receive the first DL channel(s)/signal(s), the UE could keep setting their (spatial domain) receive filter(s) according to the QCL source RS(s) and QCL type(s) provided/indicated/configured in the new TCI state #B to receive the first DL channel(s)/signal(s).
For the first UL channel(s)/signal(s), n2 duration/offset/time (e.g., n2 symbols/slots/etc.) starting from or after reception (e.g., the last symbol/slot) of the NACK for the indicator(s) or n2 duration/offset/time (e.g., n2 symbols/slots/etc.) starting from or after not receiving (e.g., the last symbol/slot) an ACK for the indicator(s) within the first time window/offset starting from the transmission of the indicator(s), the UE could set their (spatial domain) transmit filter(s) according to the QCL source RS(s) and QCL type(s) provided/indicated/configured in the previously/currently applied TCI state #A to transmit the first UL channel(s)/signal(s). The value of n2 could be: (i) fixed in the system specification(s), (ii) configured/provided/indicated by the network, e.g., via higher layer RRC signaling/parameter and/or MAC CE command and/or dynamic DCI based L1 signaling, and/or (iii) autonomously determined by the UE and sent to the network via uplink channels such as PUCCH/PUSCH. Before setting their (spatial domain) transmit filter(s) according to the QCL source RS(s) and QCL type(s) provided/indicated/configured in the previously/currently applied TCI state #A to transmit the first UL channel(s)/signal(s), the UE could keep setting their (spatial domain) transmit filter(s) according to the QCL source RS(s) and QCL type(s) provided/indicated/configured in the new TCI state #B to transmit the first UL channel(s)/signal(s).
For the second DL channels/signals (which the TCI state change/update/switch triggered by the indicator(s) does not apply to), upon/after reception of the NACK, the UE could keep setting their (spatial domain) receive filter(s) according to the QCL source RS(s) and QCL type(s) provided/indicated/configured in the previously/currently applied TCI state #A to receive the second DL channel(s)/signal(s).
For the second UL channels/signals (which the TCI state change/update/switch triggered by the indicator(s) does not apply to), upon/after reception of the NACK, the UE could keep setting their (spatial domain) transmit filter(s) according to the QCL source RS(s) and QCL type(s) provided/indicated/configured in the previously/currently applied TCI state #A to transmit the second UL channel(s)/signal(s).

In the present disclosure, when/if a UE sets their (spatial domain) receive filter(s) according to QCL source RS(s) and QCL type(s) provided/indicated/configured in a TCI state to receive a DL channel, the UE (e.g., the UE 116) expects DM-RS of the DL channel is quasi-co-located (QCL'ed) with the RS(s) in the TCI state for the corresponding QCL type(s). When/if a UE sets their (spatial domain) receive filter(s) according to QCL source RS(s) and QCL type(s) provided/indicated/configured in a TCI state to receive a DL signal/RS, the UE expects the DL signal/RS is quasi-co-located (QCL'ed) with the RS(s) in the TCI state for the corresponding QCL type(s). When/if a UE sets their (spatial domain) transmit filter(s) according to QCL source RS(s) and QCL type(s) provided/indicated/configured in a TCI state to transmit an UL channel, the UE determines their UL TX (spatial) filter(s), if applicable, from the TCI state for the UL channel. When/if a UE sets their (spatial domain) transmit filter(s) according to QCL source RS(s) and QCL type(s) provided/indicated/configured in a TCI state to transmit an UL signal/RS, the UE determines their UL TX (spatial) filter(s), if applicable, from the TCI state for the UL signal/RS.

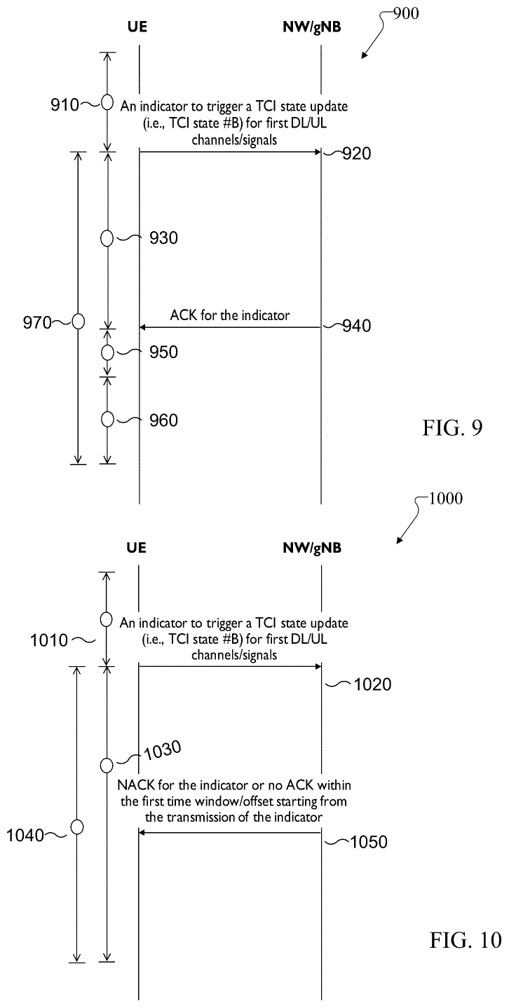

FIG. 9 illustrates an example procedure 900 for applying TCI states for first/second downlink and uplink channels/signals according to embodiments of the present disclosure. For example, procedure 900 for applying TCI states for first/second downlink and uplink channels/signals may be performed by the UE 112 and the gNB 102 and/or network 130 in the wireless network 100 of FIG. 1. This example is for illustration only and other embodiments can be used without departing from the scope of the present disclosure.

The procedure begins in 910, a UE applies TCI state #A for first/second DL channels/signals and first/second UL channels/signals. In 920 the UE sends to the NW/gNB an indicator to trigger a TCI state update (i.e., TCI state #B) for first DL/UL channels/signals. In 930, the UE applies TCI state #A for first DL and UL channels/signals. In 940, the NW/gNB sends to the UE an ACK for the indicator. In 950, a n3 duration/offset/time (e.g., symbols/slots), applies TCI state #A for first DL and UL channels/signals. In 960, the UE applies TCI state #B for first DL and UL channels/signals. In 950, the UE applies TCI state #A for second DL and UL channels/signals.

FIG. 10 illustrates an example procedure 1000 for applying TCI states for first/second downlink and uplink channels/signals according to embodiments of the present disclosure. For example, procedure 1000 for applying TCI states for first/second downlink and uplink channels/signals may be performed by the UE 113 and the gNB 102 and/or network 130 in the wireless network 100 of FIG. 1. This example is for illustration only and other embodiments can be used without departing from the scope of the present disclosure.

The procedure begins in 1010, a UE applies TCI state #A for first/second DL channels/signals and first/second UL channels/signals. In 1020, the UE sends to the NW/gNB an indicator to trigger a TCI state update (i.e., TCI state #B) for first DL/UL channels/signals. In 1030, the UE applies TCI state #A for first DL and UL channels/signals. In 1040, the UE applies TCI state #A for second DL and UL channels/signals. In 1050, the NW/gNB sends to the UE a NACK for the indicator or no ACK within the first time window/offset starting from the transmission of the indicator.

In one embodiment, after a UE has sent to the network (e.g., the network 130) the one or more indicators as specified herein in the present disclosure and before the UE receives from the network an ACK/NACK for the indicator(s) as specified herein in the present disclosure, when/if the indicator(s) triggers a TCI state change/update/switch, e.g., from a previously/currently applied TCI state #A to a new TCI state #B, only for one or more first DL channel(s)/signal(s) and first UL channel(s)/signal(s) according to those specified herein in the present disclosure, and when/if the UE receives an ACK for the indicator(s) as specified herein in the present disclosure:
For the first DL channel(s)/signal(s), n3 duration/offset/time (e.g., n3 symbols/slots/etc.) starting from or after reception (e.g., the last symbol/slot) of the ACK for the indicator(s), the UE could set their (spatial domain) filter(s) QCL receive according to the source RS(s) and QCL type(s) provided/indicated/configured in the new TCI state #B to receive the first DL channel(s)/signal(s). The value of n3 could be: (i) fixed in the system specification(s), (ii) configured/provided/indicated by the network, e.g., via higher layer RRC signaling/parameter and/or MAC CE command and/or dynamic DCI based L1 signaling, and/or (iii) autonomously determined by the UE and sent to the network via uplink channels such as PUCCH/PUSCH. Before setting their (spatial domain) receive filter(s) according to the QCL source RS(s) and QCL type(s) provided/indicated/configured in the new TCI state #B to receive the first DL channel(s)/signal(s), the UE could keep setting their (spatial domain) receive filter(s) according to the QCL source RS(s) and QCL type(s) provided/indicated/configured in the previously/currently applied TCI state #A to receive the first DL channel(s)/signal(s).
For the first UL channel(s)/signal(s), n3 duration/offset/time (e.g., n3 symbols/slots/etc.) starting from or after reception (e.g., the last symbol/slot) of the ACK for the indicator(s), the UE could set their (spatial domain) transmit filter(s) according to the QCL source RS(s) and QCL type(s) provided/indicated/configured in the new TCI state #B to transmit the first UL channel(s)/signal(s). The value of n3: (i) fixed in the system specification(s), (ii) configured/provided/indicated by the network, e.g., via higher layer RRC signaling/parameter and/or MAC CE command and/or dynamic DCI based L1 signaling, and/or (iii) autonomously determined by the UE and sent to the network via uplink channels such as PUCCH/PUSCH. Before setting their (spatial domain) receive filter(s) according to the QCL source RS(s) and QCL type(s) provided/indicated/configured in the new TCI state #B to receive the second DL channel(s)/signal(s), the UE could keep setting their (spatial domain) receive filter(s) according to the QCL source RS(s) and QCL type(s) provided/indicated/configured in the previously/currently applied TCI state #A to receive the second DL channel(s)/signal(s).
For one or more second DL channels/signals (which the TCI state change/update/switch triggered by the indicator(s) does not apply to), the UE could set their (spatial domain) receive filter(s) according to the QCL source RS(s) and QCL type(s) provided/indicated/configured in the previously/currently applied TCI state #A to receive the second DL channel(s)/signal(s).
For one or more second UL channels/signals (which the TCI state change/update/switch triggered by the indicator(s) does not apply to), the UE could set their (spatial domain) transmit filter(s) according to the QCL source RS(s) and QCL type(s) provided/indicated/configured in the previously/currently applied TCI state #A to transmit the second UL channel(s)/signal(s).

When/if the UE receives a NACK for the indicator(s) as described herein in the present disclosure, or the UE does not receive an ACK for the indicator(s) within the first time window/offset starting from the transmission of the indicator(s) as specified herein in the present disclosure:
For the first DL channel(s)/signal(s), upon/after reception of the NACK, the UE could keep setting their (spatial domain) receive filter(s) according to the QCL source RS(s) and QCL type(s) provided/indicated/configured in the previously/currently applied TCI state #A to receive the first DL channel(s)/signal(s).
For the first UL channel(s)/signal(s), upon/after reception of the NACK, the UE could keep setting their (spatial domain) transmit filter(s) according to the QCL source RS(s) and QCL type(s) provided/indicated/configured in the currently/previously applied TCI state #A to transmit the first UL channel(s)/signal(s).
For the second DL channels/signals (which the TCI state change/update/switch triggered by the indicator(s) does not apply to), upon/after reception of the NACK, the UE could keep setting their (spatial domain) receive filter(s) according to the QCL source RS(s) and QCL type(s) provided/indicated/configured in the previously/currently applied TCI state #A to receive the second DL channel(s)/signal(s).
For the second UL channels/signals (which the TCI state change/update/switch triggered by the indicator(s) does not apply to), upon/after reception of the NACK, the UE could keep setting their (spatial domain) transmit filter(s) according to the QCL source RS(s) and QCL type(s) provided/indicated/configured in the previously/currently applied TCI state #A to transmit the second UL channel(s)/signal(s).

In the present disclosure, a UE could send to the network the indicator(s) as specified herein in the present disclosure to trigger or initiate a TCI state(s) change/update/switch for one or more channels/signals according to one or more of the following conditions and/or when/if one or more of the following conditions hold/are achieved.
In one example, the UE could be provided/configured/indicated by the network, e.g., via higher layer RRC signaling/parameter and/or MAC CE command and/or dynamic DCI based L1 signaling, that the UE-initiated beam switching is enabled. For instance, a higher layer parameter, denoted by ‘ueInitiatedBeamSwitch’, could be configured or set to enabled in CSI-ResourceConfig and/or CSI-ReportConfig to enable the UE-initiated beam switching. The configuration/indication/enabling of the UE-initiated beam switching via higher layer RRC signaling/parameter (e.g., by configuring ‘ueInitiatedBeamSwitch’ or setting ‘ueInitiatedBeamSwitch’ to enabled) as specified herein in the present disclosure could be based on a UE capability signaling. The UE capability signaling (e.g., denoted by ‘selfInitiatedBeamSwitch’ sent by the UE to the network) could indicate to the network that the UE is capable of initiating or triggering a TCI state(s) or beam change/update/switch for one or more channels/signals according to one or more of the design examples as specified herein in the present disclosure. Optionally, when/if the UE has sent/indicated to the network the UE capability signaling. i.e., ‘selfInitiatedBeamSwith’ here, the UE-initiated beam switching as specified herein in the present disclosure could be enabled or started by the UE.
In another example, the UE could be provided/configured/indicated by the network, e.g., via higher layer RRC signaling/parameter and/or MAC CE command and/or dynamic DCI based L1 signaling, that the UE-initiated beam/CSI reporting is enabled. For instance, a higher layer parameter, denoted by ‘ueInitiatedReport’, could be configured or set to enabled in CSI-ResourceConfig and/or CSI-ReportConfig to enable the UE-initiated CSI/beam reporting. The configuration/indication/enabling of the UE-initiated CSI/beam reporting via higher layer RRC signaling/parameter (e.g., by configuring ‘ueInitiatedReport’ or setting ‘ueInitiatedReport’ to enabled) as specified herein in the present disclosure could be based on a UE capability signaling. The UE capability signaling (e.g., denoted by ‘selfInitiatedReport’ sent by the UE to the network) could indicate to the network that the UE is capable of initiating or triggering a CSI/beam measurement/report. For this case, when/if the UE-initiated beam/CSI reporting is configured/enabled, the UE-initiated beam switching could also be configured/enabled such that the UE could initiate or trigger a TCI state(s) or beam change/update/switch for one or more channels/signals according to one or more of the design examples as specified herein in the present disclosure. Optionally, when/if the UE has sent/indicated to the network the UE capability signaling. i.e., ‘selfInitiatedReport’ here, the UE-initiated CSI/beam reporting and/or the UE-initiated beam switching could be enabled or started by the UE.
In yet another example, higher layer parameter ‘reportQuantity’ in CSI-ReportConfig could be set to a dedicated value, e.g., denoted by ‘ueInitiated-ssbri-cri’, to enable the UE-initiated CSI/beam reporting and/or the UE-initiated beam switching.
In yet another example, higher layer parameter ‘reportQuantity’ in CSI-ReportConfig could be set to ‘none’, and/or higher layer parameter ‘groupBasedBeamReporting’ in CSI-ReportConfig could be configured or set to enabled, and/or higher layer parameter ‘groupBasedBeamReporting-r17’ in CSI-ReportConfig could be configured or set to enabled. When/if the higher layer parameter ‘groupBasedBeamReporting’ is configured or set to enabled, higher layer parameter ‘nrofReportedRS’ could be set to 0 or a value greater than the maximum number of beams/RSs that can be reported in a CSI report (e.g., 8). When/if the higher layer parameter ‘groupBasedBeamReporting-r17’ is configured or set to enabled, the number of configured CSI resource sets could be one and/or higher layer parameter ‘nrofReportedGroups’ could be set to 0 or a value greater than the maximum number of groups of beams/RSs that can be reported in a CSI report (e.g., 8).
In yet another example, the UE could be configured/provided/indicated by the network a higher layer parameter BeamAppTime for determining/identifying time to apply a beam/TCI state change/update after the beam/TCI state change/update is indicated by the beam indication DCI (e.g., via TCI field in DCI format 1_1/1_2 with or without DL assignment) under the unified TCI framework. When the configured value of BeamAppTime is greater than (or less than) a threshold, the UE-initiated beam switching as specified herein in the present disclosure could be enabled. The configuration of the value of BeamAppTime as specified herein in the present disclosure could be based on a UE capability signaling. The UE capability signaling (e.g., denoted by ‘beamAppTime’ sent by the UE to the network) could indicate to the network which value or range of values of BeamAppTime the UE is capable of supporting. Optionally, when/if the UE has sent/indicated to the network the UE capability signaling. i.e., ‘beamAppTime’ here, is greater than (or less than) a threshold, the UE-initiated beam switching could be enabled or started by the UE. The threshold could be determined according to: (1) configured/indicated/provided by the network, e.g., via higher layer RRC signaling/parameter and/or MAC CE command and/or dynamic DCI based L1 signaling. (2) fixed in the system specifications, and/or (3) autonomously determined by the UE and sent to the network, e.g., in part of CSI/beam report.
In yet another example, when/if the subcarrier spacing (SCS) of the cell/channel to/for which the beam/TCI state change/update/switch is applied is less than (or greater than) a threshold, the UE-initiated beam switching could be enabled. The threshold could be determined according to: (1) configured/indicated/provided by the network, e.g., via higher layer RRC signaling/parameter and/or MAC CE command and/or dynamic DCI based L1 signaling. (2) fixed in the system specifications, and/or (3) autonomously determined by the UE and sent to the network, e.g., in part of CSI/beam report.
In yet another example, when/if the UE is higher layer configured by the network with dl-OrJoint-TCIStateList or TCI-UL-State, and/or the value of unifiedTCI-StateType is set to ‘separate’, the UE-initiated beam switching as specified herein in the present disclosure could be enabled such that the UE could send to the network one or more indicators to trigger or initiate change/update/switch of one or more TCI states for one or more DL channels/signals or one or more UL channels/signals according to one or more of the design examples specified herein in the present disclosure.
In yet another example, when/if the UE is higher layer configured by the network with dl-OrJoint-TCIState List, and/or the value of unifiedTCI-State Type is set to ‘joint’, the UE-initiated beam switching as specified herein in the present disclosure could be enabled such that the UE could send to the network one or more indicators to trigger or initiate change/update/switch of one or more TCI states for one or more DL and UL channels/signals according to one or more of the design examples specified herein in the present disclosure.
In yet another example, when/if the UE measured L1-RSRP(s) and/or L1-SINR(s) for one or more beams is greater than (or less than) a threshold, the UE-initiated beam switching as specified herein in the present disclosure could be enabled such that the UE could send to the network one or more indicators to trigger or initiate change/update/switch of one or more TCI states for one or more DL/UL channels/signals according to one or more of the design examples specified herein in the present disclosure.

One or more of the described/specified conditions herein could be used to determine whether to enable or start the UE-initiated CSI/beam reporting according to those specified herein in the present disclosure.

In one embodiment, as specified herein in the present disclosure, a UE could trigger or initiate TCI state(s)/beam(s) change/update/switch (e.g., via/by sending one or more indicators to the network. (e.g., the network 130)) for one or more channels/signals according to one or more of the design examples specified herein in the present disclosure. The UE could be indicated/provided/configured by the network, e.g., via higher layer RRC signaling/parameter and/or MAC CE command and/or dynamic DCI based L1 signaling, when to start and/or end sending the indicator(s) as specified herein in the present disclosure for the UE-initiated beam switching.
In one example, the UE could be configured/provided/indicated by the network, e.g., via higher layer RRC signaling/parameter (e.g., in CSI-ResourceConfig and/or CSI-ReportConfig) and/or MAC CE command and/or dynamic DCI based L1 signaling, a starting symbol/slot/etc. (e.g., in form of symbol index/slot index/etc.), from which the UE could or is allowed to send to the network the indicator(s) for the UE-initiated beam switching, or from which the UE is not allowed or expected to send to the network the indicator(s) for the UE-initiated beam switching.
In another example, the UE could be configured/provided/indicated by the network, e.g., via higher layer RRC signaling/parameter (e.g., in CSI-ResourceConfig and/or CSI-ReportConfig) and/or MAC CE command and/or dynamic DCI based L1 signaling, an ending symbol/slot/etc. (e.g., in form of symbol index/slot index/etc.), after which the UE is not allowed or expected to send to the network the indicator(s) to initiate or trigger TCI state(s)/beam(s) change/switch/update, or after which the UE could or is allowed to send to the network the indicator(s) for the UE-initiated beam switching.
In yet another example, the UE could be configured/provided/indicated by the network, e.g., via higher layer RRC signaling/parameter (e.g., in CSI-ResourceConfig and/or CSI-ReportConfig) and/or MAC CE command and/or dynamic DCI based L1 signaling, a reference timing (e.g., a reference symbol/slot/etc. in form of symbol index/slot index/etc.). Furthermore, the UE could be configured/provided/indicated by the network, e.g., via higher layer RRC signaling/parameter (e.g., in CSI-ResourceConfig and/or CSI-ReportConfig) and/or MAC CE command and/or dynamic DCI based L1 signaling, a second time window/offset (e.g., in form of number of symbols/slots/etc.). Starting from the reference timing and within the second time window/offset, the UE is not allowed or expected to send to the network the indicator(s) to initiate or trigger TCI state(s)/beam(s) change/switch/update. Or starting from the reference timing and within the second time window/offset, the UE could or is allowed to send to the network the indicator(s) to initiate or trigger TCI state(s)/beam(s) change/switch/update.
In yet another example, the UE could be configured/provided/indicated by the network, e.g., via higher layer RRC signaling/parameter (e.g., in CSI-ResourceConfig and/or CSI-ReportConfig) and/or MAC CE command and/or dynamic DCI based L1 signaling, a third time window/offset (e.g., in form of number of symbols/slots/etc.). Starting from a reference timing and within the third time window/offset, the UE is not allowed or expected to send to the network the indicator(s) to initiate or trigger TCI state(s)/beam(s) change/switch/update. Or starting from the reference timing and within the third time window/offset, the UE could or is allowed to send to the network the indicator(s) to initiate or trigger TCI state(s)/beam(s) change/switch/update, wherein determination of the reference timing could be based on or according to fixed value(s)/rule(s) in system specifications and known to both the UE and network sides. For example, the reference timing here could correspond to the last (or first) symbol/slot of reception of a beam indication DCI that is received the latest in time. For another example, the reference timing here could correspond to the first (or last) symbol/slot when the latest indicated beam(s)/TCI state(s) has become applicable for transmission/reception. Yet for another example, the reference timing here could correspond to the first (or last) symbol/slot of reception of a (unified) TCI states activation/deactivation MAC CE that is received the latest in time. Yet for another example, the reference timing here could correspond to the first (or last) symbol/slot of transmission of the indicator(s)—e.g., the indicator(s) that is transmitted the latest in time—as specified herein in the present disclosure for the UE-initiated beam switching and/or UE-initiated CSI/beam reporting.
In yet another example, when/if a prohibit timer is in place, the UE is not allowed or expected to send to the network the indicator(s) to initiate or trigger TCI state(s)/beam(s) change/switch/update. The UE could be configured/provided/indicated by the network, e.g., via higher layer RRC signaling/parameter (e.g., in CSI-ResourceConfig and/or CSI-ReportConfig) and/or MAC CE command and/or dynamic DCI based L1 signaling, start and/or end of the prohibit timer. Optionally, the start (or end) of the prohibit timer could be based on or according to fixed value(s)/rule(s) in system specifications and known to both the UE and network sides. For example, the start (or end) of the prohibit timer could correspond to the last (or first) symbol/slot of reception of a beam indication DCI that is received the latest in time. For another example, the start (or end) of the prohibit timer could correspond to the first (or last) symbol/slot when the latest indicated beam(s)/TCI state(s) has become applicable for transmission/reception. Yet for another example, the start (or end) of the prohibit timer could correspond to the first (or last) symbol/slot of reception of a (unified) TCI states activation/deactivation MAC CE that is received the latest in time. Yet for another example, the start (or end) of the prohibit timer could correspond to the first (or last) symbol/slot of transmission of the indicator(s)—e.g., the indicator(s) that is transmitted the latest in time—as specified herein in the present disclosure for the UE-initiated beam switching and/or UE-initiated CSI/beam reporting. The UE could also be configured/provided/indicated by the network, e.g., via higher layer RRC signaling/parameter (e.g., in CSI-ResourceConfig and/or CSI-ReportConfig) and/or MAC CE command and/or dynamic DCI based L1 signaling, duration (e.g., in form of number of symbols/slots/etc.) of the prohibit timer.

Furthermore, the UE (e.g., the UE 116) could be indicated/provided/configured by the network, e.g., via higher layer RRC signaling/parameter and/or MAC CE command and/or dynamic DCI based L1 signaling, when to start and/or end applying the TCI state(s)/beam(s) indicated by the indicator(s)—sent by the UE to the network—as specified herein in the present disclosure.
In one example, the UE could be configured/provided/indicated by the network, e.g., via higher layer RRC signaling/parameter (e.g., in CSI-ResourceConfig and/or CSI-ReportConfig) and/or MAC CE command and/or dynamic DCI based L1 signaling, a starting symbol/slot/etc. (e.g., in form of symbol index/slot index/etc.), from which the UE could or is allowed to apply the TCI state(s)/beam(s) indicated by the indicator(s) sent by the UE to the network for the UE-initiated beam switching according to those specified herein in the present disclosure. Or from which the UE is not allowed or expected to apply the TCI state(s)/beam(s) indicated by the indicator(s) sent by the UE to the network for the UE-initiated beam switching according to those specified herein in the present disclosure.
In another example, the UE could be configured/provided/indicated by the network, e.g., via higher layer RRC signaling/parameter (e.g., in CSI-ResourceConfig and/or CSI-ReportConfig) and/or MAC CE command and/or dynamic DCI based L1 signaling, an ending symbol/slot/etc. (e.g., in form of symbol index/slot index/etc.), after which the UE is not allowed or expected to apply the TCI state(s)/beam(s) indicated by the indicator(s) sent by the UE to the network for the UE-initiated beam switching according to those specified herein in the present disclosure. Or after which, the UE could or is allowed to apply the TCI state(s)/beam(s) indicated by the indicator(s) sent by the UE to the network for the UE-initiated beam switching according to those specified herein in the present disclosure.
In yet another example, the UE could be configured/provided/indicated by the network, e.g., via higher layer RRC signaling/parameter (e.g., in CSI-ResourceConfig and/or CSI-ReportConfig) and/or MAC CE command and/or dynamic DCI based L1 signaling, a reference timing (e.g., a reference symbol/slot/etc. in form of symbol index/slot index/etc.). Furthermore, the UE could be configured/provided/indicated by the network, e.g., via higher layer RRC signaling/parameter (e.g., in CSI-ResourceConfig and/or CSI-ReportConfig) and/or MAC CE command and/or dynamic DCI based L1 signaling, a fourth time window/offset (e.g., in form of number of symbols/slots/etc.). Starting from the reference timing and within the fourth time window/offset, the UE is not allowed or expected to apply the TCI state(s)/beam(s) indicated by the indicator(s) sent by the UE to the network for the UE-initiated beam switching according to those specified herein in the present disclosure. Or starting from the reference timing and within the fourth time window/offset, the UE could or is allowed to apply the TCI state(s)/beam(s) indicated by the indicator(s) sent by the UE to the network for the UE-initiated beam switching according to those specified herein in the present disclosure.
In yet another example, the UE could be configured/provided/indicated by the network, e.g., via higher layer RRC signaling/parameter (e.g., in CSI-ResourceConfig and/or CSI-ReportConfig) and/or MAC CE command and/or dynamic DCI based L1 signaling, a fifth time window/offset (e.g., in form of number of symbols/slots/etc.). Starting from a reference timing and within the fifth time window/offset, the UE is not allowed or expected to apply the TCI state(s)/beam(s) indicated by the indicator(s) sent by the UE to the network for the UE-initiated beam switching according to those specified herein in the present disclosure. Or starting from the reference timing and within the fifth time window/offset, the UE could or is allowed to apply the TCI state(s)/beam(s) indicated by the indicator(s) sent by the UE to the network for the UE-initiated beam switching according to those specified herein in the present disclosure, wherein determination of the reference timing could be based on or according to fixed value(s)/rule(s) in system specifications and known to both the UE and network sides. For example, the reference timing here could correspond to the last (or first) symbol/slot of reception of a beam indication DCI that is received the latest in time. For another example, the reference timing here could correspond to the first (or last) symbol/slot when the latest indicated beam(s)/TCI state(s) has become applicable for transmission/reception. Yet for another example, the reference timing here could correspond to the first (or last) symbol/slot of reception of a (unified) TCI states activation/deactivation MAC CE that is received the latest in time. Yet for another example, the reference timing here could correspond to the first (or last) symbol/slot of transmission of the indicator(s)—e.g., the indicator(s) that is transmitted the latest in time—as specified herein in the present disclosure for the UE-initiated beam switching and/or UE-initiated CSI/beam reporting. Yet for another example, the reference timing here could correspond to the last (or first) symbol/slot of reception of the ACK for the indicator(s)—e.g., the indicator(s) that is transmitted the latest in time—as specified herein in the present disclosure for the UE-initiated beam switching and/or UE-initiated CSI/beam reporting, wherein for this case, the fifth time window/offset could be provided/configured/indicated to the UE along with the ACK (e.g., they are in the same slot/symbol using the same signaling medium).
In yet another example, when/if a prohibit timer is in place, the UE is not allowed or expected apply the TCI state(s)/beam(s) indicated by the indicator(s) sent by the UE to the network for the UE-initiated beam switching according to those specified herein in the present disclosure. The UE could be configured/provided/indicated by the network, e.g., via higher layer RRC signaling/parameter (e.g., in CSI-ResourceConfig and/or CSI-ReportConfig) and/or MAC CE command and/or dynamic DCI based L1 signaling, start and/or end of the prohibit timer. Optionally, the start (or end) of the prohibit timer could be based on or according to fixed value(s)/rule(s) in system specifications and known to both the UE and network sides. For example, the start (or end) of the prohibit timer could correspond to the last (or first) symbol/slot of reception of a beam indication DCI that is received the latest in time. For another example, the start (or end) of the prohibit timer could correspond to the first (or last) symbol/slot when the latest indicated beam(s)/TCI state(s) has become applicable for transmission/reception. Yet for another example, the start (or end) of the prohibit timer could correspond to the first (or last) symbol/slot of reception of a (unified) TCI states activation/deactivation MAC CE that is received the latest in time. Yet for another example, the start (or end) of the prohibit timer could correspond to the first (or last) symbol/slot of transmission of the indicator(s)—e.g., the indicator(s) that is transmitted the latest in time—as specified herein in the present disclosure for the UE-initiated beam switching and/or UE-initiated CSI/beam reporting. Yet for another example, the start (or end) of the prohibit timer could correspond to the last (or first) symbol/slot of reception of the ACK for the indicator(s)—e.g., the indicator(s) that is transmitted the latest in time—as specified herein in the present disclosure for the UE-initiated beam switching and/or UE-initiated CSI/beam reporting. The UE could also be configured/provided/indicated by the network, e.g., via higher layer RRC signaling/parameter (e.g., in CSI-ResourceConfig and/or CSI-ReportConfig) and/or MAC CE command and/or dynamic DCI based L1 signaling, duration (e.g., in form of number of symbols/slots/etc.) of the prohibit timer. Optionally, the start and/or end of the prohibit timer and/or the duration of the prohibit timer could be provided/configured/indicated to the UE along with the ACK (e.g., they are in the same slot/symbol using the same signaling medium) for the indicator(s) as specified herein in the present disclosure for the UE-initiated beam switching and/or CSI/beam reporting.

Optionally, the described timing configurations herein, such as the starting symbols/slots, ending symbols/slots, reference timings, time windows/slots, start/end of the prohibit timers, and/or durations of the prohibit timers, could be: (1) determined according to fixed value(s)/rule(s) specified in system specification(s) and/or (2) autonomously determined by the UE (e.g., the UE 116) and sent to the network (e.g., the network 130), e.g., as part of CSI/beam report. In addition, the described timing configurations herein, such as the starting symbols/slots, ending symbols/slots, reference timings, time windows/slots, start/end of the prohibit timers, and/or durations of the prohibit timers, could be UE's capabilities and sent to the network in part of UE capability signaling(s). Furthermore, as specified herein in the present disclosure, the described timing configurations herein, such as the starting symbols/slots, ending symbols/slots, reference timings, time windows/slots, start/end of the prohibit timers, and/or durations of the prohibit timers, could be applied to the UE-initiated beam switching and/or the UE-initiated CSI/beam reporting.

As specified herein in the present disclosure, a UE could send to the network one or more indicators to trigger or initiate one or more TCI states/beams change/update/switch for one or more channels/signals. Furthermore, after the UE has sent to the network the one or more indicators as specified herein in the present disclosure, the UE could or is expected to receive ACK(s) for the indicator(s) according to those specified herein in the present disclosure. The ACK(s) for the indicator(s) could be in various forms transmitted via various signaling mediums.
In one example, a UE could be provided a CORESET through a link to a search space set provided by ueInitiatedSearchSpaceId for monitoring PDCCH in the CORESET (e.g., for a PCell or a PSCell). For this case, reception of the ACK(s) for the indicator(s)—for the UE-initiated beam switching and/or CSI/beam reporting as specified herein in the present disclosure-could correspond to reception of a PDCCH in a search space set provided by ueInitiatedSearchSpaceId for which the UE could detect a DCI format with cyclic redundancy check (CRC) scrambled by cell-radio network temporary identifier (C-RNTI) or modulation and coding scheme (MCS)-C-RNTI.
In another example, a UE could send the indicator(s)—for the UE-initiated beam switching and/or CSI/beam reporting as specified herein in the present disclosure-via a MAC CE provided in Msg3 or MsgA of contention based random access procedure (e.g., for a PCell or a PSCell). For this case, reception of the ACK(s) for the indicator(s) could correspond to reception of the PDCCH that determines the completion of the contention based random access procedure.
In yet another example, a UE could send the indicator(s)—for the UE-initiated beam switching and/or CSI/beam reporting as specified herein in the present disclosure-via a first PUSCH (e.g., used for carrying a MAC CE, and/or for corresponding SCell(s)). For this case, reception of the ACK(s) for the indicator(s) could correspond to reception of a PDCCH with a DCI format scheduling a PUSCH transmission with a same hybrid automatic repeat request (HARQ) process number as for the transmission of the first PUSCH (e.g., used for carrying a MAC CE) and having a toggled new data indicator (NDI) field value.
In yet another example, reception of the ACK(s) for the indicator(s)—sent from the UE to the network for the UE-initiated beam switching and/or CSI/beam reporting as specified herein in the present disclosure-could correspond to reception of a (unified) TCI state activation/deactivation MAC CE that comprises/indicates/activates same TCI state(s)/beam(s)/QCL source RS(s) and type(s)/etc. (e.g., indicated by one or more TCI codepoints activated by the MAC CE) as those indicated by the indicator(s). For instance, a UE could send to the network the indicator(s) to trigger or initiate a TCI state change/switch/update for one or more channels/signals, wherein the indicator(s) indicates TCI state #A. For this case, reception of the ACK for the indicator(s) could be reception of a (unified) TCI state(s) activation/deactivation MAC CE that comprises/activates a TCI codepoint that indicates/comprises the same TCI state #A.
In yet another example, reception of the ACK(s) for the indicator(s)—sent from the UE to the network for the UE-initiated beam switching and/or CSI/beam reporting as specified herein in the present disclosure-could correspond to reception of a beam indication DCI (e.g., DCI format 1_1/1_2 with or without DL assignment) that indicates same TCI state(s)/beam(s)/QCL source RS(s) and type(s)/etc. (e.g., via the TCI field in the beam indication DCI) as those indicated by the indicator(s). For instance, a UE could send to the network the indicator(s) to trigger or initiate a TCI state change/switch/update for one or more channels/signals, wherein the indicator(s) indicates TCI state #A. For this case, reception of the ACK for the indicator(s) could be reception of a beam indication DCI that indicates the same TCI state #A (e.g., via the TCI field in the DCI format).

In one embodiment, as specified herein in the present disclosure, a UE could send to the network one or more indicators to trigger or initiate one or more TCI states/beams change/update/switch for one or more channels/signals. Furthermore, the UE could receive from the network a (unified) TCI state(s) activation/deactivation MAC CE indicating/providing/activating one or more TCI codepoints/sets of TCI states with each TCI codepoint/set of TCI states comprising one or more TCI states. For example, the UE could send to the network an indicator indicating a TCI state #A—i.e., the indicator triggers or initiates a TCI state update/switch/change to TCI state #A—for one or more channels/signals according to those specified herein in the present disclosure. Furthermore, the UE could receive from the network a (unified) TCI state(s) activation/deactivation MAC CE that indicates/provides/activates a single TCI codepoint/set of TCI state(s) that comprises a TCI state #B, wherein the TCI state #B could be different from the TCI state #A.
For example, when/if only the TCI state #A is applicable (i.e., the TCI state #B has not become applicable) according to those specified herein in the present disclosure, the UE could use/apply the TCI state #A indicated by the indicator(s) for transmitting/receiving the one or more channels/signals.
For another example, when/if only the TCI state #B is applicable (i.e., the TCI state #A has not become applicable) according to those specified herein in the present disclosure, the UE could use/apply the TCI state #B indicated by the (unified) TCI state(s) activation/deactivation MAC CE for transmitting/receiving the one or more channels/signals.
Yet for another example, when/if both TCI state #A and TCI state #B are applicable according to those specified herein in the present disclosure, the UE could only use/apply the TCI state #A indicated by the indicator(s) for transmitting/receiving the one or more channels/signals, e.g., based on (i) fixed rule(s)/value(s)/relation(s) specified in system specification(s), (ii) network's configuration(s)/indication(s), e.g., via higher layer RRC signaling/parameter and/or MAC CE command and/or dynamic DCI based L1 signaling, and/or (iii) autonomous determination of the UE (which could also be sent to the network, e.g., in part of CSI/beam report or UE capability signaling).
Yet for another example, when/if both TCI state #A and TCI state #B are applicable according to those specified herein in the present disclosure, the UE could only use/apply the TCI state #B indicated by the (unified) TCI state(s) activation/deactivation MAC CE for transmitting/receiving the one or more channels/signals, e.g., based on (i) fixed rule(s)/value(s)/relation(s) specified in system specification(s), (ii) network's configuration(s)/indication(s), e.g., via higher layer RRC signaling/parameter and/or MAC CE command and/or dynamic DCI based L1 signaling, and/or (iii) autonomous determination of the UE (which could also be sent to the network, e.g., in part of CSI/beam report or UE capability signaling).
Yet for another example, when/if both TCI state #A and TCI state #B are applicable according to those specified herein in the present disclosure, the UE could use/apply the TCI state #A indicated by the indicator(s) for transmitting/receiving one or more first channels/signals and use/apply the TCI state #B indicated by the (unified) TCI state(s) activation/deactivation MAC CE for transmitting/receiving one or more second channels/signals, e.g., based on (i) fixed rule(s)/value(s)/relation(s) specified in system specification(s), (ii) network's configuration(s)/indication(s), e.g., via higher layer RRC signaling/parameter and/or MAC CE command and/or dynamic DCI based L1 signaling, and/or (iii) autonomous determination of the UE (which could also be sent to the network, e.g., in part of CSI/beam report or UE capability signaling), wherein the one or more first channels/signals could be different from the one or more second channels/signals.
Yet for another example, when/if both TCI state #A and TCI state #B are applicable according to those specified herein in the present disclosure, and when/if the TCI state #A becomes applicable earlier in time (e.g., x slots/symbols/etc. earlier), wherein x could be: (1) determined according to fixed value(s)/rule(s) in system specification(s), (2) configured/indicated/provided by the network, e.g., via higher layer RRC signaling/parameter and/or MAC CE command and/or dynamic DCI based L1 signaling, and/or (3) autonomously determined by the UE and sent to the network, e.g., in part of CSI/beam report and/or UE capability signaling) than the TCI state #B, the UE could use/apply the TCI state #A indicated by the indicator(s) for transmitting/receiving the one or more channels/signals.
Yet for another example, when/if both TCI state #A and TCI state #B are applicable according to those specified herein in the present disclosure, and when/if the TCI state #B becomes applicable earlier in time (e.g., y slots/symbols/etc. earlier), wherein y could be: (1) determined according to fixed value(s)/rule(s) in system specification(s), (2) configured/indicated/provided by the network, e.g., via higher layer RRC signaling/parameter and/or MAC CE command and/or dynamic DCI based L1 signaling, and/or (3) autonomously determined by the UE and sent to the network, e.g., in part of CSI/beam report and/or UE capability signaling) than the TCI state #A, the UE could use/apply the TCI state #B indicated by the (unified) TCI state(s) activation/deactivation MAC CE for transmitting/receiving the one or more channels/signals.
Yet for another example, when/if both TCI state #A and TCI state #B are applicable according to those specified herein in the present disclosure, and when/if the reception of the (unified) TCI state(s) activation/deactivation MAC CE is later in time (e.g., x slots/symbols/etc. later), wherein x could be: (1) determined according to fixed value(s)/rule(s) in system specification(s), (2) configured/indicated/provided by the network, e.g., via higher layer RRC signaling/parameter and/or MAC CE command and/or dynamic DCI based L1 signaling, and/or (3) autonomously determined by the UE and sent to the network, e.g., in part of CSI/beam report and/or UE capability signaling) than the transmission of the indicator(s), the UE could use/apply the TCI state #B indicated by the (unified) TCI state(s) activation/deactivation MAC CE for transmitting/receiving the one or more channels/signals.
Yet for another example, when/if both TCI state #A and TCI state #B are applicable according to those specified herein in the present disclosure, and when/if the reception of the (unified) TCI state(s) activation/deactivation MAC CE is later in time (e.g., x′ slots/symbols/etc. later), wherein x′ could be: (1) determined according to fixed value(s)/rule(s) in system specification(s), (2) configured/indicated/provided by the network, e.g., via higher layer RRC signaling/parameter and/or MAC CE command and/or dynamic DCI based L1 signaling, and/or (3) autonomously determined by the UE and sent to the network, e.g., in part of CSI/beam report and/or UE capability signaling) than the reception of the ACK(s) for the indicator(s) as specified herein in the present disclosure, the UE could use/apply the TCI state #B indicated by the (unified) TCI state(s) activation/deactivation MAC CE for transmitting/receiving the one or more channels/signals.
Yet for another example, when/if both TCI state #A and TCI state #B are applicable according to those specified herein in the present disclosure, and when/if the transmission of the indicator(s) is later in time (e.g., y slots/symbols/etc. later), wherein y could be: (1) determined according to fixed value(s)/rule(s) in system specification(s), (2) configured/indicated/provided by the network, e.g., via higher layer RRC signaling/parameter and/or MAC CE command and/or dynamic DCI based L1 signaling, and/or (3) autonomously determined by the UE and sent to the network, e.g., in part of CSI/beam report and/or UE capability signaling) than the reception of the (unified) TCI state(s) activation/deactivation MAC CE, the UE could use/apply the TCI state #A indicated by the indicator(s) for transmitting/receiving the one or more channels/signals.
Yet for another example, when/if both TCI state #A and TCI state #B are applicable according to those specified herein in the present disclosure, and when/if the reception of the ACK(s) for the indicator(s) as specified herein in the present disclosure is later in time (e.g., y slots/symbols/etc. later), wherein y′ could be: (1) determined according to fixed value(s)/rule(s) in system specification(s), (2) configured/indicated/provided by the network, e.g., via higher layer RRC signaling/parameter and/or MAC CE command and/or dynamic DCI based L1 signaling, and/or (3) autonomously determined by the UE and sent to the network, e.g., in part of CSI/beam report and/or UE capability signaling) than the reception of the (unified) TCI state(s) activation/deactivation MAC CE, the UE could use/apply the TCI state #A indicated by the indicator(s) for transmitting/receiving the one or more channels/signals.

In the present disclosure, a TCI state (e.g., the TCI state #B in the described examples herein) indicated by/in a (unified) TCI state(s) activation/deactivation MAC CE command would become applicable starting from the first slot that is after slot

$$n + 3 {N}_{slot}^{subframe , μ} + \frac{{2}^{μ}}{{2}^{{μ}_{K}} mac} \cdot {k}_{mac} ,$$

where μ is the SCS configuration for the PUCCH and μ_{K}_{_{mac}} is the subcarrier spacing configuration for k_{mac} with a value of 0 for frequency range (FR) 1, and k_{mac} is provided by K-Mac or k_{mac}=0 if K-Mac is not provided. Slot n is the slot in which the UE would transmit a PUCCH with hybrid automatic repeat request acknowledgement (HARQ-ACK) information corresponding to the PDSCH carrying the (unified) TCI state(s) activation/deactivation MAC CE command.

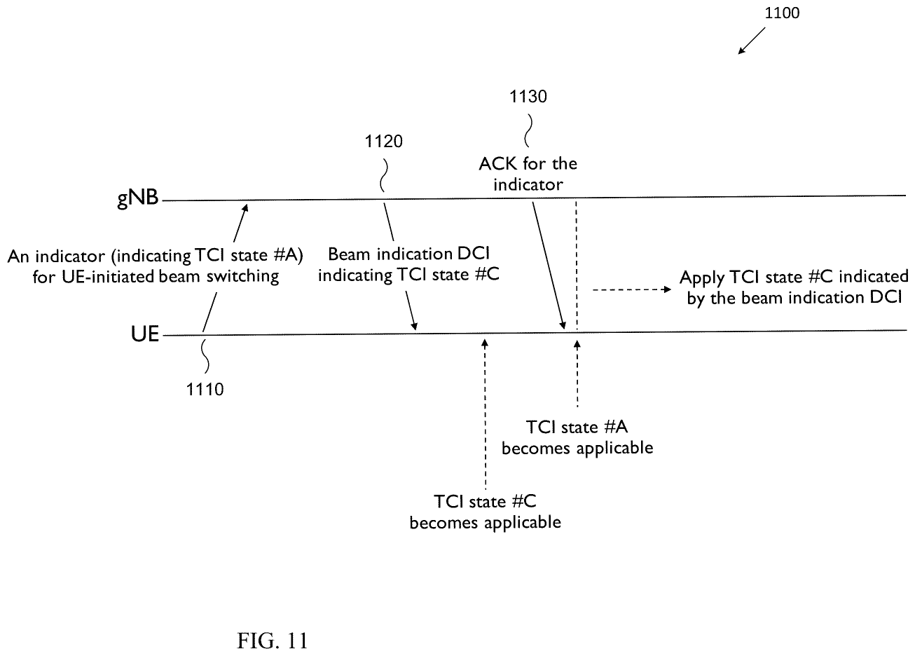

FIG. 11 illustrates a flow diagram 1100 for UE-initiated beam switching according to embodiments of the present disclosure. For example, flow diagram 1100 for UE-initiated beam switching can be performed by any of the UEs 111-116 of FIG. 1, such as the UE 111 of FIG. 3 and the gNB 102 and/or network 130 in the wireless network 100 of FIG. 1. This example is for illustration only and other embodiments can be used without departing from the scope of the present disclosure.

The flow diagram begins in 1110, a UE sends an indicator (indicating TCI state #A) for UE-initiated beam switching to the gNB. In 1120, the gNB sends a beam indication DCI indicating TCI state #C to the UE. In various embodiments. TCI state #C becomes applicable. In 1130, the gNB sends an ACK for the indicator to the UE. In various embodiments. TCI state #A becomes applicable. In various embodiments. TCI state #C, indicated by the beam indication DCI, is applied.

In one embodiment, as specified herein in the present disclosure, a UE could send to the network (e.g., the network 130) one or more indicators to trigger or initiate one or more TCI states/beams change/update/switch for one or more channels/signals. Furthermore, the UE (e.g., the UE 116) could receive from the network a beam indication DCI (DCI format 1_1/1_2 with or without DL assignment) indicating one or more TCI states (e.g., via the TCI field in the beam indication DCI). For example, the UE could send to the network an indicator indicating a TCI state #A—i.e., the indicator triggers or initiates a TCI state update/switch/change to TCI state #A—for one or more channels/signals according to those specified herein in the present disclosure. Furthermore, the UE could receive from the network a beam indication DCI with the TCI field indicating a TCI state #C, wherein the TCI state #C could be different from the TCI state #A.
For example, when/if only the TCI state #A is applicable (i.e., the TCI state #C has not become applicable) according to those specified herein in the present disclosure, the UE could use/apply the TCI state #A indicated by the indicator(s) for transmitting/receiving the one or more channels/signals.
For another example, when/if only the TCI state #C is applicable (i.e., the TCI state #A has not become applicable) according to those specified herein in the present disclosure, the UE could use/apply the TCI state #C indicated by the beam indication DCI for transmitting/receiving the one or more channels/signals.
Yet for another example, when/if both TCI state #A and TCI state #C are applicable according to those specified herein in the present disclosure, the UE could only use/apply the TCI state #A indicated by the indicator(s) for transmitting/receiving the one or more channels/signals, e.g., based on (i) fixed rule(s)/value(s)/relation(s) specified in system specification(s), (ii) network's configuration(s)/indication(s), e.g., via higher layer RRC signaling/parameter and/or MAC CE command and/or dynamic DCI based L1 signaling, and/or (iii) autonomous determination of the UE (which could also be sent to the network, e.g., in part of CSI/beam report or UE capability signaling).
Yet for another example, when/if both TCI state #A and TCI state #C are applicable according to those specified herein in the present disclosure, the UE could only use/apply the TCI state #C indicated by the beam indication DCI for transmitting/receiving the one or more channels/signals, e.g., based on (i) fixed rule(s)/value(s)/relation(s) specified in system specification(s), (ii) network's configuration(s)/indication(s), e.g., via higher layer RRC signaling/parameter and/or MAC CE command and/or dynamic DCI based L1 signaling, and/or (iii) autonomous determination of the UE (which could also be sent to the network, e.g., in part of CSI/beam report or UE capability signaling).
Yet for another example, when/if both TCI state #A and TCI state #C are applicable according to those specified herein in the present disclosure, the UE could use/apply the TCI state #A indicated by the indicator(s) for transmitting/receiving one or more first channels/signals and use/apply the TCI state #C indicated by the beam indication DCI for transmitting/receiving one or more second channels/signals, e.g., based on (i) fixed rule(s)/value(s)/relation(s) specified in system specification(s), (ii) network's configuration(s)/indication(s), e.g., via higher layer RRC signaling/parameter and/or MAC CE command and/or dynamic DCI based L1 signaling, and/or (iii) autonomous determination of the UE (which could also be sent to the network, e.g., in part of CSI/beam report or UE capability signaling), wherein the one or more first channels/signals could be different from the one or more second channels/signals.
Yet for another example, when/if both TCI state #A and TCI state #C are applicable according to those specified herein in the present disclosure and when/if the TCI state #A becomes applicable earlier in time (e.g., x slots/symbols/etc. earlier), wherein x could be: (1) determined according to fixed value(s)/rule(s) in system specification(s), (2) configured/indicated/provided by the network, e.g., via higher layer RRC signaling/parameter and/or MAC CE command and/or dynamic DCI based L1 signaling, and/or (3) autonomously determined by the UE and sent to the network, e.g., in part of CSI/beam report and/or UE capability signaling) than the TCI state #C, the UE could use/apply the TCI state #A indicated by the indicator(s) for transmitting/receiving the one or more channels/signals.
Yet for another example, when/if both TCI state #A and TCI state #C are applicable according to those specified herein in the present disclosure and when/if the TCI state #C becomes applicable earlier in time (e.g., y slots/symbols/etc. earlier), wherein y could be: (1) determined according to fixed value(s)/rule(s) in system specification(s), (2) configured/indicated/provided by the network, e.g., via higher layer RRC signaling/parameter and/or MAC CE command and/or dynamic DCI based L1 signaling, and/or (3) autonomously determined by the UE and sent to the network, e.g., in part of CSI/beam report and/or UE capability signaling) than the TCI state #A, the UE could use/apply the TCI state #C indicated by the beam indication DCI for transmitting/receiving the one or more channels/signals. With reference to FIG. 11, one conceptual example charactering the described procedure is shown.
Yet for another example, when/if both TCI state #A and TCI state #C are applicable according to those specified herein in the present disclosure and when/if the reception of the beam indication DCI is later in time (e.g., x slots/symbols/etc. later), wherein x could be: (1) determined according to fixed value(s)/rule(s) in system specification(s), (2) configured/indicated/provided by the network, e.g., via higher layer RRC signaling/parameter and/or MAC CE command and/or dynamic DCI based L1 signaling, and/or (3) autonomously determined by the UE and sent to the network, e.g., in part of CSI/beam report and/or UE capability signaling) than the transmission of the indicator(s), the UE could use/apply the TCI state #C indicated by the beam indication DCI for transmitting/receiving the one or more channels/signals.
Yet for another example, when/if both TCI state #A and TCI state #C are applicable according to those specified herein in the present disclosure and when/if the reception of the beam indication DCI is later in time (e.g., x′ slots/symbols/etc. later), wherein x′ could be: (1) determined according to fixed value(s)/rule(s) in system specification(s), (2) configured/indicated/provided by the network, e.g., via higher layer RRC signaling/parameter and/or MAC CE command and/or dynamic DCI based L1 signaling, and/or (3) autonomously determined by the UE and sent to the network, e.g., in part of CSI/beam report and/or UE capability signaling) than the reception of the ACK(s) for the indicator(s) as specified herein in the present disclosure, the UE could use/apply the TCI state #C indicated by the beam indication DCI for transmitting/receiving the one or more channels/signals.
Yet for another example, when/if both TCI state #A and TCI state #C are applicable according to those specified herein in the present disclosure and when/if the transmission of the indicator(s) is later in time (e.g., y slots/symbols/etc. later), wherein y could be: (1) determined according to fixed value(s)/rule(s) in system specification(s), (2) configured/indicated/provided by the network, e.g., via higher layer RRC signaling/parameter and/or MAC CE command and/or dynamic DCI based L1 signaling, and/or (3) autonomously determined by the UE and sent to the network, e.g., in part of CSI/beam report and/or UE capability signaling) than the reception of the beam indication DCI, the UE could use/apply the TCI state #A indicated by the indicator(s) for transmitting/receiving the one or more channels/signals.
Yet for another example, when/if both TCI state #A and TCI state #C are applicable according to those specified herein in the present disclosure and when/if the reception of the ACK(s) for the indicator(s) as specified herein in the present disclosure is later in time (e.g., y′ slots/symbols/etc. later), wherein y′ could be: (1) determined according to fixed value(s)/rule(s) in system specification(s), (2) configured/indicated/provided by the network, e.g., via higher layer RRC signaling/parameter and/or MAC CE command and/or dynamic DCI based L1 signaling, and/or (3) autonomously determined by the UE and sent to the network, e.g., in part of CSI/beam report and/or UE capability signaling) than the reception of the beam indication DCI, the UE could use/apply the TCI state #A indicated by the indicator(s) for transmitting/receiving the one or more channels/signals.

In the present disclosure, a TCI state (e.g., the TCI state #C in the described examples herein) indicated by/in a beam indication DCI (e.g., DCI format 1_1/1_2 with or without DL assignment) would become applicable starting from the first slot that is at least beamAppTime symbols after the last symbol of a PUCCH or a PUSCH, wherein the PUCCH or the PUSCH is with HARQ-ACK information corresponding to the beam indication DCI carrying the TCI state indication (e.g., the TCI state #C in the described examples herein) and without DL assignment, or corresponding to the PDSCH scheduled by the beam indication DCI carrying the TCI state indication (e.g., the TCI state #C in the described examples herein), and if the indicated TCI state is different from the previously indicated one. The first slot and the beamAppTime symbols are both determined based on the active BWP with the smallest SCS among the BWP(s) from the CCs applying the indicated TCI state that are active at the end of the PUCCH or the PUSCH carrying the HARQ-ACK information.

In (up to Rel.17) NR specification, the most resource-efficient reporting mechanism for a content (e.g., beam. CSI etc., or in general different report quantities) is aperiodic (in conjunction with aperiodic CSI-RS). On the other hand, with a well-chosen periodicity, periodic reporting (followed by semi-persistent) results in the lowest latency at the expense of resources. Although aperiodic reporting seems preferred from the overall operational perspective, in a few relevant scenarios the NW/gNB lacks knowledge on the DL channel condition—or, in other words, the UE (e.g., the UE 116) knows the DL channel condition better. In this case, it is clearly beneficial if the UE can initiate its own aperiodic reporting for a content (e.g., beam. CSI etc.) or trigger a beam switching for a condition or event. For instance, when the UE is configured only with aperiodic beam reporting and the channel condition is worsened to the point of beam failure, the loss of link due to beam failure can be avoided if the UE can transmit an aperiodic beam report without having to wait for a beam report request/trigger from the NW/gNB or trigger a new beam update without having to wait for a beam change or update indication from the NW/gNB. Likewise, when the UE is configured only with aperiodic CSI reporting and the channel condition is worsened due to UE speed/movement, the performance degradation due to faster link quality degradation can be avoided if the UE can transmit an aperiodic CSI report without having to wait for a CSI request/trigger from the NW/gNB or trigger a new beam update without having to wait for a beam change or update indication from the NW/gNB. Such UE-initiated reporting and/or beam switching for a content can be enabled for other types of report quantities (different from common beam or CSI reports) and application scenarios.

Although UE-initiated reporting and/or beam switching can be beneficial, efficient designs are needed to ensure that the latency is reduced and, at the same time, error events can be minimized. Therefore, there is a need for efficient designs for UE-initiated reporting and/or beam switching for a content that can offer good trade-off between latency and reliability, in particular, when the UE-initiated beam management framework can include multiple report types (or report quantities), or/and multiple event types when a report types can be associated with an event (e.g. for beam report, the event can be beam failure, and for CSI, the event can be user throughput degradation or increasing retransmission rate). This disclosure provides example embodiments on the mentioned UE-initiated beam management herein including CSI/beam reporting and beam switching. Furthermore, this disclosure also provides various design options and resource allocation strategies for sending the beam/CSI report(s) under the UE-initiated and/or event-based beam management framework.

The present disclosure provides various novel and detailed design examples on the UE-initiated beam management framework including UE-initiated/triggered beam/CSI reporting and/or UE-initiated/triggered beam switching. This disclosure also covers various design aspects including signaling support, etc., related to event-based/driven beam operation, in particular, under unified TCI framework. To better support/enable the UE-initiated and the event-based beam operations, this disclosure presents detailed uplink resource allocation designs for sending the CSI/beam report(s).

In the present disclosure, a UE detects (or determines) a need for transmitting a UE-initiated/UE-triggered report (or initiation/triggering) of a (report-)type (A). (B), or (C), where
(A) includes an initiator/trigger/pre-notification message
(B) includes a report/content (comprising one or multiple report quantities)
(C) includes both a trigger/pre-notification message and a (corresponding) report/content

The report is to facilitate/enable efficient/timely/fast/reliable communication over the link/channel between a target entity (e.g., NW/gNB or another device) and the UE. The content (if reported) can include a quantity or quantities. At least one of the following examples can be used/configured for the content:
In one example, the content includes beam-related quantity/quantities. For example, up to N≥1 indicators {Iᵢ} or pairs of {(Iᵢ,Jᵢ)}, where Iᵢ is an beam (source RS) indicator (e.g., CRI, SSBRI) and Jᵢ is a beam metric (e.g., layer 1 reference signal received power (L1-RSRP), layer 1 signal to interference and noise ratio (L1-SINR)).
In one example, the content includes CSI-related quantity/quantities. For example, at least one of (RI. PMI. CQI, CRI, LI),
In one example, the content includes TDCP-related quantity/quantities. For example, an indicator about the Doppler profile (e.g., Doppler spread or Doppler shift, relative Doppler spreads, or relative Doppler shifts), or an indicator about the auto-correlation profiles (e.g. (auto-) correlation values corresponding to a few dominant lags/delays).
In one example, the content includes other (e.g., non-beam, non-CSI, non-TDCP) quantity/quantities.
   In one example, quantity/quantities comprises a selector/indicator indicating selection of one (or >1) of either:
      beam (TCI state) TCI states (e.g., DL TCI state. UL TCI state, or unified (joint) DL/UL TCI state), or
      panel(s) (e.g., UE panels for DL reception or/and UL transmission), or
      antenna (c) (e.g., UE antennae for DL reception or/and UL transmission), or
      antenna port(s) (e.g., UE antenna ports for DL reception or/and UL transmission).
   In one example, quantity/quantities comprises an indicator indicating switching from one beam to another beam, or from one panel to another, or from one antenna port group to another antenna port group, or from N₁ SRS ports to N₂ SRS ports, where N₁≠N₂ (e.g., this switching is for DL reception or/and UL transmission).
In one example, the content includes beam-related quantity/quantities (according to one or more examples described herein) and at least one other quantity/quantities (according to one or more examples described herein).
In one example, the content includes CSI-related quantity/quantities (according to one or more examples described herein) and at least one other quantity/quantities (according to one or more examples described herein).
In one example, the content includes TDCP-related quantity/quantities (according to one or more examples described herein) and at least one other quantity/quantities (according to one or more examples described herein).
In one example, the content includes beam-related quantity/quantities (according to one or more examples described herein) and CSI-related quantity/quantities (according to one or more examples described herein).
In one example, the content includes beam-related quantity/quantities (according to one or more examples described herein) and TDCP-related quantity/quantities (according to one or more examples described herein).
In one example, the content includes TDCP-related quantity/quantities (according to one or more examples described herein) and CSI-related quantity/quantities (according to one or more examples described herein).

In one example, the report is targeting a physical layer (L1) communication (e.g., L1 DL/UL, or L1 SL), i.e., such reporting is to enable fast/reliable DL/UL or SL transmission/reception.

In one example, the link/channel between the target entity and the UE is a Uu interface (i.e., DL, UL).

In one example, the link/channel between the target entity and the UE is a sidelink (SL), or a device-to-device (D2D) or PC5 interface.

In one example, such reporting can be non-event-based or autonomous, the UE can initiate/trigger the report autonomously (i.e., without being associated with any event) or unconditionally/freely. For example, the UE can be configured with a triggering time window (or multiple UL slots), and the UE can trigger the report during this window.

In one example, such reporting can be event-based, i.e., the UE can initiate/trigger the report only when it detects an event associated with the report, where the event can be of a (event-)type: type 0, type 1, and so on. In one example, type 0 corresponds to a beam-related event, type 1 corresponds to a CSI-related event, type 2 corresponds to a time-domain channel property (TDCP)-related event, and type 3 can be a non-CSI-related event (examples provided later). In one example, if a metric (depending on the event-type) is less than or equal to a threshold (or greater than or equal to a threshold), the event is detected or declared positive. The threshold is chosen such that a failure (e.g., beam/link failure) can be detected before it actually happens and the UE-initiated report can avoid the failure.

In one example, such reporting can be non-event-based or event-based, based on report-type.

In one example, such reporting can be non-event-based or event-based, based on a configuration.

A few examples of the event-types and the report-types are provided in Table 6 (for joint) and Table 7/Table 8 (for separate). In these examples, the event-types and the report-types are separate (explicit). However, they can also be joint, as shown in Table 9. A few examples of the autonomous UE-initiated report are shown in Table 10.

TABLE 6
event-based UE-initiated report

| | Report | | |
|---|---|---|---|
| Event type | Type | Trigger/pre-notification message | Content |
| 0: beam | (A) | Yes (e.g., beam-related event) | No |
| | (B) | No | Yes |
| | (C) | Yes (e.g., beam-related event) | Yes |
| 1: CSI | (A) | Yes (e.g., CSI-related event) | No |
| | (B) | No | Yes |
| | (C) | Yes (e.g., CSI-related event) | Yes |
| 2: TDCP | (A) | Yes (e.g., TDCP-related event) | No |
| | (B) | No | Yes |
| | (C) | Yes (e.g., TDCP-related event) | Yes |
| 3: non-CSI/ | (A) | Yes (e.g., non-CSI-related event) | No |
| beam/TDCP | (B) | No | Yes |
| | (C) | Yes (e.g., non-CSI-related event) | Yes |
| 4. other (content- | (A) | Yes (no need for content) | No |
| free/less events) | | | |

TABLE 7
event-based UE-initiated report

| Event-type | Event |
|---|---|
| 0 | Beam-related |
| 1 | CSI-related |
| 2 | TDCP-related |
| 3 | Non-beam/CSI/TDCP |
| 4 | Other |

TABLE 8
event-based UE-initiated report

| Report-type | Trigger/pre-notification message | Content |
|---|---|---|
| (A) | Yes | No |
| (B) | No | Yes |
| (C) | Yes | Yes |

TABLE 9
event-based UE-initiated report
Report

| Type | Trigger/pre-notification message | Content |
|---|---|---|
| 0 | Yes (e.g., beam-related event), | No |
| | content-specific or event-specific | |
| 1 | No | Beam |
| 2 | Yes (e.g., beam-related event) | Beam |
| 3 | Yes (e.g., CSI-related event) | No |
| 4 | No | CSI |
| 5 | Yes (e.g., CSI-related event) | CSI |
| 6 | Yes (e.g., TDCP-related event) | No |
| 7 | No | TDCP |
| 8 | Yes (e.g., TDCP-related event) | TDCP |
| 9 | Yes (e.g., non-CSI-related event) | No |
| 10 | No | Non-CSI |
| 11 | Yes (e.g., non-CSI-related event) | Non-CSI |

TABLE 10
non-event-based or autonomous UE-initiated report
Report

| Type | Trigger/pre-notification message | Content |
|---|---|---|
| 0 | Yes (content-agnostic/transparent) | No |
| 1 | No | Beam |
| 2 | Yes | Beam |
| 3 | No | CSI |
| 4 | Yes | CSI |
| 5 | No | TDCP |
| 6 | Yes | TDCP |
| 7 | No | Non-CSI |
| 8 | Yes | Non-CSI |

In one embodiment, a UE could send to the network (e.g., the network 130) one or more indicators to indicate, initiate or trigger update(s)/change(s) of one or more beams and/or transmission configuration indication (TCI) states (and therefore, quasi-co-location (QCL) settings including QCL source RS(s) and the corresponding QCL type(s) provided/configured therein) and/or spatial relation settings for receiving/transmitting one or more DL/UL channels and/or signals. Throughout this disclosure, a TCI state can also be referred to as a beam or a spatial relation setting; i.e., they can be used/applied interchangeably to various design examples throughout the present disclosure; for instance, a spatial relation or spatial relation setting for determining an UL Tx spatial filter can be with a reference to an RS in the indicated TCI state. Furthermore, throughout the present disclosure, “trigger” can also be referred to as “initiate” or “indicate”; i.e., they can be used/applied interchangeably to various design examples throughout the present disclosure. For instance, the UE could send to the network an indicator to trigger a TCI state change/update/switch for one or more channels or signals. The indicator could comprise/include/contain or correspond to one or more of:
An identity (ID) of the TCI state
An index/ID of a higher layer RRC configured list/set/pool of TCI states that comprises/indicates/provides the TCI state
An index of the TCI state in a list/set/pool of TCI states higher layer RRC configured to the UE.
An index of the TCI state in a set of TCI states activated by a (unified) TCI state(s) activation/deactivation MAC CE
An index/ID of a set of TCI states—e.g., among sets of TCI states activated/provided by a (unified) TCI state(s) activation/deactivation MAC CE—that comprises/indicates/provides the TCI state
A TCI codepoint activated/provided by a (unified) TCI state(s) activation/deactivation MAC CE that comprises/indicates/provides the TCI state
An index/ID of a TCI codepoint—e.g., among TCI codepoints activated/provided by a (unified) TCI state(s) activation/deactivation MAC CE—that comprises/indicates/provides the TCI state
An index/ID of or information related to a (unified) TCI state(s) activation/deactivation MAC CE that activates the TCI state or a TCI codepoint that comprises/indicates/provides the TCI state; the information could include/comprise/contain/indicate when (e.g., reception time in form of slot/slot index/etc.) the (unified) TCI state(s) activation/deactivation MAC CE was received.
An index/ID of or information related to a beam indication DCI that provides/indicates the TCI state or a TCI codepoint that comprises/indicates/provides the TCI state; the information could include/comprise/contain/indicate when (e.g., reception time in form of slot/slot index/etc.) the beam indication DCI was received
An index/ID of a CORESET or a coresetPoolIndex/coresetGroupIndex associated to a CORESET, in which a beam indication DCI that provides/indicates the TCI state or a TCI codepoint that comprises/indicates/provides the TCI state was received
RS index(es)/ID(s) such as SSB index(es)/ID(s) and/or CSI-RS resource index(es)/ID(s) provided/indicated in the TCI state along with the corresponding QCL-type(s)
Resource indicator(s) such as SSBRI(s) and/or CRI(s) in one or more beam reports
A bitmap with each bit position of the bitmap corresponding to a candidate TCI state/RS index or ID/resource indicator/etc.; for this case, when/if a bit position of the bitmap is set to ‘1’ (or ‘0’), the TCI state/RS index or ID/resource indicator/etc. corresponding to the bit position could be for the UE-initiated beam(s)/TCI state(s) switching/update/change as specified herein in the present disclosure.

Furthermore, as described herein in the present disclosure, the indicator could be for one or more DL/UL channels and/or signals. Specifically, for transmitting/receiving DL/UL channel(s).
In one example, the indicator could trigger a TCI state change/update/switch for all applicable DL and UL channels including, e.g., all UE-dedicated PDSCH/PDCCH and dynamic-grant/configured-grant based PUSCH and all of dedicated PUCCH resources.
In another example, the indicator could trigger a TCI state change/update/switch for one or more of all applicable DL and/or UL channels including, e.g., all UE-dedicated PDSCH and/or all UE-dedicated PDCCH and/or dynamic-grant/configured-grant based PUSCH and/or all of dedicated PUCCH resources.
In yet another example, the indicator could trigger a TCI state change/update/switch only for applicable DL channel(s) including, e.g., all UE-dedicated PDSCH and/or PDCCH.
   For example, the indicator could trigger a TCI state change/update/switch only for PDCCH and PDSCH receptions including, e.g., all UE-dedicated reception(s) of PDSCH(s) and PDCCH(s).
   For another example, the indicator could trigger a TCI state change/update/switch only for PDSCH(s) reception including, e.g., all UE-dedicated reception(s) of PDSCH(s).
   Yet for another example, the indicator could trigger a TCI state change/update/switch only for PDCCH(s) reception including, e.g., all UE-dedicated reception(s) of PDCCH(s).
In yet another example, the indicator could trigger a TCI state change/update/switch only for applicable UL channel(s) including, e.g., dynamic-grant/configured-grant based PUSCH and/or all of dedicated PUCCH resources.
   For example, the indicator could trigger a TCI state change/update/switch only for PUSCH and PUCCH transmissions including, e.g., dynamic-grant/configured-grant based PUSCH and all of dedicated PUCCH resources.
   For another example, the indicator could trigger a TCI state change/update/switch only for PUSCH(s) transmission, including, e.g., dynamic-grant/configured-grant based PUSCH.
   Yet for another example, the indicator could trigger a TCI state change/update/switch only for PUCCH(s) transmission, including, e.g., all of dedicated PUCCH resources.
In yet another example, the indicator could trigger a TCI state change/update/switch only for applicable DL/UL control channel(s) including, e.g., all UE-dedicated PDCCH and/or all of dedicated PUCCH resources.
   For example, the indicator could trigger a TCI state change/update/switch only for DL and UL control channels including, e.g., all UE-dedicated PDCCH and all of dedicated PUCCH resources.
   For another example, the indicator could trigger a TCI state change/update/switch only for DL control channel(s) reception including, e.g., all UE-dedicated reception(s) of PDCCH(s).
   Yet for another example, the indicator could trigger a TCI state change/update/switch only for UL control channel(s) transmission including, e.g., all of dedicated PUCCH resources.
In yet another example, the indicator could trigger a TCI state change/update/switch only for applicable DL/UL shared data channel(s) including, e.g., all UE-dedicated PDSCH and/or dynamic-grant/configured-grant based PUSCH.
   For example, the indicator could trigger a TCI state change/update/switch only for DL and UL shared data channels including, e.g., all UE-dedicated PDSCH and dynamic-grant/configured-grant based PUSCH.
   For another example, the indicator could trigger at TCI state change/update/switch only for DL shared data channel(s) reception including, e.g., all UE-dedicated reception(s) of PDSCH(s).
   Yet for another example, the indicator could trigger a TCI state change/update/switch only for UL shared data channel(s) transmission including, e.g., dynamic-grant/configured-grant based PUSCH.

Furthermore, for transmitting/receiving DL/UL signal(s):
In one example, the indicator could trigger a TCI state change/update/switch for all applicable DL and UL signals including, e.g., (aperiodic) CSI-RS resources and (aperiodic) SRS resources.
In another example, the indicator could trigger a TCI state change/update/switch for one or more of all applicable DL and/or UL signals including, e.g., (aperiodic) CSI-RS resources and/or (aperiodic) SRS resources.
In yet another example, the indicator could trigger a TCI state change/update/switch only for DL signal(s) reception including, e.g., (aperiodic) CSI-RS resources.
In yet another example, the indicator could trigger a TCI state change/update/switch only for UL signal(s) transmission including, e.g., (aperiodic) SRS resources.

In the present disclosure, a UE could send to the network, e.g., in part of CSI/beam report and/or the indicator(s) as described herein in the present disclosure, one or more channel/signal indicators to indicate which one or more of the DL and UL channels and signals the TCI state(s) change/update/switch triggered/indicated/initiated by the indicator(s) as described herein in the present disclosure is applied to, according to one or more of the design examples specified herein in the present disclosure.
In one example, the channel/signal indicator(s) could be a one-bit indicator. For instance, the one-bit channel/signal indicator could be applied to one or more examples described herein; for this case, when/if the one-bit channel/signal indicator is set to ‘0’ (or ‘1’), the one-bit channel/signal indicator could indicate that the indicator(s) as specified herein in the present disclosure could trigger a TCI state change/update/switch only for applicable DL channel(s) including, e.g., all UE-dedicated PDSCH and/or PDCCH (i.e., according to one or more example described herein); when/if the one-bit channel/signal indicator is set to ‘1’ (or ‘0’), the one-bit channel/signal indicator could indicate that the indicator(s) as specified herein in the present disclosure could trigger a TCI state change/update/switch only for applicable UL channel(s) including, e.g., dynamic-grant/configured-grant based PUSCH and/or all of dedicated PUCCH resources; optionally, when/if the one-bit channel/signal indicator is not present/reported, the indicator(s) as specified herein in the present disclosure could trigger a TCI state change/update/switch for all applicable DL and UL channels including, e.g., all UE-dedicated PDSCH/PDCCH and dynamic-grant/configured-grant based PUSCH and all of dedicated PUCCH resources. The one-bit channel/signal indicator as described herein in the present disclosure could be applied to other design examples specified herein in the present disclosure.
In another example, the channel/signal indicator(s) could be a bitmap with each entry/bit position of the bitmap corresponding to a DL or UL channel or signal. For this case, when/if an entry/bit position of the bitmap is set to ‘1’ (or ‘0’), the TCI state change/update/switch triggered by the indicator(s) as specified herein in the present disclosure could apply to the DL or UL channel or signal corresponding to the entry/bit position of the bitmap.
In yet another example, the channel/signal indicator(s) could be a bitmap with each entry/bit position of the bitmap corresponding to one or more DL and/or UL channels and/or signals. For this case, when/if an entry/bit position of the bitmap is set to ‘1’ (or ‘0’), the TCI state change/update/switch triggered by the indicator(s) as specified herein in the present disclosure could apply to the one or more DL and/or UL channels and/or signals corresponding to the entry/bit position of the bitmap according to one or more of the design examples specified herein in the present disclosure.

One or more channels and/or signals could be configured/indicated by the network (e.g., the network 130), e.g., via higher layer RRC signaling/parameter and/or MAC CE command and/or dynamic DCI based L1 signaling, to follow the TCI state(s), when/if applicable, indicated by the indicator(s) as specified herein in the present disclosure.
In one example, when/if a higher layer parameter, denoted by ‘followUEInitiatedTCIstate’, is configured/provided or set to enabled for a channel or a signal (e.g., the higher layer parameter ‘followUEInitiatedTCIstate’ could be configured/provided or set to enabled in higher layer parameter(s) that configures/provides the channel or the signal), and when/if the TCI state(s) indicated by the indicator(s) as specified herein in the present disclosure—sent by the UE to the network for the UE-initiated beam switching—has become applicable, the UE could apply/use the TCI state(s) indicated by the indicator(s) as specified herein in the present disclosure for the channel or the signal described/specified herein.
   For example, a SRS resource set or a SRS resource could be configured/provided with/by the higher layer parameter ‘follow UEInitiatedTCIstate’ or the higher layer parameter ‘follow UEInitiatedTCIstate’ set to enabled; for this case, when/if the higher layer parameter ‘followUEInitiatedTCIstate’ is configured/provided or is set to enabled for a SRS resource set or a SRS resource (e.g., in the higher layer parameter(s)/signaling(s) that configures/activates/triggers/indicates/provides the SRS resource set or the SRS resource), the UE could transmit the SRS resources(s) in the SRS resource set or the SRS resource applying/using the TCI state(s), if applicable, indicated by the indicator(s) as specified herein in the present disclosure (the indicator(s) is sent by the UE to the network for UE-initiated beam switching).
   For another example, a CSI resource set such as a SSB resource set provided by CSI-SSB-ResourceSet or a non-zero power (NZP) CSI-RS resource set provided by nzp-CSI-RS-ResourceSet or a CSI(-RS) resource such as a SSB resource or a NZP CSI-RS resource could be configured/provided with/by the higher layer parameter ‘followUEInitiatedTCIState’ or the higher layer parameter ‘followUEInitiatedTCIState’ set to enabled; for this case, when/if the higher layer parameter ‘follow UEInitiatedTCIstate’ is configured/provided or is set to enabled for a CSI resource set or a CSI(-RS) resource (e.g., in the higher layer parameter(s)/signaling(s) that configures/activates/triggers/indicates/provides the CSI resource set or the CSI(-RS) resource), the UE could receive the CSI(-RS) resource(s) in the CSI resource set or the CSI(-RS) resource applying/using the TCI state(s), if applicable, indicated by the indicator(s) as specified herein in the present disclosure (the indicator(s) is sent by the UE to the network for UE-initiated beam switching).
In another example, when/if a higher layer parameter, denoted by ‘followUnifiedTCIstate’ or ‘followUnifiedTCIstateSRS’ specified under the unified TCI framework in the 3GPP Rel-17, is configured/provided or set to enabled for a channel or a signal (e.g., the higher layer parameter ‘followUnifiedTCIstate’ or ‘followUnifiedTCIstateSRS’ could be configured/provided or set to enabled in higher layer parameter(s) that configures/provides the channel or the signal), and when/if the TCI state(s) indicated by the indicator(s) as specified herein in the present disclosure-sent by the UE to the network for the UE-initiated beam switching—has become applicable, the UE could apply/use the TCI state(s) indicated by the indicator(s) as specified herein in the present disclosure for the channel or the signal described/specified herein.
   For example, a SRS resource set or a SRS resource could be configured/provided with/by the higher layer parameter ‘followUnifiedTCIstateSRS’ or the higher layer parameter ‘followUnifiedTCIstateSRS’ set to enabled; for this case, when/if the higher layer parameter ‘followUnifiedTCIstateSRS’ is configured/provided or is set to enabled for a SRS resource set or a SRS resource (e.g., in the higher layer parameter(s)/signaling(s) that configures/activates/triggers/indicates/provides the SRS resource set or the SRS resource), the UE could transmit the SRS resources(s) in the SRS resource set or the SRS resource applying/using the TCI state(s), if applicable, indicated by the indicator(s) as specified herein in the present disclosure (the indicator(s) is sent by the UE to the network for UE-initiated beam switching).
   For another example, a CSI resource set such as a SSB resource set provided by CSI-SSB-ResourceSet or a NZP CSI-RS resource set provided by nzp-CSI-RS-ResourceSet or a CSI(-RS) resource such as a SSB resource or a NZP CSI-RS resource could be configured/provided with/by the higher layer parameter ‘followUnifiedTCIState’ or the higher layer parameter ‘followUnifiedTCIState’ set to enabled; for this case, when/if the higher layer parameter ‘followUnifiedTCIstate’ is configured/provided or is set to enabled for a CSI resource set or a CSI(-RS) resource (e.g., in the higher layer parameter(s)/signaling(s) that configures/activates/triggers/indicates/provides the CSI resource set or the CSI(-RS) resource), the UE could receive the CSI(-RS) resource(s) in the CSI resource set or the CSI(-RS) resource applying/using the TCI state(s), if applicable, indicated by the indicator(s) as specified herein in the present disclosure (the indicator(s) is sent by the UE to the network for UE-initiated beam switching).
In yet another example, for a CORESET with index 0, when/if a higher layer parameter, denoted by ‘followUEInitiatedTCIstate’, is configured/provided or set to enabled for the CORESET (e.g., the higher layer parameter ‘followUEInitiatedTCIstate’ could be configured/provided or set to enabled in the higher layer parameter such as ControlResourceSet that configures the CORESET), and when/if the TCI state(s) indicated by the indicator(s) as specified herein in the present disclosure-sent by the UE to the network for the UE-initiated beam switching—has become applicable, the UE could expect that a DM-RS antenna port for PDCCH receptions in the CORESET and a DM-RS antenna port for PDSCH receptions scheduled by DCI formats provided by PDCCH receptions in the CORESET are quasi co-located with the reference signals provided by the TCI state(s) indicated by the indicator(s). Furthermore, for a CORESET other than a CORESET with index 0, associated at least with common search space (CSS) sets other than Type3-PDCCH CSS sets, when/if a higher layer parameter, denoted by ‘followUEInitiatedTCIstate’, is configured/provided or set to enabled for the CORESET (e.g., the higher layer parameter ‘followUEInitiatedTCIstate’ could be configured/provided or set to enabled in the higher layer parameter such as ControlResourceSet that configures the CORESET), and when/if the TCI state(s) indicated by the indicator(s) as specified herein in the present disclosure-sent by the UE to the network for the UE-initiated beam switching—has become applicable, the UE could expect that a DM-RS antenna port for PDCCH receptions in the CORESET and a DM-RS antenna port for PDSCH receptions scheduled by DCI formats provided by PDCCH receptions in the CORESET are quasi co-located with the reference signals provided by the TCI state(s) indicated by the indicator(s).
In yet another example, for a CORESET with index 0, when/if a higher layer parameter, denoted by ‘followUnifiedTCIstate’ specified under the unified TCI framework in the 3GPP Rel-17, is configured/provided or set to enabled for the CORESET (e.g., the higher layer parameter ‘followUnifiedTCIstate’ could be configured/provided or set to enabled in the higher layer parameter such as ControlResourceSet that configures the CORESET), and when/if the TCI state(s) indicated by the indicator(s) as specified herein in the present disclosure-sent by the UE to the network for the UE-initiated beam switching—has become applicable, the UE could expect that a DM-RS antenna port for PDCCH receptions in the CORESET and a DM-RS antenna port for PDSCH receptions scheduled by DCI formats provided by PDCCH receptions in the CORESET are quasi co-located with the reference signals provided by the TCI state(s) indicated by the indicator(s). Furthermore, for a CORESET other than a CORESET with index 0, associated at least with CSS sets other than Type3-PDCCH CSS sets, when/if a higher layer parameter, denoted by ‘followUnifiedTCIstate’ specified under the unified TCI framework in the 3GPP Rel-17, is configured/provided or set to enabled for the CORESET (e.g., the higher layer parameter ‘followUnifiedTCIstate’ could be configured/provided or set to enabled in the higher layer parameter such as ControlResourceSet that configures the CORESET), and when/if the TCI state(s) indicated by the indicator(s) as specified herein in the present disclosure-sent by the UE to the network for the UE-initiated beam switching—has become applicable, the UE could expect that a DM-RS antenna port for PDCCH receptions in the CORESET and a DM-RS antenna port for PDSCH receptions scheduled by DCI formats provided by PDCCH receptions in the CORESET are quasi co-located with the reference signals provided by the TCI state(s) indicated by the indicator(s).

The indicator(s) described herein in the present disclosure could correspond to the trigger/pre-notification message in a (report-)type (A) based report or a (report-)type (C) based report, or part of the (corresponding) content in a (report-)type (B) based report or a (report-)type (C) based report. Furthermore, the signaling medium/container for reporting the indicator(s) as specified herein in the present disclosure (or equivalently, the trigger/pre-notification message in a (report-)type (A) based report or a (report-)type (C) based report, or part of the (corresponding) content in a (report-)type (B) based report or a (report-)type (C) based report) could be PUCCH, PUSCH. PRACH. MAC CE. UCI, etc. The UE (e.g., the UE 116) may expect to receive from the network an ACK (or NACK) for the indicator(s) specified herein in the present disclosure within a first time window/offset (e.g., in terms of the number of slots/symbols/etc.) starting from the transmission of the indicator(s) (e.g., starting from the corresponding slot/symbol/etc.). The value of the first time window/offset could be: (i) fixed in the system specification(s), (ii) configured/provided/indicated by the network, e.g., via higher layer RRC signaling/parameter and/or MAC CE command and/or dynamic DCI based L1 signaling, or (iii) autonomously determined by the UE and sent to the network via uplink channels such as PUCCH/PUSCH.
When/if the UE does not receive from the network an ACK for the indicator(s) within the first time window/offset starting from the transmission of the indicator(s) or receives a NACK for the indicator(s) within the first time window/offset starting from the transmission of the indicator(s), the UE could (re-)send the indicator(s).
When/if the UE receives from the network an ACK for the indicator(s) within the first time window/offset starting from the transmission of the indicator(s), the UE may perform the behaviors/operations and/or expect the corresponding network's operations according to the indicator(s) X duration/offset/time (e.g., X symbols/slots/etc.) starting from the reception of the ACK message for the indicator(s). The value of X could be: (i) fixed in the system specification(s), (ii) configured/provided/indicated by the network, e.g., via higher layer RRC signaling/parameter and/or MAC CE command and/or dynamic DCI based L1 signaling, or (iii) autonomously determined by the UE and sent to the network via uplink channels such as PUCCH/PUSCH.

The UE could be indicated/configured/provided by the network, e.g., via higher layer RRC signaling/parameter and/or MAC CE command and/or dynamic DCI based L1 signaling, the ACK (or NACK) for the indicator(s) specified herein in the present disclosure for the UE-initiated beam switching. For instance. The UE could be indicated/configured/provided by the network, e.g., via higher layer RRC signaling/parameter and/or MAC CE command and/or dynamic DCI based L1 signaling, a one-bit indicator to indicate ACK or NACK for the indicator(s) specified herein in the present disclosure for the UE-initiated beam switching; when/if the one-bit indicator is set to ‘1’ (or ‘0’), the one-bit indicator could indicate an ACK for the indicator(s) sent by the UE for the UE-initiated TCI state(s)/beam(s) switching/update/change; when/if the one-bit indicator is not present/configured or is set to ‘0’ (or ‘1’), the one-bit indicator could indicate a NACK for the indicator(s) sent by the UE for the UE-initiated TCI state(s)/beam(s) switching/update/change. Furthermore, when/if provided/indicated in a DCI, the ACK (or NACK)—e.g., the one-bit indicator as described herein—for the indicator(s) sent by the UE for the UE-initiated TCI state(s)/beam(s) switching/update/change could be indicated/provided via one or more new/dedicated DCI fields—e.g., denoted by ACK/NACK for UE-initiated beam switching field(s)—in the DCI. Alternatively, when/if provided/indicated in a DCI, the ACK (or NACK)—e.g., the one-bit indicator as described herein—for the indicator(s) sent by the UE for the UE-initiated TCI state(s)/beam(s) switching/update/change could be indicated/provided via/by repurposing one or more bits of one or more existing DCI fields in the DCI. For instance, the ‘New Data Indicator’ (NDI) field in a DCI could be repurposed/used to indicate the ACK (or NACK) for the indicator(s) sent by the UE for the UE-initiated TCI state(s)/beam(s) switching/update/change; when/if the NDI field is toggled or is set to ‘1’ (or ‘0’), the NDI could indicate an ACK for the indicator(s) sent by the UE for the UE-initiated TCI state(s)/beam(s) switching/update/change; otherwise, the NDI could indicate a NACK for the indicator(s) sent by the UE for the UE-initiated TCI state(s)/beam(s) switching/update/change.

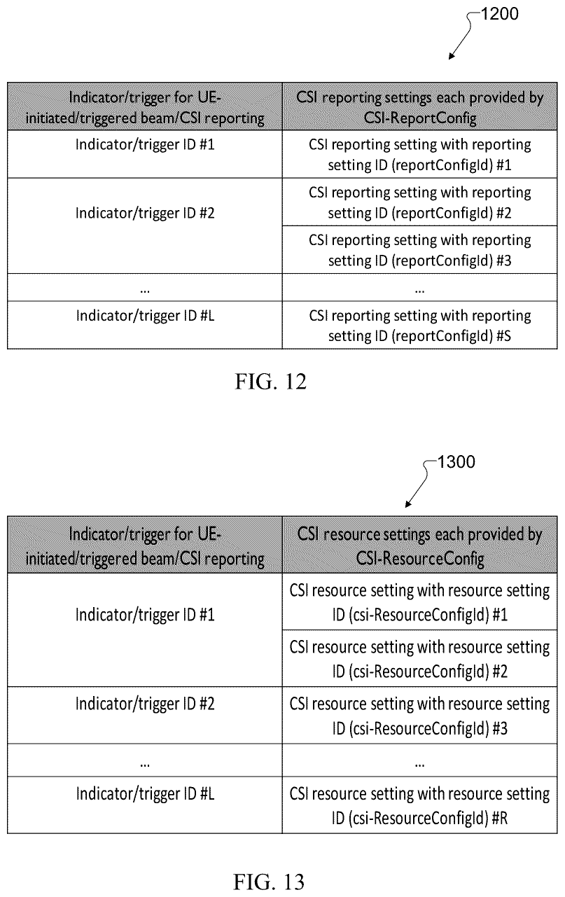

FIG. 12 illustrates a table of example mapping 1200 between indicator/trigger IDs and CSI report settings for beam reporting according to embodiments of the present disclosure. For example, mapping 1200 between indicator/trigger IDs and CSI report settings for beam reporting may be referenced by any of the UEs 111-116 of FIG. 1, such as the UE 112. This example is for illustration only and other embodiments can be used without departing from the scope of the present disclosure.

FIG. 13 illustrates a table of example mapping 1300 between indicator/trigger IDs and CSI resource settings for beam reporting according to embodiments of the present disclosure. For example, mapping 1300 between indicator/trigger IDs and CSI resource settings for beam reporting may be referenced by any of the UEs 111-116 of FIG. 1, such as the UE 116 of FIG. 3. This example is for illustration only and other embodiments can be used without departing from the scope of the present disclosure.

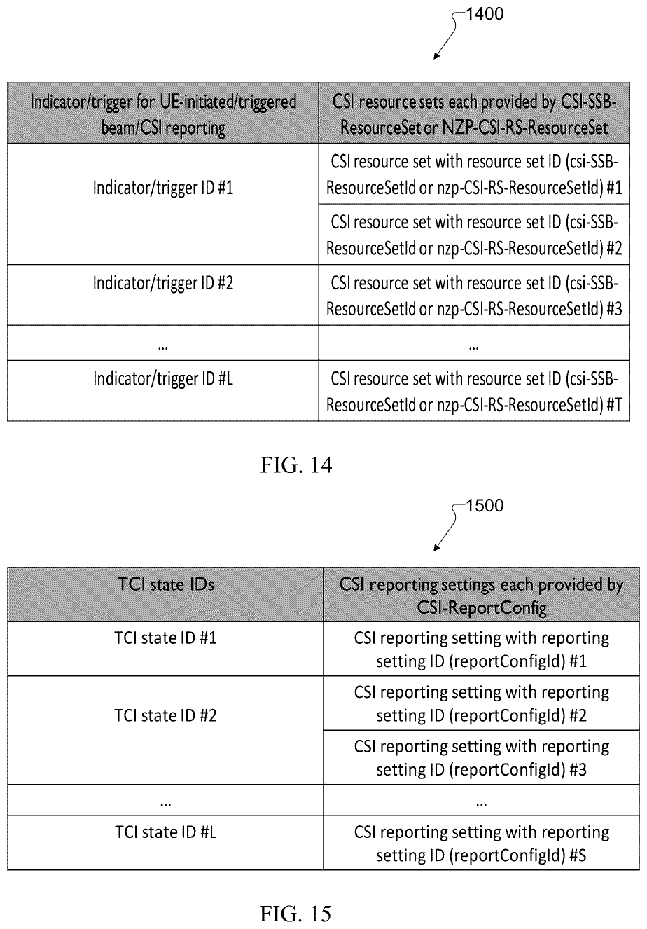

FIG. 14 illustrates a table of example mapping 1400 between indicator/trigger IDs and CSI resource sets for beam reporting according to embodiments of the present disclosure. For example, mapping 1400 between indicator/trigger IDs and CSI resource sets for beam reporting may be referenced by any of the UEs 111-116 of FIG. 1, such as the UE 113. This example is for illustration only and other embodiments can be used without departing from the scope of the present disclosure.

As specified herein in the present disclosure, a UE could send to the network one or more indicators or triggers to initiate or trigger CSI/beam reporting, e.g., the indicator(s) could be of (report-)type (A) as specified herein in the present disclosure which could only contain/include/comprise a trigger/pre-notification message, or the indicator(s) could be of (report-)type (B) as specified herein in the present disclosure which could only contain/include a content (comprising one or more report quantities), or the indicator(s) could be of (report-) type (C) as specified herein in the present disclosure which could contain/include a trigger/pre-notification message and a (corresponding) content (comprising one or more report quantities), wherein each of the one or more indicators or triggers could be associated with or characterized by an indicator/trigger ID. Furthermore, an indicator or trigger, or equivalently, an indicator/trigger ID could be associated to one or more CSI reporting settings (e.g., each provided by a CSI-ReportConfig), one or more CSI resource settings (e.g., each provided by a CSI-ResourceConfig), one or more CSI resource sets (e.g., one or more SSB resource sets each provided by a CSI-SSB-ResourceSet and/or one or more NZP CSI-RS resource sets each provided by a nzp-CSI-RS-ResourceSet), one or more CSI resource groups/subsets in a CSI resource set, one or more SSB resources, and/or one or more NZP CSI-RS resources.
In one example, the UE could be indicated/configured/provided by the network, e.g., via higher layer RRC signaling/parameter and/or MAC CE command and/or dynamic DCI based L1 signaling, the association/mapping between one or more indicators or triggers (or equivalently, one or more indicator/trigger IDs) and one or more CSI reporting settings, one or more CSI resource settings, one or more CSI resource sets, one or more CSI resource groups/subsets in a CSI resource set, one or more SSB resources and/or one or more NZP CSI-RS resources.
   For example, with reference to FIG. 12, the UE could be indicated/configured/provided by the network, e.g., via higher layer RRC signaling/parameter and/or MAC CE command and/or dynamic DCI based L1 signaling, the association/mapping between one or more indicator/trigger IDs (indicator/trigger IDs #1, #2 . . . , #L) and one or more CSI reporting settings (provided by reporting setting IDs #1, #2 . . . , #S). As can be seen from the configured/indicated/provided mapping table in FIG. 12, when/if the UE sends to the network the indicator or trigger with the indicator/trigger ID #1 to initiate or trigger beam/CSI reporting, the CSI reporting setting with the reporting setting ID #1, and therefore the detailed reporting configurations provided therein and the CSI resource setting(s)/CSI resource set(s)/CSI-RS resource(s) associated/linked to the CSI reporting setting, could also be triggered/activated/enabled for the UE-initiated/triggered beam/CSI reporting as specified herein in the present disclosure. That is, after the UE has sent to the network the indicator/trigger with the indicator/trigger ID #1 for the UE-initiated/triggered beam/CSI reporting, the UE could measure the corresponding RSs and report the corresponding CSI/beam measurement results(s) according to the CSI reporting setting with the reporting setting ID #1, and therefore the detailed reporting configurations provided therein and the CSI resource setting(s)/CSI-RS resource set(s)/CSI-RS resource(s) associated/linked to the CSI reporting setting.
   For another example, with reference to FIG. 13, the UE could be indicated/configured/provided by the network, e.g., via higher layer RRC signaling/parameter and/or MAC CE command and/or dynamic DCI based L1 signaling, the association/mapping between one or more indicator/trigger IDs (indicator/trigger IDs #1, #2, . . . , #L) and one or more CSI resource settings (provided by resource setting IDs #1, #2, . . . , #R). As can be seen from the configured/indicated/provided mapping table in FIG. 13, when/if the UE sends to the network the indicator or trigger with the indicator/trigger ID #1 to initiate or trigger beam/CSI reporting, the CSI resource settings with the resource setting IDs #1 and #2, and therefore the detailed resource configurations including the CSI resource set(s)/CSI-RS resource(s) provided therein and the CSI reporting setting(s) associated/linked to the CSI resource settings, could also be triggered/activated/enabled for the UE-initiated/triggered beam/CSI reporting as specified herein in the present disclosure. That is, after the UE has sent to the network the indicator/trigger with the indicator/trigger ID #1 for the UE-initiated/triggered beam/CSI reporting, the UE could measure the corresponding RSs and report the corresponding CSI/beam measurement results(s) according to the CSI resource settings with the resource setting IDs #1 and #2, and therefore the detailed resource configurations including the CSI resource set(s)/CSI-RS resource(s) provided therein and the CSI reporting setting(s) associated/linked to the CSI resource settings.
   Yet for another example, with reference to FIG. 14, the UE could be indicated/configured/provided by the network, e.g., via higher layer RRC signaling/parameter and/or MAC CE command and/or dynamic DCI based L1 signaling, the association/mapping between one or more indicator/trigger IDs (indicator/trigger IDs #1, #2, . . . , #L) and one or more CSI resource sets (provided by resource set IDs #1, #2, . . . , #T). As can be seen from the configured/indicated/provided mapping table in FIG. 14, when/if the UE sends to the network the indicator or trigger with the indicator/trigger ID #1 to initiate or trigger beam/CSI reporting, the CSI resource sets with the resource set IDs #1 and #2 (e.g., two SSB resource sets, two NZP CSI-RS resource sets or a SSB resource set and a NZP CSI-RS resource set), and therefore the detailed resource configurations including the SSB/NZP CSI-RS resource(s) provided therein and the CSI reporting setting(s) associated/linked to the CSI resource sets, could also be triggered/activated/enabled for the UE-initiated/triggered beam/CSI reporting as specified herein in the present disclosure. That is, after the UE has sent to the network the indicator/trigger with the indicator/trigger ID #1 for the UE-initiated/triggered beam/CSI reporting, the UE could measure the corresponding RSs and report the corresponding CSI/beam measurement results(s) according to the CSI resource sets with the resource set IDs #1 and #2, and therefore the detailed resource configurations including the SSB/NZP CSI-RS resource(s) provided therein and the CSI reporting setting(s) associated/linked to the CSI resource sets.
   Yet for another example, the UE could be indicated/configured/provided by the network, e.g., via higher layer RRC signaling/parameter and/or MAC CE command and/or dynamic DCI based L1 signaling, the association/mapping between one or more indicator/trigger IDs and one or more CSI resource groups/subsets, wherein each CSI resource group/subset comprises one or more CSI(-RS) resources and the one or more CSI resource groups/subsets are within the same CSI resource set and configured to the UE via higher layer RRC signaling(s)/parameter(s). Similar to those presented in FIGS. 12, 13 and 14, a UE could be indicated/configured/provided by the network, e.g., via higher layer RRC signaling/parameter and/or MAC CE command and/or dynamic DCI based L1 signaling, a mapping table that maps/links each of the indicator/triggers (or indicator/trigger IDs) to one or more CSI resource groups/subsets. When/if the UE sends to the network an indicator or trigger to initiate or trigger beam/CSI reporting, the CSI resource group(s)/subset(s) that is mapped/linked to the indicator/trigger (or indicator/trigger ID), and therefore the detailed resource configurations including the SSB/NZP CSI-RS resource(s) provided therein and the CSI reporting setting(s) associated/linked to the CSI resource group(s)/subset(s), could also be triggered/activated/enabled for the UE-initiated/triggered beam/CSI reporting as specified herein in the present disclosure. That is, after the UE has sent to the network the indicator/trigger for the UE-initiated/triggered beam/CSI reporting, the UE could measure the corresponding RSs and report the corresponding CSI/beam measurement results(s) according to the CSI resource group(s)/subset(s) associated to the indicator/trigger, and therefore the detailed resource configurations including the SSB/NZP CSI-RS resource(s) provided therein and the CSI reporting setting(s) associated/linked to the CSI resource group(s)/subset(s).
   Yet for another example, the UE could be indicated/configured/provided by the network, e.g., via higher layer RRC signaling/parameter and/or MAC CE command and/or dynamic DCI based L1 signaling, the association/mapping between one or more indicator/trigger IDs and one or more SSB/NZP CSI-RS resources. Similar to those presented in FIGS. 12, 13 and 14, a UE could be indicated/configured/provided by the network, e.g., via higher layer RRC signaling/parameter and/or MAC CE command and/or dynamic DCI based L1 signaling, a mapping table that maps/links each of the indicator/triggers (or indicator/trigger IDs) to one or more SSB/NZP CSI-RS resources. When/if the UE sends to the network an indicator or trigger to initiate or trigger beam/CSI reporting, the SSB/NZP CSI-RS resource(s) that is mapped/linked to the indicator/trigger (or indicator/trigger ID), and the CSI reporting setting(s) associated/linked to the SSB/NZP CSI-RS resource(s), could also be triggered/activated/enabled for the UE-initiated/triggered beam/CSI reporting as specified herein in the present disclosure. That is, after the UE has sent to the network the indicator/trigger for the UE-initiated/triggered beam/CSI reporting, the UE could measure the corresponding RSs and report the corresponding CSI/beam measurement results(s) according to the SSB/NZP CSI-RS resource(s) associated to the indicator/trigger, and therefore the CSI reporting setting(s) associated/linked to the SSB/NZP CSI-RS resource(s).
In another example, the higher layer parameter(s)/signaling(s) that provides/configures/indicates an indicator/trigger for the UE-initiated/triggered beam/CSI reporting as specified herein in the present disclosure could also provide/indicate/include/comprise/contain/configure one or more CSI reporting settings each provided by a CSI-ReportConfig (and/or their corresponding reporting setting IDs each provided by reportConfigId), and/or one or more CSI resource settings each provided by a CSI-ResourceConfig (and/or their corresponding resource setting IDs each provided by csi-ResourceConfigId), and/or one or more CSI resource sets each provided by a CSI-SSB-ResourceSet or a NZP-CSI-RS-ResourceSet (and/or their corresponding resource set IDs each provided by csi-SSB-ResourceSetId or nzp-CSI-RS-ResourceSetId), and/or one or more CSI resource subsets/groups (in a CSI resource set) each provided by a CSI-SSB-ResourceSubSet or a NZP-CSI-RS-ResourceSubSet (and/or their corresponding resource subset/group IDs each provided by csi-SSB-ResourceSubSetId or nzp-CSI-RS-ResourceSubSetId), and/or one or more SSB/NZP CSI-RS resources each provided by a SSB-Index or a nzp-CSI-RS-ResourceId. For this design example, the indicator/trigger and the one or more CSI resource settings and/or the one or more CSI reporting settings and/or the one or more CSI resource sets and/or the one or more CSI resource groups/subsets and/or the one or more SSB/NZP CSI-RS resources could be linked/associated/mapped with/to each other(s) if they are provided/configured/indicated in/by the same higher layer parameter(s)/signaling(s).
In yet another example, the higher layer parameter(s) CSI-ReportConfig that configures a CSI reporting setting, and/or CSI-ResourceConfig that configures a CSI-ResourceConfig, and/or CSI-SSB-ResourceSet that configures a SSB resource set, and/or NZP-CSI-RS-ResourceSet that configures a NZP CSI-RS resource set, and/or CSI-SSB-ResourceSubSet that configures a SSB resource subset/group as specified herein in the present disclosure, and/or NZP-CSI-RS-ResourceSubSet that configures a NZP CSI-RS resource subset/group as specified herein in the present disclosure, and/or SSB-Index that configures a SSB resource, and/or nzp-CSI-RS-Resource that configures a NZP CSI-RS resource set could configure/provide/indicate/comprise/include/contain one or more indicator/trigger IDs. For this design example, the one or more indicators/triggers (or the one or more indicator/trigger IDs) and the CSI resource setting and/or the CSI reporting setting and/or the CSI resource set and/or the CSI resource group/subset and/or the SSB/NZP CSI-RS resource could be linked/associated/mapped with/to each other(s) if they are provided/configured/indicated in/by the same higher layer parameter(s)/signaling(s).

FIG. 15 illustrates a table of example mapping 1500 between TCI state IDs and CSI report settings for beam reporting according to embodiments of the present disclosure. For example, mapping 1500 between TCI state IDs and CSI report settings for beam reporting may be referenced by any of the UEs 111-116 of FIG. 1, such as the UE 114. This example is for illustration only and other embodiments can be used without departing from the scope of the present disclosure.

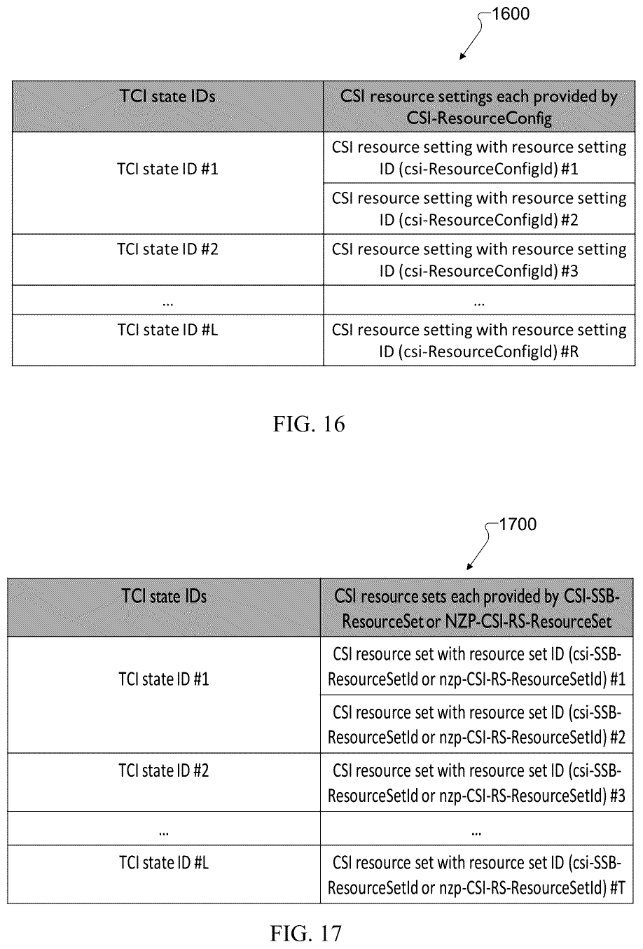

FIG. 16 illustrates a table of example mapping 1600 between TCI state IDs and CSI resource settings for beam reporting according to embodiments of the present disclosure. For example, mapping 1600 between TCI state IDs and CSI resource settings for beam reporting may be referenced by any of the UEs 111-116 of FIG. 1, such as the UE 115. This example is for illustration only and other embodiments can be used without departing from the scope of the present disclosure.

FIG. 17 illustrates a table of example mapping 1700 between TCI state IDs and CSI resource sets for beam reporting according to embodiments of the present disclosure. For example, mapping 1700 between TCI state IDs and CSI resource sets for beam reporting may be referenced by any of the UEs 111-116 of FIG. 1, such as the UE 116 of FIG. 3. This example is for illustration only and other embodiments can be used without departing from the scope of the present disclosure.

In one embodiment, a UE could receive from the network (e.g., the network 130) a (unified) TCI state activation/deactivation MAC CE command and/or a beam indication DCI (e.g., DCI format 1_1/1_2 with or without DL assignment) to indicate or update one or more TCI states for one or more channels/signals. The (unified) TCI state activation/deactivation MAC CE could provide/comprise one or more sets of TCI states used to map to one or more TCI codepoints of the TCI field in a beam indication DCI; when/if only one TCI state or one set of TCI states is provided/indicated by/in the (unified) TCI state(s) activation/deactivation MAC CE, the UE (e.g., the UE 116) could use/apply the TCI state/set of TCI states for transmitting/receiving one or more channels/signals. The UE could apply/use the TCI state(s) indicated by the TCI field in the beam indication DCI for transmitting/receiving one or more channels/signals. Furthermore. X time/duration (e.g., X slots/symbols/etc.) after/upon receiving the (unified) TCI state(s) activation/deactivation MAC CE and/or the beam indication DCI, the UE could start measuring/receiving one or more RSs such as NZP CSI-RSs, and report to the network the corresponding measurement result(s) including one or more resource indicators and their respective beam metrics. Here, the value of X could be determined/identified according to: (1) a fixed value specified or provided in system specifications. (2) network's configuration(s)/indication(s), e.g., via higher layer RRC signaling/parameter and/or MAC CE command and/or dynamic DCI based L1 signaling, and/or (3) UE's autonomous selection, which could also be reported/sent to the network, e.g., in part of CSI/beam report and/or UE's capability signaling. That is, the TCI state(s)/beam(s) update/indication via the (unified) TCI state(s) activation/deactivation MAC CE and/or the beam indication DCI could also trigger or initiate (aperiodic) CSI measurement and reporting-denoted by TCI state(s)/beam(s) indication driven beam/CSI measurement and reporting in the present disclosure. For this case, an indicated/updated TCI state/beam could be associated to one or more CSI reporting settings (e.g., each provided by a CSI-ReportConfig), one or more CSI resource settings (e.g., each provided by a CSI-ResourceConfig), one or more CSI resource sets (e.g., one or more SSB resource sets each provided by a CSI-SSB-ResourceSet and/or one or more NZP CSI-RS resource sets each provided by a nzp-CSI-RS-ResourceSet), one or more CSI resource groups/subsets in a CSI resource set, one or more SSB resources, and/or one or more NZP CSI-RS resources.
In one example, the UE could be indicated/configured/provided by the network, e.g., via higher layer RRC signaling/parameter and/or MAC CE command and/or dynamic DCI based L1 signaling, the association/mapping between one or more TCI states and one or more CSI reporting settings, one or more CSI resource settings, one or more CSI resource sets, one or more CSI resource groups/subsets in a CSI resource set, one or more SSB resources and/or one or more NZP CSI-RS resources.
   For example, with reference to FIG. 15, the UE could be indicated/configured/provided by the network, e.g., via higher layer RRC signaling/parameter and/or MAC CE command and/or dynamic DCI based L1 signaling, the association/mapping between one or more TCI states/TCI state IDs (TCI state IDs #1, #2, . . . , #L) and one or more CSI reporting settings (provided by reporting setting IDs #1, #2, . . . , #S). As can be seen from the configured/indicated/provided mapping table in FIG. 15, when/if the TCI state with TCI state ID #1 is indicated/updated to the UE via the (unified) TCI state(s) activation/deactivation MAC CE and/or beam indication DCI for one or more channels/signals, the CSI reporting setting with the reporting setting ID #1, and therefore the detailed reporting configurations provided therein and the CSI resource setting(s)/CSI resource set(s)/CSI-RS resource(s) associated/linked to the CSI reporting setting, could also be triggered/activated/enabled for the TCI state(s)/beam(s) indication driven beam/CSI measurement and reporting as specified herein in the present disclosure. That is, after the UE has been indicated by the network via the (unified) TCI state(s) activation/deactivation MAC CE and/or beam indication DCI the TCI state with TCI state ID #1 for one or more channels/signals, the UE could measure the corresponding RSs and report the corresponding CSI/beam measurement results(s) according to the CSI reporting setting with the reporting setting ID #1, and therefore the detailed reporting configurations provided therein and the CSI resource setting(s)/CSI-RS resource set(s)/CSI-RS resource(s) associated/linked to the CSI reporting setting.
   For another example, with reference to FIG. 16, the UE could be indicated/configured/provided by the network, e.g., via higher layer RRC signaling/parameter and/or MAC CE command and/or dynamic DCI based L1 signaling, the association/mapping between one or more TCI states/TCI state IDs (TCI state IDs #1, #2, . . . , #L) and one or more CSI resource settings (provided by resource setting IDs #1, #2, . . . , #R). As can be seen from the configured/indicated/provided mapping table in FIG. 16, when/if the TCI state with TCI state ID #1 is indicated/updated to the UE via the (unified) TCI state(s) activation/deactivation MAC CE and/or beam indication DCI for one or more channels/signals, the CSI resource settings with the resource setting IDs #1 and #2, and therefore the detailed resource configurations including the CSI resource set(s)/CSI-RS resource(s) provided therein and the CSI reporting setting(s) associated/linked to the CSI resource settings, could also be triggered/activated/enabled for the TCI state(s)/beam(s) indication driven beam/CSI measurement and reporting as specified herein in the present disclosure. That is, after the UE has been indicated/updated by the network via the (unified) TCI state(s) activation/deactivation MAC CE and/or beam indication DCI the TCI state with TCI state ID #1 for one or more channels/signals, the UE could measure the corresponding RSs and report the corresponding CSI/beam measurement results(s) according to the CSI resource settings with the resource setting IDs #1 and #2, and therefore the detailed resource configurations including the CSI resource set(s)/CSI-RS resource(s) provided therein and the CSI reporting setting(s) associated/linked to the CSI resource settings.
   Yet for another example, with reference to FIG. 17, the UE could be indicated/configured/provided by the network, e.g., via higher layer RRC signaling/parameter and/or MAC CE command and/or dynamic DCI based L1 signaling, the association/mapping between one or more TCI states/TCI state IDs (TCI state IDs #1, #2, . . . , #L) and one or more CSI resource sets (provided by resource set IDs #1, #2, . . . , #T). As can be seen from the configured/indicated/provided mapping table in FIG. 17, when/if the TCI state with TCI state ID #1 is indicated/updated to the UE via the (unified) TCI state(s) activation/deactivation MAC CE and/or beam indication DCI for one or more channels/signals, the CSI resource sets with the resource set IDs #1 and #2 (e.g., two SSB resource sets, two NZP CSI-RS resource sets or a SSB resource set and a NZP CSI-RS resource set), and therefore the detailed resource configurations including the SSB/NZP CSI-RS resource(s) provided therein and the CSI reporting setting(s) associated/linked to the CSI resource sets, could also be triggered/activated/enabled for the TCI state(s)/beam(s) indication driven beam/CSI measurement and reporting as specified herein in the present disclosure. That is, after the UE has been indicated/updated by the network via the (unified) TCI state(s) activation/deactivation MAC CE and/or beam indication DCI the TCI state with TCI state ID #1 for one or more channels/signals, the UE could measure the corresponding RSs and report the corresponding CSI/beam measurement results(s) according to the CSI resource sets with the resource set IDs #1 and #2, and therefore the detailed resource configurations including the SSB/NZP CSI-RS resource(s) provided therein and the CSI reporting setting(s) associated/linked to the CSI resource sets.
   Yet for another example, the UE could be indicated/configured/provided by the network, e.g. via higher layer RRC signaling/parameter and/or MAC CE command and/or dynamic DCI based L1 signaling, the association/mapping between one or more TCI states/TCI state IDs and one or more CSI resource groups/subsets, wherein each CSI resource group/subset comprises one or more CSI(-RS) resources and the one or more CSI resource groups/subsets are within the same CSI resource set and configured to the UE via higher layer RRC signaling(s)/parameter(s). Similar to those presented in FIGS. 15, 16 and 17, a UE could be indicated/configured/provided by the network, e.g., via higher layer RRC signaling/parameter and/or MAC CE command and/or dynamic DCI based L1 signaling, a mapping table that maps/links each of the TCI states (or TCI state IDs) to one or more CSI resource groups/subsets. When/if a TCI state is indicated/updated to the UE via the (unified) TCI state(s) activation/deactivation MAC CE and/or beam indication DCI for one or more channels/signals, the CSI resource group(s)/subset(s) that is mapped/linked to the TCI state (or TCI state ID), and therefore the detailed resource configurations including the SSB/NZP CSI-RS resource(s) provided therein and the CSI reporting setting(s) associated/linked to the CSI resource group(s)/subset(s), could also be triggered/activated/enabled for the TCI state(s)/beam(s) indication driven beam/CSI measurement and reporting as specified herein in the present disclosure. That is, after the UE has been indicated/updated to the UE via the (unified) TCI state(s) activation/deactivation MAC CE and/or beam indication DCI a TCI state for one or more channels/signals, the UE could measure the corresponding RSs and report the corresponding CSI/beam measurement results(s) according to the CSI resource group(s)/subset(s) associated to the TCI state/TCI state ID, and therefore the detailed resource configurations including the SSB/NZP CSI-RS resource(s) provided therein and the CSI reporting setting(s) associated/linked to the CSI resource group(s)/subset(s).
   Yet for another example, the UE could be indicated/configured/provided by the network, e.g., via higher layer RRC signaling/parameter and/or MAC CE command and/or dynamic DCI based L1 signaling, the association/mapping between one or more TCI states/TCI state IDs and one or more SSB/NZP CSI-RS resources. Similar to those presented in FIGS. 15, 16 and 17, a UE could be indicated/configured/provided by the network, e.g., via higher layer RRC signaling/parameter and/or MAC CE command and/or dynamic DCI based L1 signaling, a mapping table that maps/links each of the TCI states (or TCI state IDs) to one or more SSB/NZP CSI-RS resources. When/if a TCI state is indicated/updated to the UE via the (unified) TCI state(s) activation/deactivation MAC CE and/or beam indication DCI for one or more channels/signals, the SSB/NZP CSI-RS resource(s) that is mapped/linked to the TCI state (or TCI state ID), and the CSI reporting setting(s) associated/linked to the SSB/NZP CSI-RS resource(s), could also be triggered/activated/enabled for the TCI state(s)/beam(s) indication driven beam/CSI measurement and reporting as specified herein in the present disclosure. That is, after the UE has been indicated/updated by the network via the (unified) TCI state(s) activation/deactivation MAC CE and/or beam indication DCI a TCI state for one or more channels/signals, the UE could measure the corresponding RSs and report the corresponding CSI/beam measurement results(s) according to the SSB/NZP CSI-RS resource(s) associated to the TCI state/TCI state ID, and therefore the CSI reporting setting(s) associated/linked to the SSB/NZP CSI-RS resource(s).
In another example, the higher layer parameter(s)/signaling(s) that provides/configures/indicates a TCI state—e.g., TCI-State. UL-TCI-State. DLorJoint-TCIState and/or etc.—could also provide/indicate/include/comprise/contain/configure one or more CSI reporting settings each provided by a CSI-ReportConfig (and/or their corresponding reporting setting IDs each provided by reportConfigId), and/or one or more CSI resource settings each provided by a CSI-ResourceConfig (and/or their corresponding resource setting IDs each provided by csi-ResourceConfigId), and/or one or more CSI resource sets each provided by a CSI-SSB-ResourceSet or a NZP-CSI-RS-ResourceSet (and/or their corresponding resource set IDs each provided by csi-SSB-ResourceSetId or nzp-CSI-RS-ResourceSetId), and/or one or more CSI resource subsets/groups (in a CSI resource set) each provided by a CSI-SSB-ResourceSubSet or a NZP-CSI-RS-ResourceSubSet (and/or their corresponding resource subset/group IDs each provided by csi-SSB-ResourceSubSetId or nzp-CSI-RS-ResourceSubSetId), and/or one or more SSB/NZP CSI-RS resources each provided by a SSB-Index or a nzp-CSI-RS-ResourceId. For this design example, the TCI state and the one or more CSI resource settings and/or the one or more CSI reporting settings and/or the one or more CSI resource sets and/or the one or more CSI resource groups/subsets and/or the one or more SSB/NZP CSI-RS resources could be linked/associated/mapped with/to each other(s) if they are provided/configured/indicated in/by the same higher layer parameter(s)/signaling(s) such as TCI-State. UL-TCI-State. DLorJoint-TCIState and/or etc.
In yet another example, the higher layer parameter(s) CSI-ReportConfig that configures a CSI reporting setting, and/or CSI-ResourceConfig that configures a CSI-ResourceConfig, and/or CSI-SSB-ResourceSet that configures a SSB resource set, and/or NZP-CSI-RS-ResourceSet that configures a NZP CSI-RS resource set, and/or CSI-SSB-ResourceSubSet that configures a SSB resource subset/group as specified herein in the present disclosure, and/or NZP-CSI-RS-ResourceSubSet that configures a NZP CSI-RS resource subset/group as specified herein in the present disclosure, and/or SSB-Index that configures a SSB resource, and/or nzp-CSI-RS-Resource that configures a NZP CSI-RS resource set could configure/provide/indicate/comprise/include/contain one or more TCI state IDs. For this design example, the one or more TCI states (or the one or more TCI state IDs) and the CSI resource setting and/or the CSI reporting setting and/or the CSI resource set and/or the CSI resource group/subset and/or the SSB/NZP CSI-RS resource could be linked/associated/mapped with/to each other(s) if they are provided/configured/indicated in/by the same higher layer parameter(s)/signaling(s).

In one embodiment, a UE could receive from the network a (unified) TCI state activation/deactivation MAC CE command and/or a beam indication DCI (e.g., DCI format 1_1/1_2 with or without DL assignment) to indicate or update one or more TCI states for one or more channels/signals, wherein each TCI state could comprise/provide/indicate/configure one or more QCL source RSs and their corresponding QCL types. The (unified) TCI state activation/deactivation MAC CE could provide/comprise one or more sets of TCI states used to map to one or more TCI codepoints of the TCI field in a beam indication DCI; when/if only one TCI state or one set of TCI states is provided/indicated by/in the (unified) TCI state(s) activation/deactivation MAC CE, the UE could use/apply the TCI state/set of TCI states—and therefore, the QCL source RS(s) and the corresponding QCL type(s) provided/indicated therein—for transmitting/receiving one or more channels/signals. The UE could apply/use the TCI state(s)—and therefore, the QCL source RS(s) and the corresponding QCL type(s) indicated/provided therein—indicated by the TCI field in the beam indication DCI for transmitting/receiving one or more channels/signals. Furthermore. X time/duration (e.g., X slots/symbols/etc.) after/upon receiving the (unified) TCI state(s) activation/deactivation MAC CE and/or the beam indication DCI, the UE could start measuring/receiving one or more RSs such as NZP CSI-RSs, and report to the network the corresponding measurement result(s) including one or more resource indicators and their respective beam metrics. Here, the value of X could be determined/identified according to: (1) a fixed value specified or provided in system specifications. (2) network's configuration(s)/indication(s), e.g., via higher layer RRC signaling/parameter and/or MAC CE command and/or dynamic DCI based L1 signaling, and/or (3) UE's autonomous selection, which could also be reported/sent to the network, e.g., in part of CSI/beam report and/or UE's capability signaling. That is, the TCI state(s)/beam(s) update/indication via the (unified) TCI state(s) activation/deactivation MAC CE and/or the beam indication DCI could also trigger or initiate (aperiodic) CSI measurement and reporting-denoted by TCI state(s)/beam(s) indication driven beam/CSI measurement and reporting in the present disclosure. For this case, the QCL source RS(s) provided/indicated in an indicated/updated TCI state/beam could be associated to one or more CSI reporting settings (e.g., each provided by a CSI-ReportConfig), one or more CSI resource settings (e.g., each provided by a CSI-ResourceConfig), one or more CSI resource sets (e.g., one or more SSB resource sets each provided by a CSI-SSB-ResourceSet and/or one or more NZP CSI-RS resource sets each provided by a nzp-CSI-RS-ResourceSet), one or more CSI resource groups/subsets in a CSI resource set, one or more SSB resources, and/or one or more NZP CSI-RS resources.
In one example, the UE could be indicated/configured/provided by the network, e.g., via higher layer RRC signaling/parameter and/or MAC CE command and/or dynamic DCI based L1 signaling, the association/mapping between one or more QCL source RS resources (and therefore, their resource IDs) and one or more CSI reporting settings, one or more CSI resource settings, one or more CSI resource sets, one or more CSI resource groups/subsets in a CSI resource set, one or more SSB resources and/or one or more NZP CSI-RS resources. Similar to those presented in FIGS. 15, 16 and 17—e.g., by replacing TCI state IDs to QCL source RS resource IDs, a UE could be indicated/configured/provided by the network, e.g., via higher layer RRC signaling/parameter and/or MAC CE command and/or dynamic DCI based L1 signaling, a mapping table that maps/links each of the one or more QCL source RS resources (and therefore, their resource IDs) to one or more CSI reporting settings, and/or one or more CSI resource settings, and/or one or more CSI resource sets, and/or one or more CSI resource groups/subsets, and/or one or more SSB resources, and/or one or more NZP CSI-RS resources. When/if a TCI state, and therefore a QCL source RS provided/indicated therein, is indicated/updated to the UE via the (unified) TCI state(s) activation/deactivation MAC CE and/or beam indication DCI for one or more channels/signals, the CSI reporting setting(s), and/or CSI resource setting(s), and/or CSI resource set(s), and/or CSI resource group(s)/subset(s), and/or SSB resource(s), and/or NZP CSI-RS resource(s) that is mapped/linked to the QCL source RS resource (or equivalently, the QCL source RS resource ID), could also be triggered/activated/enabled for the TCI state(s)/beam(s) indication driven beam/CSI measurement and reporting as specified herein in the present disclosure. That is, after the UE has been indicated/updated to the UE via the (unified) TCI state(s) activation/deactivation MAC CE and/or beam indication DCI a TCI state, and therefore, a QCL source RS resource provided/indicated therein, for one or more channels/signals, the UE could measure the corresponding RSs and report the corresponding CSI/beam measurement results(s) according to the CSI reporting setting(s), and/or CSI resource setting(s), and/or CSI resource set(s), and/or CSI resource group(s)/subset(s), and/or SSB resource(s), and/or NZP CSI-RS resource(s) associated to the QCL source RS resource/QCL source RS resource ID.
In another example, the higher layer parameter(s)/signaling(s) that provides/configures/indicates a QCL source RS (and therefore, the corresponding QCL type)—e.g., QCL-Info in TCI-State. UL-TCI-State. DLorJoint-TCIState and/or etc, and/or SSB-Index and/or nzp-CSI-RS-Resource-could also provide/indicate/include/comprise/contain/configure one or more CSI reporting settings each provided by a CSI-ReportConfig (and/or their corresponding reporting setting IDs each provided by reportConfigId), and/or one or more CSI resource settings each provided by a CSI-ResourceConfig (and/or their corresponding resource setting IDs each provided by csi-ResourceConfigId), and/or one or more CSI resource sets each provided by a CSI-SSB-ResourceSet or a NZP-CSI-RS-ResourceSet (and/or their corresponding resource set IDs each provided by csi-SSB-ResourceSetId or nzp-CSI-RS-ResourceSetId), and/or one or more CSI resource subsets/groups (in a CSI resource set) each provided by a CSI-SSB-ResourceSubSet or a NZP-CSI-RS-ResourceSubSet (and/or their corresponding resource subset/group IDs each provided by csi-SSB-ResourceSubSetId or nzp-CSI-RS-ResourceSubSetId), and/or one or more SSB/NZP CSI-RS resources each provided by a SSB-Index or a nzp-CSI-RS-ResourceId. For this design example, the QCL source RS and the one or more CSI resource settings and/or the one or more CSI reporting settings and/or the one or more CSI resource sets and/or the one or more CSI resource groups/subsets and/or the one or more SSB/NZP CSI-RS resources could be linked/associated/mapped with/to each other(s) if they are provided/configured/indicated in/by the same higher layer parameter(s)/signaling(s) such as QCL-Info in TCI-State. UL-TCI-State. DLorJoint-TCIState and/or etc. and/or SSB-Index and/or nzp-CSI-RS-Resource.
In yet another example, the higher layer parameter(s) CSI-ReportConfig that configures a CSI reporting setting, and/or CSI-ResourceConfig that configures a CSI-ResourceConfig, and/or CSI-SSB-ResourceSet that configures a SSB resource set, and/or NZP-CSI-RS-ResourceSet that configures a NZP CSI-RS resource set, and/or CSI-SSB-ResourceSubSet that configures a SSB resource subset/group as specified herein in the present disclosure, and/or NZP-CSI-RS-ResourceSubSet that configures a NZP CSI-RS resource subset/group as specified herein in the present disclosure, and/or SSB-Index that configures a SSB resource, and/or nzp-CSI-RS-Resource that configures a NZP CSI-RS resource set could configure/provide/indicate/comprise/include/contain one or more QCL source RS resource IDs (or IDs/indexes associated/corresponding to higher layer parameter(s) QCL-Info in TCI-State. UL-TCI-State. DLorJointTCI-State and/or etc.). For this design example, the one or more QCL source RS resources (or the one or more QCL source RS resource IDs) and the CSI resource setting and/or the CSI reporting setting and/or the CSI resource set and/or the CSI resource group/subset and/or the SSB/NZP CSI-RS resource could be linked/associated/mapped with/to each other(s) if they are provided/configured/indicated in/by the same higher layer parameter(s)/signaling(s).

According to or based on those specified herein in the present disclosure, for the UE-initiated/event-driven beam management including beam reporting. (1) the QCL source RS(s) of a TCI state including (i) CSI-RS(s) including TRS(s) provided/indicated in the QCL-Info/TCI-State that provides or configures the TCI state and/or (ii) SSB(s) that is QCL'ed with CSI-RS(s) including TRS(s) provided/indicated in the QCL-Info/TCI-State that provides or configures the TCI state could be identified or determined by the UE (e.g., when the TCI state is indicated/updated by MAC CE and/or DCI—e.g., via the TCI field in DCI format 1_1/1_2 with or without DL assignment) as current serving beam RS(s), and (2) the RS resource(s) associated/specific to the TCI state according to or following those specified herein in the present disclosure—e.g., the CSI resource setting(s), CSI resource set(s) and/or CSI-RS resource(s) including SSB(s) and/or NZP CSI-RS resource(s) that are associated to the RS resource(s) could be provided/configured/indicated in the QCL-Info/TCI-State that provides or configures the TCI state-could be identified or determined by the UE (e.g., when the TCI state is indicated/updated by MAC CE and/or DCI—e.g., via the TCI field in DCI format 1_1/1_2 with or without DL assignment) as candidate/new beam RS(s).

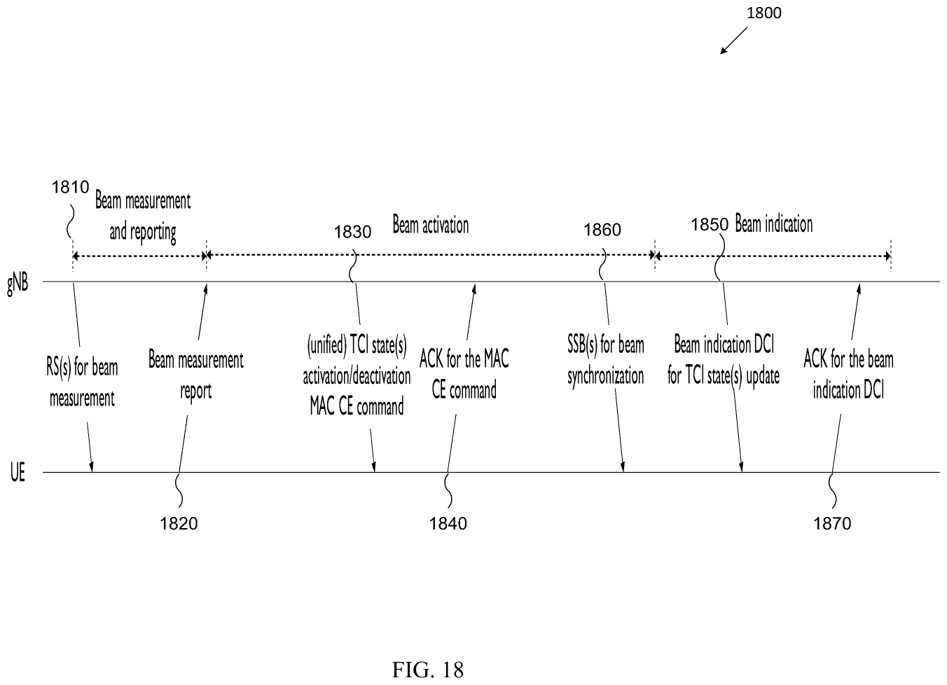

FIG. 18 illustrates a flow diagram 1800 for an example beam operation according to embodiments of the present disclosure. For example, flow diagram 1800 for an example beam operation may be followed by the UE 111 and the gNB 102 and/or network 130 in the wireless network 100 of FIG. 1. This example is for illustration only and other embodiments can be used without departing from the scope of the present disclosure.
In 1810 (beam measurement and reporting), a UE could receive and measure one or more RSs from the network for beam measurement and reporting; here, a RS could correspond to a SSB or a NZP CSI-RS.
In 1820 (beam measurement and reporting), the UE could send to the network a beam measurement report, wherein the beam measurement report could contain/comprise/include/indicate one or more resource indicators and their corresponding beam metrics; here, a resource indicator could correspond to a SSBRI or a CRI, and a beam metric could correspond to a L1-RSRP or a L1-SINR.
In 1830 (beam activation), the UE could receive from the network a (unified) TCI state(s) activation/deactivation MAC CE, which could comprise/indicate/include/contain one or more TCI states/sets of TCI states used to map to one or more TCI codepoints of a TCI field in a beam indication DCI (e.g., DCI format 1_1/1_2 with or without DL assignment).
In 1840 (beam activation), the UE could send to the network a HARQ-ACK for reception/detection of the (unified) TCI state(s) activation/deactivation MAC CE command.
In 1850 (beam activation), the UE could receive and measurement one or more SSBs from the network for downlink synchronization-especially for “unknown” TCI states.
In 1860 (beam indication), the UE could be indicated by the network one or more TCI states/updates of one or more TCI states via one or more TCI codepoints of a TCI field in a beam indication DCI (e.g., DCI format 1_1/1_2 with or without DL assignment).
In 1870 (beam indication), the UE could send to the network a HARQ-ACK for reception/detection of the beam indication DCI.

Here, a TCI state could be a joint DL and UL TCI state provided by TCI-State or DLorJoint-TCIState. or a separate DL TCI state provided by TCI-State or DLorJoint-TCIState, or a separate UL TCI state provided by TCI-State or UL-TCI-State. Furthermore, a target TCI state is a “known” TCI state if it has been meeting the following conditions:
The TCI state update/switch/indication is within x ms of last transmission of resource for beam measurement/reporting for the target TCI state.
The UE has sent at least 1 measurement report for the target TCI state.
The TCI state shall remain detectable during the TCI state indication/switching/updating period. i.e., signal-to-noise ratio (SNR) of the target TCI state is greater than −3 dB.

Otherwise, the target TCI state is an “unknown” TCI state. Here, the value of x could be determined according to: (i) fixed value(s) specified/provided in system specification(s), (ii) network's configuration(s)/indication(s), e.g., via higher layer RRC signaling/parameter and/or MAC CE command and/or dynamic DCI based L1 signaling, and/or (iii) UE's autonomous determination/selection/decision, which could also be sent to the network, e.g., in part of CSI/beam report and/or UE's capability signaling.

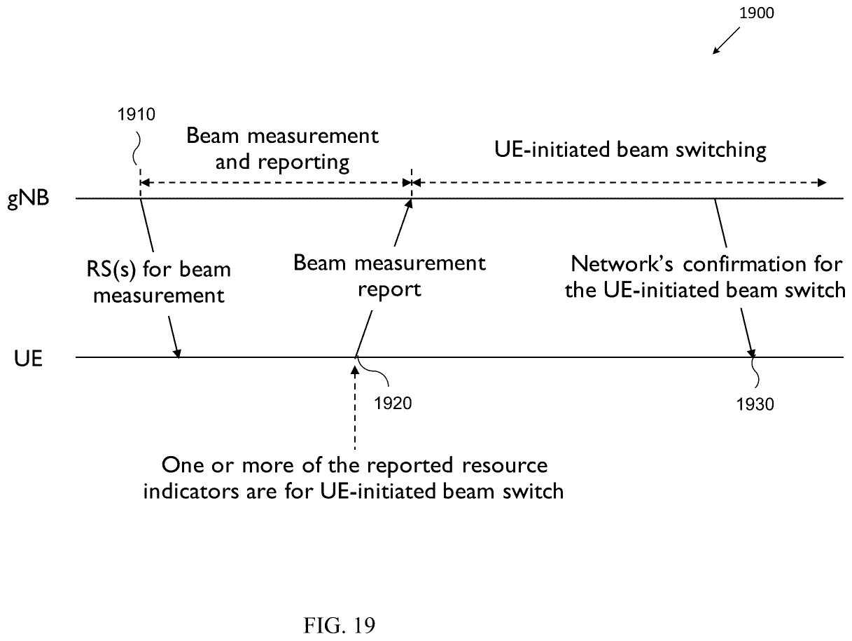

FIG. 19 illustrates a flow diagram 1900 for UE-initiated beam switching according to embodiments of the present disclosure. For example, flow diagram 1900 for UE-initiated beam switching may be followed by the UE 112 and the gNB 102 and/or network 130 in the wireless network 100 of FIG. 1. This example is for illustration only and other embodiments can be used without departing from the scope of the present disclosure.

The flow diagram begins in 1910, the gNB transmits RS(s) for beam measurement to a UE. In 1920, the UE transmits a beam measurement report to the gNB. In various embodiments, one or more of the reported resource indicators are for UE-initiated beam switching. In 1930, the gNB transmits the network's confirmation for the UE-initiated beam switch.

In one embodiment, the UE (e.g., the UE 116) could send to the network (e.g., the network 130) the beam measurement report as specified herein in the present disclosure (e.g., 1820 in the above described design example) as a TCI state(s)/beam(s) switching request—with reference to FIG. 19. In one example, the UE could indicate to the network, e.g., in part of the CSI/beam report, that the beam measurement report is also a TCI state(s)/beam(s) switching request. For example, the UE could send to the network, e.g., in part of the CSI/beam report, a one-bit indicator; when/if the one-bit indicator is set to ‘0’ (or ‘1’), the beam measurement report is only for the beam measurement and reporting as specified herein in the present disclosure; and when/if the one-bit indicator is set to ‘1’ (or ‘0’), the beam measurement report is for the beam measurement/reporting and/or the UE-initiated TCI state(s)/beam(s) switching as specified herein in the present disclosure. In another example, the UE could be indicated/configured/provided by the network, e.g., via higher layer RRC signaling and/or MAC CE command and/or dynamic DCI based L1 signaling, that a beam measurement report could also be a TCI state(s)/beam(s) switching request. For example, the UE could be indicated/configured/provided by the network, e.g., via higher layer RRC signaling(s)/parameter(s) (e.g., in CSI-ResourceConfig and/or CSI-ReportConfig) and/or MAC CE command and/or dynamic DCI based L1 signaling, a one-bit indicator; when/if the one-bit indicator is set to ‘0’ (or ‘1’), the corresponding beam measurement report is only for the beam measurement and reporting as specified herein in the present disclosure; when/if the one-bit indicator is set to ‘1’ (or ‘0’), the beam measurement report is for the beam measurement/reporting and/or the UE-initiated TCI state(s)/beam(s) switching as specified herein in the present disclosure. As specified herein in the present disclosure, when/if a resource indicator (e.g., a SSBRI or a CRI) reported in the beam measurement report is used/applied for TCI state(s)/beam(s) change/update/switch initiated or triggered by the UE.
When/if applicable, the UE could set their (spatial domain) receive filter(s) according to at least the RS corresponding to the reported resource indicator (e.g., the SSBRI or the CRI) to receive one or more DL channels/signals.
When/if applicable, the UE determines their (spatial domain) transmit filter(s) or UL TX (spatial) filter(s), from/according to at least the RS corresponding to the reported resource indicator (e.g., the SSBRI or the CRI), to transmit one or more UL channels/signals.

When/if the beam measurement report also serves as a TCI state(s)/beam(s) switching request initiated/triggered by the UE:
For example, when/if the beam measurement report contains/comprises/includes/indicates only one resource indicator, the resource indicator, and therefore the corresponding RS resource (beam), could be for the UE-initiated TCI state(s)/beam(s) switch/change/update.
For another example, when/if the beam measurement report contains/comprises/includes/indicates more than one resource indicators, one or more of the reported resource indicators, and therefore the corresponding RS resource(s) (beam(s)), could be for the UE-initiated TCI state(s)/beam(s) switch/change/update.
   For example, the position(s) of the one or more of the reported resource indicators for the UE-initiated TCI state(s)/beam(s) switch/change/update in the corresponding beam measurement report could be fixed. For instance, the one or more of the reported resource indicators for the UE-initiated TCI state(s)/beam(s) switch/change/update could correspond to the first Nb≥1 resource indicators reported in the beam measurement report, wherein the value of Nb could be: (i) a fixed value specified/provided in system specification(s), (ii) configured/indicated/provided by the network, e.g., via higher layer RRC signaling/parameter and/or MAC CE command and/or dynamic DCI based L1 signaling, and/or (iii) autonomously determined by the UE, and/or reported to the network, e.g., in part of beam/CSI report and/or UE's capability signaling. Alternatively, the one or more of the reported resource indicators for the UE-initiated TCI state(s)/beam(s) switching/change/update could correspond to the odd-numbered/indexed (or even-numbered/indexed) resource indicators reported in the beam measurement report.
   For another example, the UE could indicate to the network, e.g., in part of the beam/CSI report, the position(s) of the one or more of the reported resource indicators for the UE-initiated TCI state(s)/beam(s) switch/change/update in the corresponding beam measurement report. For instance, the UE could indicate to the network, e.g., in part of the beam/CSI report, a bitmap with each bit position of the bitmap corresponding to a reported resource indicator in the corresponding beam measurement report. When/if a bit position of the bitmap is set to ‘1’ (or ‘0’), the corresponding reported resource indicator in the beam measurement report could be for the UE-initiated TCI state(s)/beam(s) switch/update/change; i.e., the UE could trigger/initiate/request TCI state(s)/beam(s) change/switch/update according to at least the RS resource for/corresponding to the reported resource indicator (the bit position in the bitmap corresponding to the reported resource indicator is set to ‘1’ (or ‘0’)).
   Yet for another example, the UE could be indicated/configured/provided by the network, e.g., via higher layer RRC signaling(s)/parameter(s)—e.g., in CSI-ResourceConfig or CSI-ReportConfig, and/or MAC CE command and/or dynamic DCI based L1 signaling, the position(s) of the one or more of the reported resource indicators for the UE-initiated TCI state(s)/beam(s) switch/change/update in the corresponding beam measurement report. For instance, the UE could be indicated/configured/provided by the network, e.g., via higher layer RRC signaling(s)/parameter(s)—e.g., in CSI-ResourceConfig or CSI-ReportConfig, and/or MAC CE command and/or dynamic DCI based L1 signaling, a bitmap with each bit position of the bitmap corresponding to a (reported) resource indicator in the corresponding beam measurement report. When/if a bit position of the bitmap is set to ‘1’ (or ‘0’), the corresponding (reported) resource indicator in the beam measurement report could be for the UE-initiated TCI state(s)/beam(s) switch/update/change; i.e., the UE could trigger/initiate/request TCI state(s)/beam(s) change/switch/update according to at least the RS resource for/corresponding to the reported resource indicator (the bit position in the bitmap corresponding to the reported resource indicator is set to ‘1’ (or ‘0’)).

The UE could also indicate to the network, e.g., in part of the CSI/beam report, priority order(s) of the one or more of the reported resource indicators for the UE-initiated TCI state(s)/beam(s) switch/update/change. For example, the priority order of the one or more of the reported resource indicators for the UE-initiated TCI state(s)/beam(s) switch/update/change is from high to low according to their corresponding beam metrics sorted from high to low. For another example, the priority order of the one or more of the reported resource indicators for the UE-initiated TCI state(s)/beam(s) switch/update/change is from high to low according to their positions in the beam measurement report, e.g., from the first to the last or vice versa.

Furthermore, when/if the beam measurement report also serves as a TCI state(s)/beam(s) switching request initiated/triggered by the UE, the UE could also expect to receive from the network a confirmation message/indication/configuration, e.g., an ACK, for the beam measurement report (and therefore, the UE-initiated/triggered TCI state(s)/beam(s) change/switch/update). As specified herein in the present disclosure, the UE could use/apply the UE-initiated/triggered TCI state(s)/beam(s) change/update/switch for one or more channels/signals X duration/offset/time (e.g., X symbols/slots/etc.) starting from the reception of the network's confirmation message/indication/configuration (e.g., the ACK) for the beam measurement report. As specified herein in the present disclosure, the value of X could be (i) fixed in the system specification(s), (ii) configured/indicated/provided by the network, e.g., via higher layer RRC signaling/parameter and/or MAC CE command and/or dynamic DCI based L1 signaling, and/or (iii) autonomously determined by the UE and reported to the network, e.g., in part of the corresponding beam/CSI report and/or UE's capability reporting. When/if the beam measurement report also serves as a TCI state(s)/beam(s) switching request initiated/triggered by the UE according to those specified herein in the present disclosure:
For example, when/if the beam measurement report contains/comprises/includes/indicates only one resource indicator, the resource indicator, and therefore the corresponding RS resource (beam), could be for the UE-initiated TCI state(s)/beam(s) switch/change/update. For this case, the network's confirmation message/indication/configuration (e.g., an ACK) could only be for the reported resource indicator, and therefore the corresponding RS resource (beam) for the UE-initiated TCI state(s)/beam(s) switch/change/update.
For another example, as specified herein in the present disclosure, one or more of the resource indicators-denoted by first resource indicator(s) here-reported in the beam measurement report could be used/applied for TCI state(s)/beam(s) change/switch/update initiated or triggered by the UE, wherein the first resource indicator(s) could be determined according to fixed rule(s) in system specifications, network's configuration(s)/indication(s) via RRC and/or MAC CE and/or DCI, and/or autonomously by the UE themselves. For this case:
   In one example, the network's confirmation message/indication/configuration (e.g., an ACK) could be for all the reported first resource indicator(s), and therefore the RS resource(s) (beam(s)) corresponding to the reported first resource indicator(s).
   In another example, the network's confirmation message/indication/configuration (e.g., an ACK) could be for one or more of the reported first resource indicator(s)—denoted by second resource indicator(s) here, and therefore one or more of the RS resource(s) (beam(s)) corresponding to the reported first resource indicator(s).
      For example, the position(s) of the second resource indicator(s) within the first resource indicator(s) reported for the UE-initiated TCI state(s)/beam(s) switching/update/change could be fixed. For instance, the second resource indicator(s) could correspond to the first Mb≥1 resource indicator(s) of the first resource indicator(s), wherein the value of Mb could be: (i) a fixed value specified/provided in system specification(s), (ii) configured/indicated/provided by the network. e.g., via higher layer RRC signaling/parameter and/or MAC CE command and/or dynamic DCI based L1 signaling, and/or (iii) autonomously determined by the UE, and/or reported to the network, e.g., in part of beam/CSI report and/or UE's capability signaling. Alternatively, the second resource indicator(s) could correspond to the odd-numbered/indexed (or even-numbered/indexed) resource indicators of the first resource indicator(s).
      For another example, the UE could indicate to the network, e.g., in part of the beam/CSI report, the position(s) of the second resource indicator(s) within the first resource indicator(s) reported for the UE-initiated TCI state(s)/beam(s) switch/change/update. For instance, the UE could indicate to the network, e.g., in part of the beam/CSI report, a bitmap with each bit position of the bitmap corresponding to a reported first resource indicator in the corresponding beam measurement report. When/if a bit position of the bitmap is set to ‘1’ (or ‘0’), the corresponding reported first resource indicator in the beam measurement report could be a second resource indicator.
      Yet for another example, the UE could be indicated/configured/provided by the network, e.g., via higher layer RRC signaling(s)/parameter(s)—e.g., in CSI-ResourceConfig or CSI-ReportConfig. and/or MAC CE command and/or dynamic DCI based L1 signaling and/or the confirmation message/configuration/indication, the position(s) of the second resource indicator(s) within the first resource indicator(s) reported for the UE-initiated TCI state(s)/beam(s) switch/change/update. For instance, the UE could be indicated/configured/provided by the network, e.g., via higher layer RRC signaling(s)/parameter(s)—e.g., in CSI-ResourceConfig or CSI-ReportConfig, and/or MAC CE command and/or dynamic DCI based L1 signaling and/or the confirmation message/indication/configuration, a bitmap with each bit position of the bitmap corresponding to a reported first resource indicator in the corresponding beam measurement report. When/if a bit position of the bitmap is set to ‘1’ (or ‘0’), the corresponding reported resource indicator in the beam measurement report could be a second resource indicator.

For this design example, upon/after receiving or detecting the network's confirmation message/indication/configuration (e.g., an ACK) for the UE-initiated TCI state(s)/beam(s) switching/update/change, the UE could set their (spatial domain) receive filter(s) according to the RS resource(s) (beam(s)) corresponding to the (confirmed) second resource indicator(s) (e.g., the SSBRI(s)/CRI(s)) to receive one or more DL channels/signals and/or the UE could set their (spatial domain) transmit filter(s) or UL TX (spatial) filter(s) from/according to the RS resource(s) (beam(s) corresponding to the (confirmed) second resource indicator(s) (e.g., the SSBRI(s)/CRI(s)) to transmit one or more UL channels/signals.

In the present disclosure, the UE could be indicated/configured/provided by the network, e.g., via higher layer RRC signaling(s)/parameter(s) (e.g., in CSI-ResourceConfig and/or CSI-ReportConfig) and/or MAC CE command and/or dynamic DCI based L1 signaling and/or the network's confirmation message/indication/configuration, whether the network's confirmation message/indication/configuration (e.g., an ACK) is for all the reported first resource indicator(s)—and therefore the RS resource(s) (or beam(s)) corresponding to the reported first resource indicator(s) or one or more of the reported first resource indicator(s)—and therefore the RS resource(s) (or beam(s)) corresponding to the second resource indicator(s) as specified herein in the present disclosure. For instance, the UE could be indicated/configured/provided by the network. e.g., via higher layer RRC signaling(s)/parameter(s) (e.g., in CSI-ResourceConfig and/or CSI-ReportConfig) and/or MAC CE command and/or dynamic DCI based L1 signaling and/or the network's confirmation message/indication/configuration, a one-bit indicator; when/if the one-bit indicator is set to ‘0’ (or ‘1’), the network's confirmation message/indication/configuration (e.g., an ACK) is for all the reported first resource indicator(s)—and therefore the RS resource(s) (or beam(s)) corresponding to the reported first resource indicator(s). When/if the one-bit indicator is set to ‘1’ (or ‘0’), the network's confirmation message/indication/configuration (e.g., an ACK) is for one or more of the reported first resource indicator(s)—and therefore the RS resource(s) (or beam(s)) corresponding to the second resource indicator(s) as specified herein in the present disclosure.
Yet for another example, the network's confirmation message/indication/configuration (e.g., an ACK) could (also/additionally) be for the priority order(s) of the one or more of the reported resource indicators for the UE-initiated TCI state(s)/beam(s) switch/update/change, wherein the priority order(s) could be reported by the UE to the network, e.g., in part of the beam/CSI report and/or UE's capability signaling, according to those specified herein in the present disclosure. Or the network's confirmation message/indication/configuration could contain/provide/indicate/comprise/include two parts/stages (or two ACKs); the first part/stage (or the first ACK) could be for the resource indicator(s)—and therefore, the corresponding RS resource(s)/beam(s)—reported in the beam measurement report for the UE-initiated TCI state(s)/beam(s) change/update/switch. The second part/stage (or the second ACK) could be for other information, such as the priority order(s) of the resource indicator(s) reported in the beam measurement report as the TCI state(s)/beam(s) change/update/switch initiated or triggered by the UE, related to the UE-initiated TCI state(s)/beam(s) switching/update/change. Furthermore, the network's confirmation message/indication/configuration could (also/additionally) contain/provide/indicate/comprise/include priority order(s) of the one or more of the reported resource indicators for the UE-initiated TCI state(s)/beam(s) switch/update/change. For example, the priority order of the one or more of the reported resource indicators for the UE-initiated TCI state(s)/beam(s) switch/update/change is from high to low according to their corresponding beam metrics sorted from high to low. For another example, the priority order of the one or more of the reported resource indicators for the UE-initiated TCI state(s)/beam(s) switch/update/change is from high to low according to their positions in the beam measurement report, e.g., from the first to the last or vice versa.

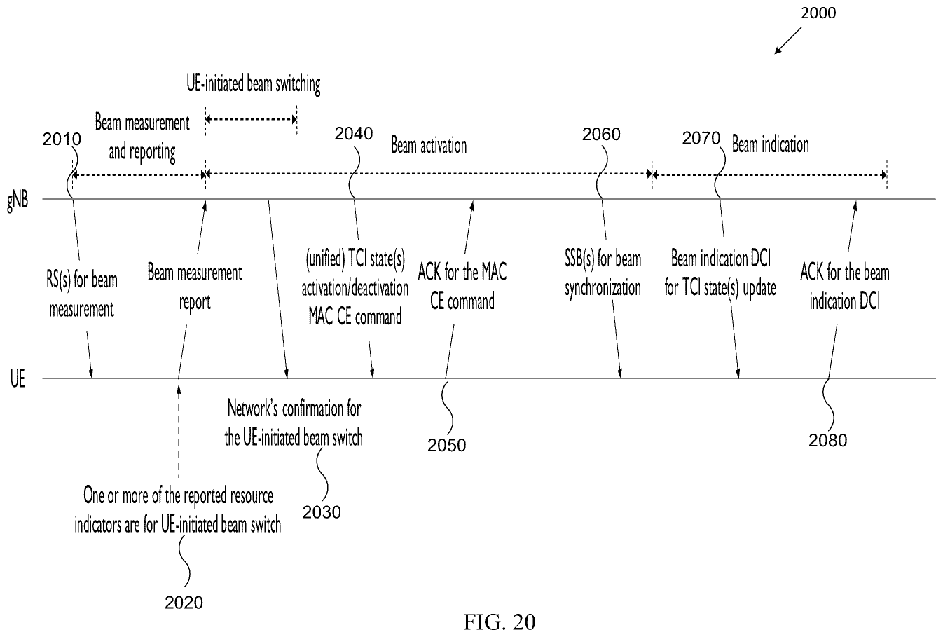

FIG. 20 illustrates a flow diagram 2000 for UE-initiated beam switching according to embodiments of the present disclosure. For example, flow diagram 2000 for UE-initiated beam switching may be followed by the UE 113 and the gNB 102 and/or network 130 in the wireless network 100 of FIG. 1. This example is for illustration only and other embodiments can be used without departing from the scope of the present disclosure.

The flow diagram begins in 2010, the gNB sends RS(s) for beam measurement to a UE. In 2020 the UE transmits a beam measurement report to the gNB. In various embodiments, one or more of the reported resource indicators are for UE-initiated beam switching. In 2030, the gNB transmits a network confirmation for the UE-initiated beam switch. In 2040, the gNB transmits (unified) TCI state(s) activation/deactivation MAC CE command. In 2050, the UE transmits an ACK for the MAC CE command to the gNB. In 2060, the gNB transmits SSB(s) for beam synchronization to the UE. In 2070, the gNB transmits beam indication DCI for TCI state(s) update to the UE. In 2080, the UE transmits an ACK for the beam indication DCI to the gNB.

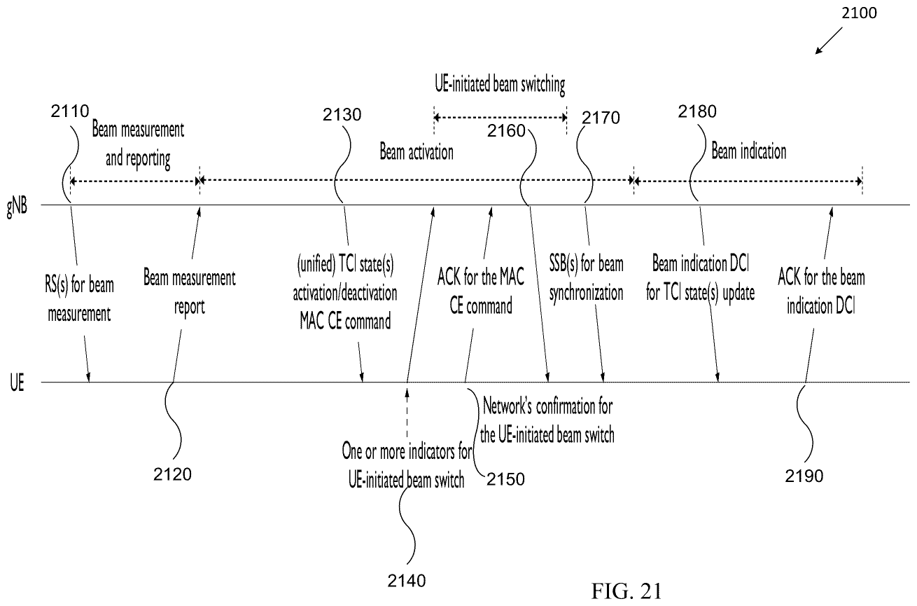

FIG. 21 illustrates a flow diagram 2100 for UE-initiated beam switching according to embodiments of the present disclosure. For example, flow diagram 2100 for UE-initiated beam switching may be followed by the UE 114 and the gNB 102 and/or network 130 in the wireless network 100 of FIG. 1. This example is for illustration only and other embodiments can be used without departing from the scope of the present disclosure.

The flow diagram begins in 2110, the gNB sends RS(s) for beam measurement to a UE. In 2120, the UE transmits a beam measurement report to the gNB. In 2130, the gNB transmits (unified) TCI state(s) activation/deactivation MAC CE command. In 2140, the UE transmits one or more indicators for UE-initiated beam switch to the gNB. In 2150, the UE transmits an ACK for the MAC CE command to the gNB. In 2160, the gNB transmits the network's confirmation for the UE-initiated beam switch. In 2170, the gNB transmits SSB(s) for beam synchronization to the UE. In 2180, the gNB transmits beam indication DCI for TCI state(s) update to the UE. In 2190, the UE transmits an ACK for the beam indication DCI to the gNB.

When/if the beam measurement report is also used for initiating or triggering TCI state(s)/beam(s) change/update switch (i.e., the UE-initiated TCI state(s)/beam(s) change/switch/update) as specified herein in the present disclosure, the beam activation procedures/process (e.g., 1830, 1840 and 1850 as illustrated in FIG. 18) and/or the beam indication procedures/process (e.g., 1860 and 1870 as illustrated in FIG. 18) could be omitted. That is, when/if a UE triggers or initiates TCI state(s)/beam(s) change/update/switch, e.g., via the beam measurement report and/or one or more indicators as specified herein in the present disclosure, the UE is not expected to receive the (unified) TCI state(s) activation/deactivation MAC CE for the beam activation (e.g., 1830, 1840 and 1850 as illustrated in FIG. 18) and/or the beam indication DCI for the beam indication (e.g., 1860 and 1870 as illustrated in FIG. 18). Alternatively, with reference to FIG. 20, when/if a UE triggers or initiates TCI state(s)/beam(s) change/update/switch, e.g., via the beam measurement report as specified herein in the present disclosure, the UE could also be able to or is allowed/expected to receive the (unified) TCI state(s) activation/deactivation MAC CE for the beam activation (e.g., 1830, 1840 and 1850 as illustrated in FIG. 18) and/or the beam indication DCI for the beam indication (e.g., 1860 and 1870 as illustrated in FIG. 18). Optionally, with reference to FIG. 21, when/if a UE triggers or initiates TCI state(s)/beam(s) change/update/switch, e.g., via the one or more indicators as specified herein in the present disclosure, the UE could also be able to or is allowed/expected to receive the (unified) TCI state(s) activation/deactivation MAC CE for the beam activation (e.g., 1830, 1840 and 1850 as illustrated in FIG. 18) and/or the beam indication DCI for the beam indication (e.g., 1860 and 1870 as illustrated in FIG. 18).

The UE could be indicated/configured/provided by the network, e.g., via higher layer RRC signaling/parameter and/or MAC CE command and/or dynamic DCI based L1 signaling, the network's confirmation message/indication/configuration as specified herein in the present disclosure for the beam measurement report—used/applied for the UE-initiated beam switching. For instance. The UE could be indicated/configured/provided by the network, e.g., via higher layer RRC signaling/parameter and/or MAC CE command and/or dynamic DCI based L1 signaling, a one-bit indicator to indicate the network's confirmation message/indication/configuration for the beam measurement report specified herein in the present disclosure for the UE-initiated beam switching; when/if the one-bit indicator is set to ‘1’ (or ‘0’), the one-bit indicator could indicate an ACK of the network's confirmation message/indication/configuration for the beam measurement report sent by the UE for the UE-initiated TCI state(s)/beam(s) switching/update/change; when/if the one-bit indicator is not present/configured or is set to ‘0’ (or ‘1’), the one-bit indicator could indicate a NACK of the network's confirmation message/configuration/indication for the beam measurement report sent by the UE for the UE-initiated TCI state(s)/beam(s) switching/update/change. Furthermore, when/if provided/indicated in a DCI, the network's confirmation message/indication/configuration (e.g., an ACK)—e.g., the one-bit indicator as described herein—for the beam measurement report sent by the UE for the UE-initiated TCI state(s)/beam(s) switching/update/change could be indicated/provided via one or more new/dedicated DCI fields—e.g., denoted by ‘ACK/NACK for UE-initiated beam switching’ field(s)—in the DCI. Alternatively, when/if provided/indicated in a DCI, the network's confirmation message/indication/configuration (e.g., an ACK)—e.g., the one-bit indicator as described herein—for the beam measurement report sent by the UE for the UE-initiated TCI state(s)/beam(s) switching/update/change could be indicated/provided via/by repurposing one or more bits of one or more existing DCI fields in the DCI. For instance, the ‘New Data Indicator’ (NDI) field in a DCI could be repurposed/used to indicate the network's confirmation message/indication/configuration for the beam measurement report sent by the UE for the UE-initiated TCI state(s)/beam(s) switching/update/change; when/if the NDI field is toggled or is set to ‘1’ (or ‘0’), the NDI could indicate an ACK of the network's confirmation message/indication/configuration for the beam measurement report sent by the UE for the UE-initiated TCI state(s)/beam(s) switching/update/change; otherwise, the NDI could indicate a NACK of the network's confirmation message/indication/configuration for the beam measurement report sent by the UE for the UE-initiated TCI state(s)/beam(s) switching/update/change.

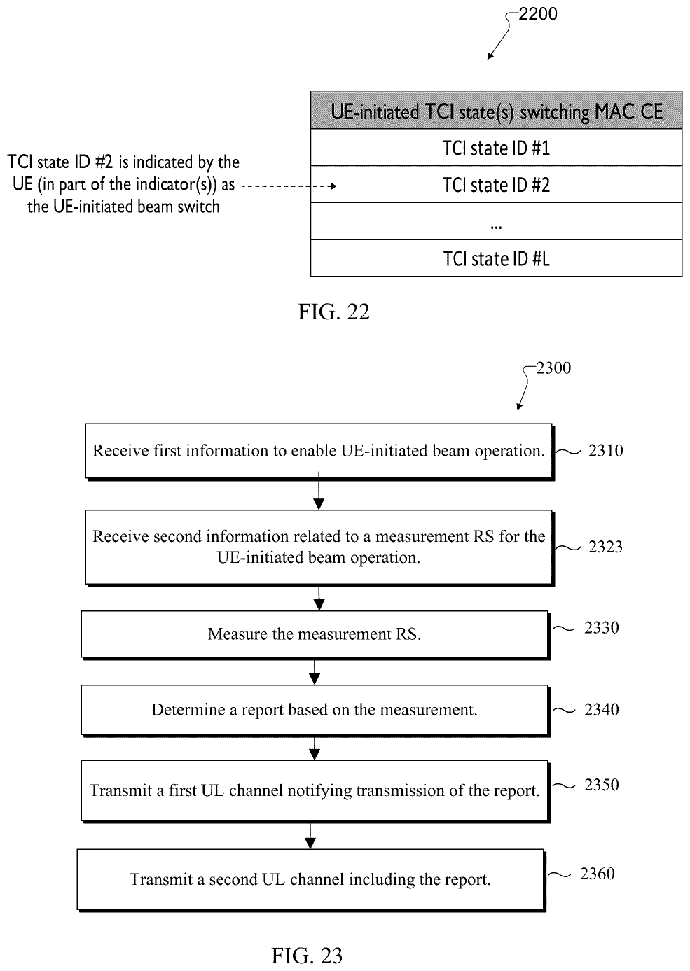

FIG. 22 illustrates an example UE-initiated TCI state(s) switching activation/deactivation MAC CE command 2200 according to embodiments of the present disclosure. For example, UE-initiated TCI state(s) switching activation/deactivation MAC CE command 2200 may be referenced by any of the UEs 111-116 of FIG. 1, such as the UE 111. This example is for illustration only and other embodiments can be used without departing from the scope of the present disclosure.

In one embodiment, as specified herein in the present disclosure, a UE could trigger or initiate TCI state(s)/beam(s) change/update/switch, e.g., via sending the beam measurement report (e.g., one or more of the resource indicators reported therein are for the TCI state(s)/beam(s) change/update/switch as specified herein in the present disclosure) and/or the one or more indicators as specified herein in the present disclosure, for one or more DL/UL channels/signals. The TCI state(s)/beam(s) indicated/sent/provided by the UE to the network (e.g., the network 130)—for the TCI state(s)/beam(s) update/change/switching initiated/triggered by the UE-could be from one or more TCI states activated/provided/indicated in a MAC CE command.
In one example, the MAC CE command could be a dedicated MAC CE command for the UE-initiated TCI state(s)/beam(s) switching/update/change-denoted by UE-initiated TCI state(s) switching activation/deactivation MAC CE command. The UE-initiated TCI state(s) switching activation/deactivation MAC CE as specified herein in the present disclosure could contain/include/provide/comprise/activate/indicate one or more TCI states and/or one or more sets of TCI states. For this design example, the TCI state(s)/beam(s) indicated/sent/provided by the UE to the network—for the TCI state(s)/beam(s) update/change/switching initiated/triggered by the UE—could be from one or more of the TCI states—denoted by active/candidate TCI state(s) for UE-initiated beam switching—activated/provided/indicated in the UE-initiated TCI state(s) switching activation/deactivation MAC CE command. The UE could be indicated/provided/configured by the network, e.g., via higher layer RRC signaling/parameter and/or MAC CE command and/or dynamic DCI based L1 signaling, the active/candidate TCI state(s) for UE-initiated beam switching from the TCI states activated/provided/indicated in the UE-initiated TCI state(s) switching activation/deactivation MAC CE command.
   For example, the UE could be provided/indicated/configured by the network, e.g., via higher layer RRC signaling/parameter and/or MAC CE command (e.g., the same UE-initiated TCI state(s) switching activation/deactivation MAC CE command) and/or dynamic DCI based L1 signaling, a bitmap with each bit position of the bitmap corresponding to a TCI state/set of TCI states activated/provided/indicated in/by the UE-initiated TCI state(s) switching activation/deactivation MAC CE command. When/if a bit position of the bitmap is set to ‘1’ (or ‘0’), the corresponding TCI state/set of TCI states activated/provided/indicated in/by the UE-initiated TCI state(s) switching activation/deactivation MAC CE command could correspond to an active/candidate TCI state/set of TCI states for UE-initiated beam switching.
   For another example, each of the TCI states/sets of TCI states activated/provided/indicated in/by the UE-initiated TCI state(s) switching activation/deactivation MAC CE command could be associated with an (one-bit) indicator, wherein the (one-bit) indicator(s) could also be provided/indicated in the same UE-initiated TCI state(s) switching activation/deactivation MAC CE command. When/if an (one-bit) indicator associated to a TCI state/set of TCI states in the UE-initiated TCI state(s) switching activation/deactivation MAC CE is set to ‘1’ (or ‘0’), the corresponding TCI state/set of TCI states could correspond to an active/candidate TCI state/set of TCI states for UE-initiated beam switching.
   Yet for another example, the UE-initiated TCI state(s) switching activation/deactivation MAC CE command could provide/indicate one or more indicators each associated/corresponding to a TCI state/set of TCI states activated/provided/indicated in/by the UE-initiated TCI state(s) switching activation/deactivation MAC CE command. When/if a TCI state/set of TCI states activated/provided/indicated in/by the UE-initiated TCI state(s) switching activation/deactivation MAC CE command is associated/configured/indicated with an indicator and/or the indicator is set to a valid value (e.g., ‘1’), the TCI state/set of TCI states could correspond to an active/candidate TCI state/set of TCI states for UE-initiated beam switching.
   Yet for another example, the UE could be provided/indicated/configured by the network, e.g., via higher layer RRC signaling/parameter and/or MAC CE command (e.g., the same UE-initiated TCI state(s) switching activation/deactivation MAC CE command) and/or dynamic DCI based L1 signaling, index(es)/ID(s) of the active/candidate TCI state(s)/set(s) of TCI states for UE-initiated beam switching in the UE-initiated TCI state(s) switching activation/deactivation MAC CE command and/or position(s)/ordering(s) of the active/candidate TCI state(s)/set(s) of TCI states for UE-initiated beam switching among all the TCI states/sets of TCI states activated/provided/indicated by the UE-initiated TCI state(s) switching activation/deactivation MAC CE command.
   Yet for another example, the active/candidate TCI state(s) for UE-initiated beam switching could correspond to all of the “known” TCI states activated/indicated/provided in/by the UE-initiated TCI state(s) switching activation/deactivation MAC CE command.
   Yet for another example, the active/candidate TCI state(s) for UE-initiated beam switching could correspond to one or more of the “known” TCI states activated/indicated/provided in/by the UE-initiated TCI state(s) switching activation/deactivation MAC CE. The UE could be indicated/provided/configured by the network, e.g., via higher layer RRC signaling(s)/parameter(s) and/or MAC CE command and/or dynamic DCI based L1 signaling, which one or more of the “known” TCI states activated/indicated/provided in/by the UE-initiated TCI state(s) switching activation/deactivation MAC CE command could correspond to the active/candidate TCI state(s) for UE-initiated beam switching. For instance, the UE could be indicated/provided/configured by the network, e.g., via higher layer RRC signaling(s)/parameter(s) and/or MAC CE command and/or dynamic DCI based L1 signaling, a bitmap with each bit position of the bitmap corresponding to a “known” TCI state activated/indicated/provided in/by the UE-initiated TCI state(s) switching activation/deactivation MAC CE command. When/if a bit position of the bitmap is set to ‘1’ (or ‘0’), the “known” TCI state activated/indicated/provided in/by the UE-initiated TCI state(s) switching activation/deactivation MAC CE command corresponding/associated to the bit position could correspond to an active/candidate TCI state for UE-initiated beam switching.

The UE (e.g., the UE 116) could indicate/send to the network, e.g., via/in part of the one or more indicators as specified herein in the present disclosure, one or more of the TCI states activated/indicated/provided by/in the UE-initiated TCI state(s) switching activation/deactivation MAC CE command and/or one or more of the active/candidate TCI states for the UE-initiated TCI state(s)/beam(s) switching/update/change.
For example, the UE could send/indicate/provide to the network, e.g., by/in part of the one or more indicators for the UE-initiated TCI state(s)/beam(s) switching/update/change as specified herein in the present disclosure, index(es)/ID(s) of the TCI state(s)—for the UE-initiated/triggered TCI state(s)/beam(s) switching/change/update—from the active/candidate TCI states for the UE-initiated TCI state(s)/beam(s) switching/update/change as specified herein in the present disclosure and/or in/from the UE-initiated TCI state(s) switching activation/deactivation MAC CE command. With reference to FIG. 22, an example of the UE-initiated TCI state(s) switching activation/deactivation MAC CE is shown. Alternatively, the UE could send/indicate/provide to the network, e.g., by/in part of the one or more indicators for the UE-initiated TCI state(s)/beam(s) switching/update/change as specified herein in the present disclosure, a bitmap with each bit position of the bitmap corresponding to a TCI state/TCI state ID in/from the activate/candidate TCI states for the UE-initiated TCI state(s)/beam(s) switch/update/change as specified herein in the present disclosure or a TCI state/TCI state ID provided/indicated/activated in/by the UE-initiated TCI state(s) switching activation/deactivation MAC CE command. When/if a bit position of the bitmap is set to ‘1’ (or ‘0’), the TCI state/TCI state ID in/from the activate/candidate TCI states for the UE-initiated TCI state(s)/beam(s) switch/update/change as specified herein in the present disclosure or the TCI state/TCI state ID provided/indicated/activated in/by the UE-initiated TCI state(s) switching activation/deactivation MAC CE command corresponding to the bit position could correspond to a TCI state/beam indicated by the UE for the UE-initiated beam switching.
For another example, the UE could send/indicate/provide to the network, e.g., by/in part of the one or more indicators for the UE-initiated TCI state(s)/beam(s) switching/update/change as specified herein in the present disclosure, index(es)/ID(s) of the set(s) of TCI state(s) from the active/candidate sets of TCI states for the UE-initiated TCI state(s)/beam(s) switching/update/change as specified herein in the present disclosure and/or in/from the UE-initiated TCI state(s) switching activation/deactivation MAC CE command, wherein the set(s) of TCI state(s) could comprise/indicate/provide/contain/include the TCI state(s) for the UE-initiated/triggered TCI state(s)/beam(s) switching/change/update. Alternatively, the UE could send/indicate/provide to the network, e.g., by/in part of the one or more indicators for the UE-initiated TCI state(s)/beam(s) switching/update/change as specified herein in the present disclosure, a bitmap with each bit position of the bitmap corresponding to a set of TCI states/TCI state IDs from the active/candidate sets of TCI states for the UE-initiated TCI state(s)/beam(s) switching/update/change as specified herein in the present disclosure or a set of TCI states/TCI state IDs provided/indicated/activated in/by the UE-initiated TCI state(s) switching activation/deactivation MAC CE command. When/if a bit position of the bitmap is set to ‘1’ (or ‘0’), the set of TCI states/TCI state IDs from the active/candidate sets of TCI states for the UE-initiated TCI state(s)/beam(s) switching/update/change as specified herein in the present disclosure or the set of TCI states/TCI state IDs provided/indicated/activated in/by the UE-initiated TCI state(s) switching activation/deactivation MAC CE command corresponding to the bit position could comprise/indicate/provide/contain/include the TCI state(s)/beam(s) for the UE-initiated beam switching.
Yet for another example, the UE could send/indicate/provide to the network, e.g., by/in part of the one or more indicators for the UE-initiated TCI state(s)/beam(s) switching/update/change as specified herein in the present disclosure, index(s)/ID(s) of or information related to UE-initiated TCI state(s) switching activation/deactivation MAC CE command(s), wherein the UE-initiated TCI state(s) switching activation/deactivation MAC CE command(s) could comprise/indicate/provide/contain/include/activate the TCI state(s) for the UE-initiated/triggered TCI state(s)/beam(s) switching/change/update. Alternatively, the UE could send/indicate/provide to the network, e.g., by/in part of the one or more indicators for the UE-initiated TCI state(s)/beam(s) switching/update/change as specified herein in the present disclosure, a bitmap with each bit position of the bitmap corresponding to a UE-initiated TCI state(s) switching activation/deactivation MAC CE command. When/if a bit position of the bitmap is set to ‘1’ (or ‘0’), the UE-initiated TCI state(s) switching activation/deactivation MAC CE command corresponding to the bit position could comprise/indicate/provide/contain/include the TCI state(s)/beam(s) for the UE-initiated beam switching.
In another example, the MAC CE command could correspond to the (unified) TCI state(s) activation/deactivation MAC CE command, which could activate/comprise/indicate/include/contain one or more TCI states/sets of TCI states used to map to one or more TCI codepoints of a TCI field in a beam indication DCI (e.g., DCI format 1_1/1_2 with or without DL assignment). Here, the MAC CE command could be the (unified) TCI state(s) activation/deactivation MAC CE when/if, e.g., the number of TCI states/sets of TCI states—activated/provided/indicated by/in the (unified) TCI state(s) activation/deactivation MAC CE—used to map to the TCI codepoint(s) of a TCI field in the beam indication DCI is greater than (or less than) a threshold/value, wherein the threshold/value could be: (i) fixed in system specifications (e.g., 4). (ii) configured/indicated/provided by the network, e.g., via higher layer RRC signaling/parameter and/or MAC CE command and/or dynamic DCI based L1 signaling, and/or (iii) autonomously determined/selected by the UE and/or reported to the network, e.g., via/in part of beam/CSI report and/or UE's capability signaling. For this design example, the TCI state(s)/beam(s) indicated/sent/provided by the UE to the network—for the TCI state(s)/beam(s) update/change/switching initiated/triggered by the UE—could be from one or more of the TCI states—denoted by active/candidate TCI state(s) for UE-initiated beam switching—activated/provided/indicated in the (unified) TCI state(s) activation/deactivation MAC CE command. The UE could be indicated/provided/configured by the network, e.g., via higher layer RRC signaling/parameter and/or MAC CE command and/or dynamic DCI based L1 signaling, the active/candidate TCI state(s) for UE-initiated beam switching from the TCI states activated/provided/indicated in the (unified) TCI state(s) activation/deactivation MAC CE command.
   For example, the UE could be provided/indicated/configured by the network, e.g., via higher layer RRC signaling/parameter and/or MAC CE command (e.g., the same (unified) TCI state(s) activation/deactivation MAC CE command) and/or dynamic DCI based L1 signaling, a bitmap with each bit position of the bitmap corresponding to a TCI state/set of TCI states activated/provided/indicated in/by the (unified) TCI state(s) activation/deactivation MAC CE command, wherein the TCI state/set of TCI states could be mapped to a TCI codepoint of the TCI field in a beam indication DCI. When/if a bit position of the bitmap is set to ‘1’ (or ‘0’), the corresponding TCI state/set of TCI states activated/provided/indicated in/by the (unified) TCI state(s) activation/deactivation MAC CE command could correspond to an active/candidate TCI state/set of TCI states for UE-initiated beam switching.
   For another example, each of the TCI states/sets of TCI states activated/provided/indicated in/by the (unified) TCI state(s) activation/deactivation MAC CE command could be associated with an (one-bit) indicator, wherein the (one-bit) indicator(s) could also be provided/indicated in the same (unified) TCI state(s) activation/deactivation MAC CE command and each of the TCI states/sets of TCI states activated/provided/indicated in/by the (unified) TCI state(s) activation/deactivation MAC CE command could be mapped to a TCI codepoint of the TCI field in a beam indication DCI. When/if an (one-bit) indicator associated to a TCI state/set of TCI states in the (unified) TCI state(s) activation/deactivation MAC CE is set to ‘1’ (or ‘0’), the corresponding TCI state/set of TCI states could correspond to an active/candidate TCI state/set of TCI states for UE-initiated beam switching.
   Yet for another example, the (unified) TCI state(s) activation/deactivation MAC CE command could provide/indicate one or more indicators each associated/corresponding to a TCI state/set of TCI states activated/provided/indicated in/by the (unified) TCI state(s) activation/deactivation MAC CE command, wherein a TCI state/set of TCI states activated/provided/indicated in/by the (unified) TCI state(s) activation/deactivation MAC CE command could be mapped to a TCI codepoint of the TCI field in a beam indication DCI. When/if a TCI state/set of TCI states activated/provided/indicated in/by the (unified) TCI state(s) activation/deactivation MAC CE command is associated/configured/indicated with an indicator and/or the indicator is set to a valid value (e.g., ‘1’), the TCI state/set of TCI states could correspond to an active/candidate TCI state/set of TCI states for UE-initiated beam switching.
   Yet for another example, the UE could be provided/indicated/configured by the network, e.g., via higher layer RRC signaling/parameter and/or MAC CE command (e.g., the same (unified) TCI state(s) activation/deactivation MAC CE command) and/or dynamic DCI based L1 signaling, index(es)/ID(s) of the active/candidate TCI state(s)/set(s) of TCI states for UE-initiated beam switching in the (unified) TCI state(s) activation/deactivation MAC CE command, and/or position(s)/ordering(s) of the active/candidate TCI state(s)/set(s) of TCI states for UE-initiated beam switching among all the TCI states/sets of TCI states activated/provided/indicated by the (unified) TCI state(s) activation/deactivation MAC CE command, and/or index(es)/ID(s) of the TCI codepoint(s) activated/provided/indicated in/by the (unified) TCI state(s) activation/deactivation MAC CE command that comprises/provides/contains/includes/indicates the active/candidate TCI state(s)/set(s) of TCI states for UE-initiated beam switching, and/or position(s)/ordering(s) of the TCI codepoint(s), among all the TCI codepoints activated/provided/indicated in/by the (unified) TCI state(s) activation/deactivation MAC CE command, that comprises/provides/contains/includes/indicates the active/candidate TCI state(s)/set(s) of TCI states for UE-initiated beam switching.
   Yet for another example, the active/candidate TCI state(s) for UE-initiated beam switching could correspond to all of the “known” TCI states activated/indicated/provided in/by the (unified) TCI state(s) activation/deactivation MAC CE command.
   Yet for another example, the active/candidate TCI state(s) for UE-initiated beam switching could correspond to one or more of the “known” TCI states activated/indicated/provided in/by the (unified) TCI state(s) activation/deactivation MAC CE. The UE could be indicated/provided/configured by the network, e.g., via higher layer RRC signaling(s)/parameter(s) and/or MAC CE command and/or dynamic DCI based L1 signaling, which one or more of the “known” TCI states activated/indicated/provided in/by the (unified) TCI state(s) activation/deactivation MAC CE command could correspond to the active/candidate TCI state(s) for UE-initiated beam switching. For instance, the UE could be indicated/provided/configured by the network, e.g., via higher layer RRC signaling(s)/parameter(s) and/or MAC CE command and/or dynamic DCI based L1 signaling, a bitmap with each bit position of the bitmap corresponding to a “known” TCI state activated/indicated/provided in/by the (unified) TCI state(s) activation/deactivation MAC CE command. When/if a bit position of the bitmap is set to ‘1’ (or ‘0’), the “known” TCI state activated/indicated/provided in/by the (unified) TCI state(s) activation/deactivation MAC CE command corresponding/associated to the bit position could correspond to an active/candidate TCI state for UE-initiated beam switching.

The UE could indicate/send to the network, e.g., via/in part of the one or more indicators as specified herein in the present disclosure, one or more of the TCI states activated/indicated/provided by/in the (unified) TCI state(s) activation/deactivation MAC CE command and/or one or more of the active/candidate TCI states for the UE-initiated TCI state(s)/beam(s) switching/update/change.
For example, the UE could send/indicate/provide to the network, e.g., by/in part of the one or more indicators for the UE-initiated TCI state(s)/beam(s) switching/update/change as specified herein in the present disclosure, index(es)/ID(s) of the TCI state(s)—for the UE-initiated/triggered TCI state(s)/beam(s) switching/change/update—from the active/candidate TCI states for the UE-initiated TCI state(s)/beam(s) switching/update/change as specified herein in the present disclosure and/or in/from the (unified) TCI state(s) activation/deactivation MAC CE command. Alternatively, the UE could send/indicate/provide to the network, e.g., by/in part of the one or more indicators for the UE-initiated TCI state(s)/beam(s) switching/update/change as specified herein in the present disclosure, a bitmap with each bit position of the bitmap corresponding to a TCI state/TCI state ID in/from the activate/candidate TCI states for the UE-initiated TCI state(s)/beam(s) switch/update/change as specified herein in the present disclosure or a TCI state/TCI state ID provided/indicated/activated in/by the (unified) TCI state(s) activation/deactivation MAC CE command. When/if a bit position of the bitmap is set to ‘1’ (or ‘0’), the TCI state/TCI state ID in/from the activate/candidate TCI states for the UE-initiated TCI state(s)/beam(s) switch/update/change as specified herein in the present disclosure or the TCI state/TCI state ID provided/indicated/activated in/by the (unified) TCI state(s) activation/deactivation MAC CE command corresponding to the bit position could correspond to a TCI state/beam indicated by the UE for the UE-initiated beam switching.
   For another example, the UE could send/indicate/provide to the network, e.g., by/in part of the one or more indicators for the UE-initiated TCI state(s)/beam(s) switching/update/change as specified herein in the present disclosure, index(es)/ID(s) of the set(s) of TCI state(s) from the active/candidate sets of TCI states for the UE-initiated TCI state(s)/beam(s) switching/update/change as specified herein in the present disclosure and/or in/from the (unified) TCI state(s) activation/deactivation MAC CE command, wherein the set(s) of TCI state(s) could comprise/indicate/provide/contain/include the TCI state(s) for the UE-initiated/triggered TCI state(s)/beam(s) switching/change/update. Alternatively, the UE could send/indicate/provide to the network, e.g., by/in part of the one or more indicators for the UE-initiated TCI state(s)/beam(s) switching/update/change as specified herein in the present disclosure, a bitmap with each bit position of the bitmap corresponding to a set of TCI states/TCI state IDs from the active/candidate sets of TCI states for the UE-initiated TCI state(s)/beam(s) switching/update/change as specified herein in the present disclosure or a set of TCI states/TCI state IDs provided/indicated/activated in/by the (unified) TCI state(s) activation/deactivation MAC CE command. When/if a bit position of the bitmap is set to ‘1’ (or ‘0’), the set of TCI states/TCI state IDs from the active/candidate sets of TCI states for the UE-initiated TCI state(s)/beam(s) switching/update/change as specified herein in the present disclosure or the set of TCI states/TCI state IDs provided/indicated/activated in/by the (unified) TCI state(s) activation/deactivation MAC CE command corresponding to the bit position could comprise/indicate/provide/contain/include the TCI state(s)/beam(s) for the UE-initiated beam switching.
   Yet for another example, the UE could send/indicate/provide to the network, e.g., by/in part of the one or more indicators for the UE-initiated TCI state(s)/beam(s) switching/update/change as specified herein in the present disclosure, index(es)/ID(s) of the TCI codepoint(s) in/from the (unified) TCI state(s) activation/deactivation MAC CE command, wherein the TCI codepoint(s) could comprise/indicate/provide/contain/include the TCI state(s) for the UE-initiated/triggered TCI state(s)/beam(s) switching/change/update. Alternatively, the UE could send/indicate/provide to the network, e.g., by/in part of the one or more indicators for the UE-initiated TCI state(s)/beam(s) switching/update/change as specified herein in the present disclosure, a bitmap with each bit position of the bitmap corresponding to a TCI codepoint provided/indicated/activated in/by the (unified) TCI state(s) activation/deactivation MAC CE command. When/if a bit position of the bitmap is set to ‘1’ (or ‘0’), the TCI codepoint provided/indicated/activated in/by the (unified) TCI state(s) activation/deactivation MAC CE command corresponding to the bit position could comprise/indicate/provide/contain/include the TCI state(s)/beam(s) for the UE-initiated beam switching.
   Yet for another example, the UE could send/indicate/provide to the network, e.g., by/in part of the one or more indicators for the UE-initiated TCI state(s)/beam(s) switching/update/change as specified herein in the present disclosure, index(es)/ID(s) of or information related to (unified) TCI state(s) activation/deactivation MAC CE command(s), wherein the (unified) TCI state(s) activation/deactivation MAC CE command(s) could comprise/indicate/provide/contain/include/activate the TCI state(s) for the UE-initiated/triggered TCI state(s)/beam(s) switching/change/update. Alternatively, the UE could send/indicate/provide to the network, e.g., by/in part of the one or more indicators for the UE-initiated TCI state(s)/beam(s) switching/update/change as specified herein in the present disclosure, a bitmap with each bit position of the bitmap corresponding to a (unified) TCI state(s) activation/deactivation MAC CE command. When/if a bit position of the bitmap is set to ‘1’ (or ‘0’), the (unified) TCI state(s) activation/deactivation MAC CE command corresponding to the bit position could comprise/indicate/provide/contain/include the TCI state(s)/beam(s) for the UE-initiated beam switching.

As specified herein in the present disclosure, a TCI state or a set of TCI states provided/indicated/activated in/by the (unified) TCI state(s) activation/deactivation MAC CE command could be used to map to a TCI codepoint of the TCI field in a beam indication DCI (e.g., DCI format 1_1/1_2 with or without DL assignment).

In the present disclosure, a UE could send to the network (e.g., the network 130) the indicator(s) and/or the beam measurement report as specified herein in the present disclosure to trigger or initiate a TCI state(s) change/update/switch for one or more channels/signals according to one or more of the following conditions and/or when/if one or more of the following conditions hold/are achieved.
In one example, the UE could be provided/configured/indicated by the network, e.g., via higher layer RRC signaling/parameter and/or MAC CE command and/or dynamic DCI based L1 signaling, that the UE-initiated beam switching is enabled. For instance, a higher layer parameter, denoted by ‘ueInitiatedBeamSwitch’, could be configured or set to enabled in CSI-ResourceConfig and/or CSI-ReportConfig to enable the UE-initiated beam switching. The configuration/indication/enabling of the UE-initiated beam switching via higher layer RRC signaling/parameter (e.g., by configuring ‘ueInitiatedBeamSwitch’ or setting ‘ueInitiatedBeamSwitch’ to enabled) as specified herein in the present disclosure could be based on a UE capability signaling. The UE capability signaling (e.g., denoted by ‘selfInitiatedBeamSwitch’ sent by the UE to the network) could indicate to the network that the UE is capable of initiating or triggering a TCI state(s) or beam change/update/switch for one or more channels/signals according to one or more of the design examples as specified herein in the present disclosure. Optionally, when/if the UE has sent/indicated to the network the UE capability signaling. i.e., ‘selfInitiatedBeamSwith’ here, the UE-initiated beam switching as specified herein in the present disclosure could be enabled or started by the UE.
In another example, the UE could be provided/configured/indicated by the network, e.g., via higher layer RRC signaling/parameter and/or MAC CE command and/or dynamic DCI based L1 signaling, that the UE-initiated beam/CSI reporting is enabled. For instance, a higher layer parameter, denoted by ‘ueInitiatedReport’, could be configured or set to enabled in CSI-ResourceConfig and/or CSI-ReportConfig to enable the UE-initiated CSI/beam reporting. The configuration/indication/enabling of the UE-initiated CSI/beam reporting via higher layer RRC signaling/parameter (e.g., by configuring ‘ueInitiatedReport’ or setting ‘ueInitiatedReport’ to enabled) as specified herein in the present disclosure could be based on a UE capability signaling. The UE capability signaling (e.g., denoted by ‘selfInitiatedReport’ sent by the UE to the network) could indicate to the network that the UE is capable of initiating or triggering a CSI/beam measurement/report. For this case, when/if the UE-initiated beam/CSI reporting is configured/enabled, the UE-initiated beam switching could also be configured/enabled such that the UE could initiate or trigger a TCI state(s) or beam change/update/switch for one or more channels/signals according to one or more of the design examples as specified herein in the present disclosure. Optionally, when/if the UE has sent/indicated to the network the UE capability signaling. i.e., ‘selfInitiatedReport’ here, the UE-initiated CSI/beam reporting and/or the UE-initiated beam switching could be enabled or started by the UE.
In yet another example, higher layer parameter ‘reportQuantity’ in CSI-ReportConfig could be set to a dedicated value, e.g., denoted by ‘ueInitiated-ssbri-cri’, to enable the UE-initiated CSI/beam reporting and/or the UE-initiated beam switching.
In yet another example, higher layer parameter ‘reportQuantity’ in CSI-ReportConfig could be set to “none”, and/or higher layer parameter ‘groupBasedBeamReporting’ in CSI-ReportConfig could be configured or set to enabled, and/or higher layer parameter ‘groupBasedBeamReporting-r17’ in CSI-ReportConfig could be configured or set to enabled. When/if the higher layer parameter ‘groupBasedBeamReporting’ is configured or set to enabled, higher layer parameter ‘nrofReportedRS’ could be set to 0 or a value greater than the maximum number of beams/RSs that can be reported in a CSI report (e.g., 8). When/if the higher layer parameter ‘groupBasedBeamReporting-r17’ is configured or set to enabled, the number of configured CSI resource sets could be one and/or higher layer parameter ‘nrofReportedGroups’ could be set to 0 or a value greater than the maximum number of groups of beams/RSs that can be reported in a CSI report (e.g., 8).
In yet another example, the UE could be configured/provided/indicated by the network a higher layer parameter BeamAppTime for determining/identifying time to apply a beam/TCI state change/update after the beam/TCI state change/update is indicated by the beam indication DCI (e.g., via TCI field in DCI format 1_1/1_2 with or without DL assignment) under the unified TCI framework. When the configured value of BeamAppTime is greater than (or less than) a threshold, the UE-initiated beam switching as specified herein in the present disclosure could be enabled. The configuration of the value of BeamAppTime as specified herein in the present disclosure could be based on a UE capability signaling. The UE capability signaling (e.g., denoted by ‘beamAppTime’ sent by the UE to the network) could indicate to the network which value or range of values of BeamAppTime the UE is capable of supporting. Optionally, when/if the UE has sent/indicated to the network the UE capability signaling. i.e., ‘beamAppTime’ here, is greater than (or less than) a threshold, the UE-initiated beam switching could be enabled or started by the UE. The threshold could be determined according to: (1) configured/indicated/provided by the network, e.g., via higher layer RRC signaling/parameter and/or MAC CE command and/or dynamic DCI based L1 signaling. (2) fixed in the system specifications, and/or (3) autonomously determined by the UE and sent to the network, e.g., in part of CSI/beam report.
In yet another example, when/if the subcarrier spacing (SCS) of the cell/channel to/for which the beam/TCI state change/update/switch is applied is less than (or greater than) a threshold, the UE-initiated beam switching could be enabled. The threshold could be determined according to: (1) configured/indicated/provided by the network, e.g., via higher layer RRC signaling/parameter and/or MAC CE command and/or dynamic DCI based L1 signaling. (2) fixed in the system specifications, and/or (3) autonomously determined by the UE and sent to the network, e.g., in part of CSI/beam report and/or UE's capability signaling.
In yet another example, when/if the UE is higher layer configured by the network with dl-OrJoint-TCIStateList or TCI-UL-State, and/or the value of unifiedTCI-StateType is set to ‘separate’, the UE-initiated beam switching as specified herein in the present disclosure could be enabled such that the UE could send to the network one or more indicators and/or beam measurement report(s) to trigger or initiate change/update/switch of one or more TCI states for one or more DL channels/signals or one or more UL channels/signals according to one or more of the design examples specified herein in the present disclosure.
In yet another example, when/if the UE is higher layer configured by the network with dl-OrJoint-TCIState List, and/or the value of unifiedTCI-State Type is set to ‘joint’, the UE-initiated beam switching as specified herein in the present disclosure could be enabled such that the UE could send to the network one or more indicators and/or beam measurement report(s) to trigger or initiate change/update/switch of one or more TCI states for one or more DL and UL channels/signals according to one or more of the design examples specified herein in the present disclosure.
In yet another example, when/if the UE measured L1-RSRP(s) and/or L1-SINR(s) for one or more beams is greater than (or less than) a threshold, the UE-initiated beam switching as specified herein in the present disclosure could be enabled such that the UE could send to the network one or more indicators and/or beam measurement report(s) to trigger or initiate change/update/switch of one or more TCI states for one or more DL/UL channels/signals according to one or more of the design examples specified herein in the present disclosure.
In yet another example, when/if the UE receives from the network a dedicated MAC CE command for the UE-initiated TCI state(s)/beam(s) switching/update/change-denoted by UE-initiated TCI state(s) switching activation/deactivation MAC CE command, the UE-initiated beam switching as specified herein in the present disclosure could be enabled such that the UE could send to the network one or more indicators and/or beam measurement report(s) to trigger or initiate change/update/switch of one or more TCI states for one or more DL and UL channels/signals according to one or more of the design examples specified herein in the present disclosure.
In yet another example, when/if the UE receives from the network a (unified) TCI state(s) activation/deactivation MAC CE command comprising/indicating/activating/providing at least one “unknown” TCI state/set of TCI states, the UE-initiated beam switching as specified herein in the present disclosure could be enabled such that the UE could send to the network one or more indicators and/or beam measurement report(s) to trigger or initiate change/update/switch of one or more TCI states for one or more DL and UL channels/signals according to one or more of the design examples specified herein in the present disclosure.
In yet another example, when/if the UE receives from the network a (unified) TCI state(s) activation/deactivation MAC CE command comprising/indicating/activating/providing at least Nu≥1 “unknown” TCI state(s)/set(s) of TCI states, the UE-initiated beam switching as specified herein in the present disclosure could be enabled such that the UE could send to the network one or more indicators and/or beam measurement report(s) to trigger or initiate change/update/switch of one or more TCI states for one or more DL and UL channels/signals according to one or more of the design examples specified herein in the present disclosure. The value of Nu could be: (i) determined according to fixed value(s) in system specification(s)—e.g., 2, 4 or 8, and/or (ii) configured/provided/indicated by the network, e.g., via higher layer RRC signaling/parameter and/or MAC CE command and/or dynamic DCI based L1 signaling, and/or (iii) autonomously determined/selected by the UE and reported to the network, e.g., in part of the beam/CSI report and/or UE's capability signaling.
In yet another example, when/if the UE receives from the network a (unified) TCI state(s) activation/deactivation MAC CE command that activates/indicates/provides Nc≤th_c (or Nc≥th_c) TCI states/sets of TCI states each mapped to a TCI codepoint of the TCI field in a beam indication DCI, the UE-initiated beam switching as specified herein in the present disclosure could be enabled such that the UE could send to the network one or more indicators and/or beam measurement report(s) to trigger or initiate change/update/switch of one or more TCI states for one or more DL and UL channels/signals according to one or more of the design examples specified herein in the present disclosure. Here, the value of th_c could be: (i) determined according to fixed value(s) in system specification(s)—e.g., 2, 4 or 8, and/or (ii) configured/provided/indicated by the network, e.g., via higher layer RRC signaling/parameter and/or MAC CE command and/or dynamic DCI based L1 signaling, and/or (iii) autonomously determined/selected by the UE and reported to the network, e.g., in part of the beam/CSI report and/or UE's capability signaling.
In yet another example, when/if the CSI/beam reporting periodicity and/or offset (e.g., in number of slots). e.g., provided/configured/indicated by reportSlotConfig and/or reportSlotOffsetList in CSI-ReportConfig, is greater than (or less than) a threshold/value th_r, the UE-initiated beam switching as specified herein in the present disclosure could be enabled such that the UE could send to the network one or more indicators and/or beam measurement report(s) to trigger or initiate change/update/switch of one or more TCI states for one or more DL and UL channels/signals according to one or more of the design examples specified herein in the present disclosure. Here, the threshold/value th_r could be: (i) determined according to fixed value(s) in system specification(s), and/or (ii) configured/provided/indicated by the network, e.g., via higher layer RRC signaling/parameter and/or MAC CE command and/or dynamic DCI based L1 signaling, and/or (iii) autonomously determined/selected by the UE and reported to the network, e.g., in part of the beam/CSI report and/or UE's capability signaling.

One or more of the described/specified conditions herein could be used to determine whether to enable or start the UE-initiated CSI/beam reporting according to those specified herein in the present disclosure.

In one embodiment, as specified herein in the present disclosure, a UE could send to the network (e.g., the network 130) one or more indicators or triggers to initiate or trigger CSI/beam reporting, e.g., the indicator(s) could be of (report-)type (A) as specified herein in the present disclosure which could only contain/include/comprise a trigger/pre-notification message, or the indicator(s) could be of (report-)type (B) as specified herein in the present disclosure which could only contain/include a content (comprising one or more report quantities), or the indicator(s) could be of (report-)type (C) as specified herein in the present disclosure which could contain/include a trigger/pre-notification message and a (corresponding) content (comprising one or more report quantities), wherein each of the one or more indicators or triggers could be associated with or characterized by an indicator/trigger ID. A UE can be provided, by schedulingRequestID)-UEinitiated-Reporting, a configuration for PUCCH transmission with a beam reporting request (BRR) for the UE (e.g., the UE 116) to transmit PUCCH that carries the one or more indicators/triggers for the UE-initiated/triggered beam reporting. If the UE is provided/indicated/configured by the network, e.g., via higher layer RRC signaling/parameter and/or MAC CE command and/or dynamic DCI based L1 signaling, a first and a second entity IDs, the UE could also be provided by schedulingRequestID-UEinitiated-Reporting a first configuration for PUCCH transmission with a BRR and, if the UE provides twoBRRcapability, the UE can be provided by schedulingRequestID-UEinitiated-Reporting2 a second configuration for PUCCH transmission with a BRR. If the UE is provided only the first configuration, the UE transmits a PUCCH with BRR for either the first or the second entity ID. If the UE is provided both the first and second configurations, the UE uses the first configuration to transmit a PUCCH with BRR associated with the first entity ID, and the second configuration to transmit a PUCCH with BRR associated with the second entity ID, wherein the first or second entity ID could correspond a physical cell ID (PCI), a PCI index, a coresetPoolIndex, a coresetGroupIndex, a RS set ID, a RS group ID, a TRP-specific higher layer signaling index/ID, a TCI state(s) pool/group/set ID, etc.
In one example (Mode-A), the UE could (be expected to) receive from the network a confirmation message/indication/configuration (e.g., an ACK) for the one or more indicators/triggers sent by the UE for initiating or triggering CSI/beam reporting—e.g., the PUCCH(s) with BRR as specified herein in the present disclosure. When/if the confirmation message/indication/configuration (e.g., an ACK) also provides/indicates/includes/contains/comprises an UL grant/assignment of a PUSCH (e.g., used for carrying a MAC CE), the UE could send/report to the network the beam measurement result(s)—e.g., obtained by measuring and assessing the radio link qualities of the RS(s) triggered or initiated by the UE through/via sending the one or more indicators/triggers (e.g., the PUCCH(s) with BRR) as specified herein in the present disclosure-including at least one or more resource indicators and their corresponding beam metrics as specified herein in the present disclosure in the PUSCH (e.g., used for carrying a MAC CE).
In another example (Mode-B), the UE could (be expected to) receive from the network a confirmation message/indication/configuration (e.g., an ACK) for the one or more indicators/triggers sent by the UE for initiating or triggering CSI/beam reporting—e.g., the PUCCH(s) with BRR as specified herein in the present disclosure. When/if the confirmation message/indication/configuration (e.g., an ACK) does not provide/indicate/include/contain/comprise any UL grant(s)/assignment(s) of any UL resource(s) including PUCCH(s)/PUSCH(s) for sending/reporting the beam measurement result(s)—e.g., obtained by measuring and assessing the radio link qualities of the RS(s) triggered or initiated by the UE through/via sending the one or more indicators/triggers (e.g., the PUCCH(s) with BRR) as specified herein in the present disclosure, the UE could determine or identify the UL resource(s) including PUCCH(s)/PUSCH(s) for sending/reporting the beam measurement result(s) according to the association(s) between the one or more indicators/triggers and one or more CSI reporting settings (or one or more CSI resource settings/CSI resource sets/CSI resource subsets or groups/CSI(-RS) resources) following those specified in the design examples (e.g., according to one or more example described herein) in the present disclosure—i.e., the determined or identified UL resource(s) including (periodic) PUCCH resource(s) and/or configured grant (CG) Type1/2 PUSCH resource(s) for transmitting or sending the corresponding beam report(s) could correspond to those provided/configured/indicated by/in the one or more CSI reporting settings (or the one or more CSI resource settings/CSI resource sets/CSI resource subsets or groups/CSI(-RS) resources) following those specified in the design examples in the present disclosure. For instance, the UE could send to the network an indicator/trigger with the indicator/trigger ID #1 to trigger or initiate CSI/beam measurement and reporting. With reference to FIG. 12, the indicator/trigger ID #1 is associated with/to a CSI reporting setting (provided by CSI-ReportConfig) having the reporting setting ID (provided by reportConfigId) #1. For this case, the UE could determine or identify the UL resource(s) including PUCCH(s)/PUSCH(s) for sending/reporting the beam measurement result(s) according to the parameter(s)/information—e.g., pucch-CSI-ResourceList, reportSlotConfig, reportSlotOffsetList and/or etc.—provided/configured/indicated in the CSI reporting setting CSI-ReportConfig with the reporting setting ID (provided by reportConfigId) #1.
In yet another example (Mode-C), the UE is not expected to receive from the network any confirmation message/indication/configuration (e.g., an ACK) for the one or more indicators/triggers sent by the UE for initiating or triggering CSI/beam reporting—e.g., the PUCCH(s) with BRR as specified herein in the present disclosure. For this case, the UE could determine or identify the UL resource(s) including PUCCH(s)/PUSCH(s) for sending/reporting the beam measurement result(s) according to the association(s) between the one or more indicators/triggers and one or more CSI reporting settings (or one or more CSI resource settings/CSI resource sets/CSI resource subsets or groups/CSI(-RS) resources) following those specified in the design examples (e.g., according to one or more example described herein) in the present disclosure—i.e., the determined or identified UL resource(s) including (periodic) PUCCH resource(s) and/or configured grant (CG) Type1/2 PUSCH resource(s) for transmitting or sending the corresponding beam report(s) could correspond to those provided/configured/indicated by/in the one or more CSI reporting settings (or the one or more CSI resource settings/CSI resource sets/CSI resource subsets or groups/CSI(-RS) resources) following those specified in the design examples in the present disclosure. For instance, the UE could send to the network an indicator/trigger with the indicator/trigger ID #1 to trigger or initiate CSI/beam measurement and reporting. With reference to FIG. 12, the indicator/trigger ID #1 is associated with/to a CSI reporting setting (provided by CSI-ReportConfig) having the reporting setting ID (provided by reportConfigId) #1. For this case, the UE could determine or identify the UL resource(s) including PUCCH(s)/PUSCH(s) for sending/reporting the beam measurement result(s) according to the parameter(s)/information—e.g., pucch-CSI-ResourceList, reportSlotConfig, reportSlotOffsetList and/or etc.—provided/configured/indicated in the CSI reporting setting CSI-ReportConfig with the reporting setting ID (provided by reportConfigId) #1.

The confirmation message/indication/configuration (e.g., including an ACK/NACK and/or an UL grant/assignment for a PUSCH to carry the beam report) as defined/specified herein in the present disclosure could be provided or indicated in a DCI format (e.g, a UL DCI format 0_1 and/or 0_2 and/or 0_3). For instance, the confirmation message/indication/configuration could be indicated/provided by the ‘CSI request’ field in the DCI format(s) 0_1 and/or 0_2, and PUSCH resource(s) provided/configured in CSI reporting setting(s)—e.g., provided by CSI-ReportConfig and/or ueiCSI-ReportConfig that provides or configures necessary information for the UE-initiated/event-driven beam operation/reporting as defined/specified herein in the present disclosure—corresponding/associated to the trigger state indicated/provided by the ‘CSI request’ field in the corresponding DCI format(s) could be used for sending or transmitting the corresponding beam report(s). Furthermore, when/if the DCI format provides or indicates an UL grant/assignment for a PUSCH, the confirmation message/indication/configuration could be a one-bit indicator (by/via a DCI field in the DCI format, new or repurposed) with ‘1’ (or ‘0’) indicating that the PUSCH is used/applied for transmitting or sending the beam report as specified/defined herein in the present disclosure. For the above specified/described UE-initiated/event-driven beam reporting procedures in Mode-A, Mode-B, Mode-C:
In Mode-A, the first step or step-1 is to transmit a PUCCH (the corresponding PUCCH configuration is provided with BRR) to request (e.g., UL resource(s) for) a transmission of a beam report; the second step or step-2 is for the UE to receive a network's response, e.g., the confirmation message/configuration/indication as specified/defined herein in the present disclosure received within a configured time window/period/gap/offset or before a configured timer expires, to the PUCCH transmission in the first step or step-1, wherein the network's response could also provide or indicate a UL grant or assignment for a PUSCH to carry the beam report; and the third step or step-3 is for the UE to transmit or send the beam report in the PUSCH determined or identified according to the network's response in the second step or step-2.
In Mode-C, the first step or step-1 is to transmit a PUCCH (the corresponding PUCCH configuration is provided with BRR) to indicate a transmission of a beam report; and the second step or step-2 is for the UE to transmit or send the beam report in (pre-) configured UL resource(s) including (periodic) PUCCH resource(s) and/or CG Type1/2 PUSCH resource(s), wherein the (pre-) configured UL resource(s) including (periodic) PUCCH resource(s) and/or CG Type1/2 PUSCH resource(s) could be associated/specific to the PUCCH transmission in the first step or step-1—e.g., the (pre-) configured UL resource(s) could correspond to the PUCCH/PUSCH resource(s) provided/configured in CSI reporting setting(s)/CSI resource setting(s)/CSI resource set(s)/CSI resource subset(s) as specified/defined herein in the present disclosure associated/mapped/linked/specific to the PUCCH transmission in the first step or step-1.
In Mode-B, the first step or step-1 is to transmit a PUCCH (the corresponding PUCCH configuration is provided with BRR) to request (e.g., UL resource(s) for) and/or indicate a transmission of a beam report; the second step or step-2 is for the UE to receive a network's response, e.g., the confirmation message/configuration/indication as specified/defined herein in the present disclosure, to the PUCCH transmission in the first step or step-1, wherein the network's response could also provide or indicate a UL grant or assignment for a PUSCH to carry the beam report. In this case, if the UE does not receive the network's response, e.g., within a configured time window/period/gap/offset or before a configured timer expires, in the second step or step-2, the UE could follow those specified in the second step or step-2 in Mode-C to determine or identify UL resource(s) for sending or transmitting the corresponding beam report. Otherwise, i.e., the UE receives the network's response, e.g., within a configured time window/period/gap/offset or before a configured timer expires, in the second step or step-2, the UE could follow those specified in the third step or step-3 in Mode-A to determine or identify UL resource(s) for sending or transmitting the corresponding beam report.

The UE could send to the network a capability signaling indicating whether or not they are capable of supporting the design procedure(s) specified/described in Mode-A, Mode-B and/or Mode-C. In particular, the capability signaling could comprise one or more of the following components:
Component-1: {Mode-A}
Component-2: {Mode-B}
Component-3: {Mode-C}
Component-4: {Mode-A, Mode-B}
Component-5: {Mode-A, Mode-C}
Component-6: {Mode-B, Mode-C}
Component-7: {Mode-A, Mode-B, Mode-C}

Furthermore, the UE could be indicated or configured or provided by the network, e.g., via higher layer RRC signaling(s)/parameter(s) and/or MAC CE command(s) and/or dynamic DCI based L1 signaling(s) according to or based on a corresponding UE's capability signaling, an indication to indicate which one or more of Mode-A, Mode-B and Mode-C could be enabled for the UE to perform or conduct the UE-initiated/event-driven beam management procedure(s) including beam reporting as specified/defined herein in the present disclosure.

In one embodiment, as specified herein in the present disclosure, a UE could receive from the network a (unified) TCI state activation/deactivation MAC CE command and/or a beam indication DCI (e.g., DCI format 1_1/1_2 with or without DL assignment) to indicate or update one or more TCI states for one or more channels/signals. The (unified) TCI state activation/deactivation MAC CE could provide/comprise one or more sets of TCI states used to map to one or more TCI codepoints of the TCI field in a beam indication DCI; when/if only one TCI state or one set of TCI states is provided/indicated by/in the (unified) TCI state(s) activation/deactivation MAC CE, the UE could use/apply the TCI state/set of TCI states for transmitting/receiving one or more channels/signals. The UE could apply/use the TCI state(s) indicated by the TCI field in the beam indication DCI for transmitting/receiving one or more channels/signals. Furthermore. X time/duration (e.g., X slots/symbols/etc.) after/upon receiving the (unified) TCI state(s) activation/deactivation MAC CE and/or the beam indication DCI, the UE could start measuring/receiving one or more RSs, such as NZP CSI-RSs, and report to the network the corresponding measurement result(s) including one or more resource indicators and their respective beam metrics. Here, the value of X could be determined/identified according to: (1) a fixed value specified or provided in system specifications. (2) network's configuration(s)/indication(s), e.g., via higher layer RRC signaling/parameter and/or MAC CE command and/or dynamic DCI based L1 signaling, and/or (3) UE's autonomous selection, which could also be reported/sent to the network, e.g., in part of CSI/beam report and/or UE's capability signaling. That is, the TCI state(s)/beam(s) update/indication via the (unified) TCI state(s) activation/deactivation MAC CE and/or the beam indication DCI could also trigger or initiate (aperiodic) CSI measurement and reporting-denoted by TCI state(s)/beam(s) indication driven beam/CSI measurement and reporting in the present disclosure.
In one example, the UE could (be expected to) receive from the network an UL grant/assignment of a PUSCH (e.g., used for carrying a MAC CE) for the TCI state(s)/beam(s) indication driven beam/CSI measurement and reporting. For this case, the UE could send/report to the network the beam measurement result(s)—e.g., obtained by measuring and assessing the radio link qualities of the one or more RSs as specified herein in the present disclosure-including at least one or more resource indicators and their corresponding beam metrics as specified herein in the present disclosure in the PUSCH (e.g., used for carrying a MAC CE).
In another example, for the TCI state(s)/beam(s) indication driven beam/CSI measurement and reporting, the UE is not expected to receive from the network any UL grant(s)/assignment(s) of any UL resource(s) including PUCCH(s)/PUSCH(s) for sending/reporting the beam measurement result(s)—e.g., obtained by measuring and assessing the radio link qualities of the one or more RSs as specified herein in the present disclosure. The UE could determine or identify the UL resource(s) including PUCCH(s)/PUSCH(s) for sending/reporting the beam measurement result(s) according to the association(s) between the one or more indicated TCI states/TCI state IDs and one or more CSI reporting settings (or one or more CSI resource settings/CSI resource sets/CSI resource subsets or groups/CSI(-RS) resources) following those specified in the design examples (e.g., according to one or more example described herein) in the present disclosure. For instance, the UE could be indicated/provided/configured by the network, e.g., via the (unified) TCI state(s) activation/deactivation MAC CE and/or the beam indication DCI, a TCI state with TCI state ID #2. With reference to FIG. 15, the indicated TCI state ID #2 is associated with/to a CSI reporting setting (provided by CSI-ReportConfig) having the reporting setting ID (provided by reportConfigId) #3. For this case, the UE could determine or identify the UL resource(s) including PUCCH(s)/PUSCH(s) for sending/reporting the beam measurement result(s) according to the parameter(s)/information—e.g., pucch-CSI-ResourceList, reportSlotConfig, reportSlotOffsetList and/or etc.—provided/configured/indicated in the CSI reporting setting CSI-ReportConfig with the reporting setting ID (provided by reportConfigId) #3.

FIG. 23 illustrates an example method 2300 performed by a UE in a wireless communication system according to embodiments of the present disclosure. The method 2300 of FIG. 23 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 2300 is for illustration only and other embodiments can be used without departing from the scope of the present disclosure.

The method 2300 begins with the UE receiving first information to enable UE-initiated beam operation (2310). For example, in 2310, the first information corresponds to at least one of a higher layer signaling ueInitiatedBeamReporting set to ‘enabled’; a CSI report setting for the UE-initiated beam operation; a CSI resource setting for the UE-initiated beam operation; and a higher layer parameter reportQuantity in a higher layer parameter CSI-ReportConfig set to ‘ueInitiated-ssbri-cri’ or ‘none’.

The UE then receives second information related to a measurement RS for the UE-initiated beam operation (2320). For example, in 2320, the second information indicates an association between a TCI state and a resource configuration of the measurement RS and the measurement RS is a SSB or a NZP CSI-RS. In one example, a higher layer parameter TCI-State configures the TCI state and the higher layer parameter TCI-State provides the resource configuration.

The UE then measures the measurement RS (2330) and determines a report based on the measurement (2340). For example, in 2340, the report comprises at least one of a resource indicator for the measurement RS, a beam metric for the measurement RS, an indicator indicating whether the resource indicator is for beam reporting or beam switching. The resource indicator is a SSBRI or a CRI and the beam metric is a L1-RSRP or L1-SINR.

The UE then transmits a first UL channel notifying transmission of the report (2350) and transmits a second UL channel including the report (2360). In various embodiments, the first UL channel is a PUCCH, the second UL channel is a PUSCH and the UE receives a PUCCH configuration for the first UL channel that is related to the UE-initiated beam operation. The UE may also receive, in a downlink control information (DCI) format, a response to the transmission of the first UL channel that is an ACK. NACK. UL grant, or UL assignment. When the response is the UL grant or the UL assignment, the PUSCH is scheduled or activated by the UL grant or the UL assignment.

The above flowchart(s)/flow diagrams illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a transceiver configured to:
receive first information to enable UE-initiated beam operation; and
receive second information related to a measurement reference signal (RS) for the UE-initiated beam operation; and
a processor operably coupled with the transceiver, the processor configured to:
measure the measurement RS; and
determine a report based on the measurement,
wherein the transceiver is further configured to:
transmit a first uplink (UL) channel notifying transmission of the report; and
transmit a second UL channel including the report.

2. The UE of claim 1, wherein the first information corresponds to at least one of:
a higher layer signaling ueInitiatedBeamReporting set to ‘enabled’;
a channel state information (CSI) report setting for the UE-initiated beam operation;
a CSI resource setting for the UE-initiated beam operation; and
a higher layer parameter reportQuantity in a higher layer parameter CSI-ReportConfig set to ‘ueInitiated-ssbri-cri’ or ‘none’.

3. The UE of claim 1, wherein:
the second information indicates an association between a transmission configuration indication (TCI) state and a resource configuration of the measurement RS, and
the measurement RS is a synchronization signal/physical broadcasting channel (SS/PBCH) block (SSB) or a non-zero-power channel state information reference signal (NZP CSI-RS).

4. The UE of claim 3, wherein:
a higher layer parameter TCI-State configures the TCI state, and
the higher layer parameter TCI-State provides the resource configuration.

5. The UE of claim 1, wherein:
the report comprises at least one of:
a resource indicator for the measurement RS;
a beam metric for the measurement RS; and
an indicator indicating whether the resource indicator is for beam reporting or beam switching,
the resource indicator is a synchronization signal/physical broadcasting channel (SS/PBCH) block (SSB) resource indicator (SSBRI) or a channel state information reference signal resource indicator (CRI), and
the beam metric is a layer-1 reference signal received power (L1-RSRP) or a layer-1 signal-to-interference-plus-noise ratio (L1-SINR).

6. The UE of claim 1, wherein:
the first UL channel is a physical uplink control channel (PUCCH),
the second UL channel is a physical uplink shared channel (PUSCH),
the transceiver is further configured to receive a PUCCH configuration for the first UL channel, and
the PUCCH configuration is related to the UE-initiated beam operation.

7. The UE of claim 6, wherein:
the transceiver is further configured to receive, in a downlink control information (DCI) format, a response to the transmission of the first UL channel,
the response is an acknowledgement (ACK), a negative ACK (NACK), an UL grant, or an UL assignment, and
when the response is the UL grant or the UL assignment, the PUSCH is scheduled or activated by the UL grant or the UL assignment.

8. A method performed by a user equipment (UE), the method comprising:
receiving first information to enable UE-initiated beam operation;
receiving second information related to a measurement reference signal (RS) for the UE-initiated beam operation;
measuring the measurement RS;
determining a report based on the measurement;
transmitting a first uplink (UL) channel notifying transmission of the report; and
transmitting a second UL channel including the report.

9. The method of claim 8, wherein the first information corresponds to at least one of:
a higher layer signaling ueInitiatedBeamReporting set to ‘enabled’;
a channel state information (CSI) report setting for the UE-initiated beam operation;
a CSI resource setting for the UE-initiated beam operation; and
a higher layer parameter reportQuantity in a higher layer parameter CSI-ReportConfig set to ‘ueInitiated-ssbri-cri’ or ‘none’.

10. The method of claim 8, wherein:
the second information indicates an association between a transmission configuration indication (TCI) state and a resource configuration of the measurement RS, and
the measurement RS is a synchronization signal/physical broadcasting channel (SS/PBCH) block (SSB) or a non-zero-power channel state information reference signal (NZP CSI-RS).

11. The method of claim 10, wherein:
a higher layer parameter TCI-State configures the TCI state, and
the higher layer parameter TCI-State provides the resource configuration.

12. The method of claim 8, wherein:
the report comprises at least one of:
a resource indicator for the measurement RS;
a beam metric for the measurement RS; and
an indicator indicating whether the resource indicator is for beam reporting or beam switching,
the resource indicator is a synchronization signal/physical broadcasting channel (SS/PBCH) block (SSB) resource indicator (SSBRI) or a channel state information reference signal resource indicator (CRI), and
the beam metric is a layer-1 reference signal received power (L1-RSRP) or a layer-1 signal-to-interference-plus-noise ratio (L1-SINR).

13. The method of claim 8, wherein:
the first UL channel is a physical uplink control channel (PUCCH),
the second UL channel is a physical uplink shared channel (PUSCH),
the method further comprises receiving a PUCCH configuration for the first UL channel, and
the PUCCH configuration is related to the UE-initiated beam operation.

14. The method of claim 13, further comprising:
receiving, in a downlink control information (DCI) format, a response to the transmission of the first UL channel,
wherein the response is an acknowledgement (ACK), a negative ACK (NACK), an UL grant, or an UL assignment, and
wherein, when the response is the UL grant or the UL assignment, the PUSCH is scheduled or activated by the UL grant or the UL assignment.

15. A base station (BS), comprising:
a processor; and
a transceiver operably coupled with the processor, the transceiver configured to:
transmit first information to enable a user equipment (UE)-initiated beam operation;
transmit second information related to a measurement reference signal (RS) for the UE-initiated beam operation;
transmit the measurement RS;
receive a first uplink (UL) channel notifying reception of a report associated with the measurement RS; and
receive a second UL channel including the report.

16. The BS of claim 15, wherein the first information corresponds to at least one of:
a higher layer signaling ueInitiatedBeamReporting set to ‘enabled’;
a channel state information (CSI) report setting for the UE-initiated beam operation;
a CSI resource setting for the UE-initiated beam operation; and
a higher layer parameter reportQuantity in a higher layer parameter CSI-ReportConfig set to ‘ueInitiated-ssbri-cri’ or ‘none’.

17. The BS of claim 15, wherein:
the second information indicates an association between a transmission configuration indication (TCI) state and a resource configuration of the measurement RS, and
the measurement RS is a synchronization signal/physical broadcasting channel (SS/PBCH) block (SSB) or a non-zero-power channel state information reference signal (NZP CSI-RS).

18. The BS of claim 17, wherein:
a higher layer parameter TCI-State configures the TCI state, and
the higher layer parameter TCI-State provides the resource configuration.

19. The BS of claim 15, wherein:
the report comprises at least one of:
a resource indicator for the measurement RS;
a beam metric for the measurement RS; and
an indicator indicating whether the resource indicator is for beam reporting or beam switching,
the resource indicator is a synchronization signal/physical broadcasting channel (SS/PBCH) block (SSB) resource indicator (SSBRI) or a channel state information reference signal resource indicator (CRI), and
the beam metric is a layer-1 reference signal received power (L1-RSRP) or a layer-1 signal-to-interference-plus-noise ratio (L1-SINR).

20. The BS of claim 15, wherein:
the first UL channel is a physical uplink control channel (PUCCH),
the second UL channel is a physical uplink shared channel (PUSCH),
the transceiver is further configured to transmit a PUCCH configuration for the first UL channel,
the PUCCH configuration is related to the UE-initiated beam operation,
the transceiver is further configured to transmit, in a downlink control information (DCI) format, a response to the reception of the first UL channel,
the response is an acknowledgement (ACK), a negative ACK (NACK), an UL grant, or an UL assignment, and
when the response is the UL grant or the UL assignment, the PUSCH is scheduled or activated by the UL grant or the UL assignment.
